(19) United States
(12) Patent Application Publication
(10) Pub. No.: US 2026/0180714 A1
(43) Pub. Date: Jun. 25, 2026

(54) NEURAL NETWORK OPTIMIZATION FOR ENHANCED BIT ERROR RATE PREDICTION

(71) Applicant: NVIDIA Corporation, Santa Clara, CA (US)

(72) Inventors: Pervez Mirza Aziz, Murphy, TX (US); Mohammad Shafiul Mobin, Murphy, TX (US)

(21) Appl. No.: 19/316,691

(22) Filed: Sep. 2, 2025

Related U.S. Application Data
(63) Continuation of application No. 19/176,831, filed on Apr. 11, 2025.
(60) Provisional application No. 63/737,344, filed on Dec. 20, 2024.

(51) Int. Cl. H04L 1/00; H04L 1/20

(52) U.S. Cl. CPC H04L 1/0045; H04L 1/0071; H04L 1/203

(57) ABSTRACT

Technologies for optimizing post-FEC bit error rate (BER) performance of a Forward Error Correction (FEC) system are described. The processing device evaluates a quality metric associated with a trained deep neural network (DNN) relative to a quality criterion, the DNN to estimate a post-FEC bit error rate of a FEC circuit. The processing device updates a feature set or a neural network configuration when the quality metric does not satisfy the quality criterion, and retrains the DNN with an updated feature set or updated neural network configuration and re-evaluating the quality metric. The processing device selects a final feature set or a final neural network configuration for DNN inference when the quality metric satisfies the quality criterion, and stores trained DNN model parameters corresponding to the final feature set or final neural network configuration.

### RELATED APPLICATIONS

This application is a continuation-in-part (CIP) of U.S. application Ser. No. 19/176,831, filed Apr. 11, 2025, which claims the benefit of U.S. Application No. 63/737,344, filed Dec. 20, 2024, the entire contents of both applications are incorporated herein by reference.

### TECHNICAL FIELD

At least one embodiment relates to processing resources used for high-speed communications, including estimating or predicting post-Forward Error Correction (FEC) bit error rate (BER) and optimizing systems for post-FEC BER performance. For example, at least one embodiment pertains to technology for estimating post-FEC BER and adapting FEC or communication link parameters using deep neural networks (DNNs) to improve post-FEC BER performance.

### BACKGROUND

Communication systems utilize an architecture that combines a transmitter/receiver circuit (e.g., Serializer/Deserializer (SerDes) circuit) with a Forward Error Correction (FEC) system for transmitting signals from a transmitter to a receiver via a communication channel or medium (e.g., cables, printed circuit boards, optical fibers, etc.). The SerDes system equalizes the signal over the communication channel to achieve a desired bit error rate (BER). An FEC encoder encodes data on the transmit side before the SerDes transmitter (TX) sends the data through the communication channel. After transmission, the SerDes receiver (RX) receives an analog input signal at the output of the communication channel and recovers the data as a decoded binary bit stream, achieving a certain BER performance (referred to as “pre-FEC BER performance”). This data is then passed through an FEC decoder to further improve the BER.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of a communication system having a DNN-based estimation system to optimize post-FEC BER performance of an FEC system, according to at least one embodiment.

FIG. 2 is a block diagram of a communication system having a DNN-based estimation system to optimize post-FEC BER performance of an FEC system for a linear or direct-drive multi-part optical link with interleavers, according to at least one embodiment.

FIG. 3 illustrates an example of FEC symbol interleaving with an interleave factor of four for an encoded FEC codeword, according to at least one embodiment.

FIG. 4 are block diagrams of three high-level types of post-FEC BER estimation techniques, according to various implementations.

FIG. 5 is a block diagram of a DNN training and inference architecture, according to at least one embodiment.

FIG. 6 is a block diagram of a post-FEC BER estimation architecture using DNN-based training, according to at least one embodiment.

FIG. 7 is a block diagram of an alternative architecture for post-FEC training and inference, according to at least one embodiment.

FIG. 8 is a block diagram of an overall link/SerDes/FEC architecture incorporating DNN-based training, according to at least one embodiment.

FIG. 9 is a block diagram of an overall link/SerDes/FEC architecture incorporating DNN-based inference, according to at least one embodiment.

FIG. 10 is a block diagram of an alternative framework for training and inference, according to at least one embodiment.

FIG. 11 is a block diagram illustrating periodic inference while keeping some inference parameters fixed and varying others, where k represents the time period at which post-FEC BER is re-inferred, according to at least one embodiment.

FIG. 12 is a flow diagram of an example method for determining a post-FEC BER estimation using a DNN, according to at least one embodiment.

FIG. 13 is a flow chart of an example method for dynamic feature and network configuration optimization of a DNN, according to at least one embodiment.

FIG. 14 is a flow chart of an example method for a sequential grid search for dynamic feature and network configuration optimization of a DNN, according to at least one embodiment.

FIG. 15A and FIG. 15B are flow diagrams of an example method of performing a 3D stochastic hill climbing (SHC) search for dynamic feature and network configuration optimization of a DNN, according to at least one embodiment.

FIG. 16 is a flow diagram of an example method for optimizing a DNN for enhanced bit error rate prediction, according to at least one embodiment.

FIG. 17 is a flow diagram of an example method for optimizing a DNN for enhanced bit error rate prediction, according to at least one embodiment.

FIG. 18 illustrates an example computer system, including a network controller with a DNN-based estimation system for optimizing post-FEC BER performance of an FEC system, in accordance with at least some embodiments.

FIG. 19A illustrates an example communication system with a DNN-based estimation system for optimizing post-FEC BER performance of an FEC system, in accordance with at least some embodiments.

FIG. 19B illustrates a block diagram of an example communication system employing a receiver with a DNN-based estimation system for optimizing post-FEC BER performance of an FEC system, according to at least one embodiment.

FIG. 20 is a block diagram of a computing system having two processing devices coupled to each other and to multiple networks, according to at least one embodiment.

FIG. 21 is a block diagram of a computing system having a central processing unit (CPU) and a graphics processing unit (GPU) in a single integrated circuit, according to at least one embodiment.

FIG. 22 is a block diagram of a computing system having tensor core graphics processing units (GPUs), according to at least one embodiment.

FIG. 23A illustrates inference and/or training logic, according to at least one embodiment of the present disclosure.

FIG. 23B illustrates inference and/or training logic, according to at least one embodiment.

FIG. 24 illustrates training and deployment of a neural network, according to at least one embodiment.

FIG. 25 is an example data flow diagram for an advanced computing pipeline, according to at least one embodiment.

FIG. 26 is a system diagram for an example system for training, adapting, instantiating, and deploying machine learning models in an advanced computing pipeline, according to at least one embodiment.

FIG. 27 is a block diagram illustrating an exemplary computer system, according to at least one embodiment.

FIG. 28 is a block diagram illustrating an electronic device for utilizing a processor, according to at least one embodiment.

### DETAILED DESCRIPTION

As described above, communication systems employ a combination of transmitter and receiver circuits (e.g., Serializer/Deserializer (SerDes) circuits) in conjunction with a forward error correction (FEC) system. The FEC encoder encodes data on the transmit side before the transmitter (TX) sends the data through a communication channel. The receiver (RX) (SerDes receiver) receives an analog input signal at the output of the communication channel and recovers the data as a decoded binary bit stream, achieving a certain bit error rate (BER) performance before sending that data through an FEC decoder to further improve the BER. The FEC system may perform various types of data interleaving. While there are FEC-related parameters that can be adjusted, these parameters are usually static in a system, thus locking the system into a specific, apriori chosen performance/power/latency tradeoff, where the latency refers to the latency through the FEC system.

The TX/RX hardware (e.g., SerDes hardware), on the other hand, often has many link parameters that can be adapted either directly on the SerDes hardware or through the use of an external controller. The external controller uses these link parameters to optimize SerDes performance based on pre-FEC performance criteria, such as pre-FEC BER or least mean squared error. In other words, the controller measures the pre-FEC BER performance to optimize the SerDes parameters. However, a well-equalized signal that provides good pre-FEC BER may distribute errors in a way that is not favorable to the FEC and post-FEC performance. It is not practical to measure post-FEC BER directly, creating a need for metrics that correlate well with post-FEC performance. There is no practical way to measure the post-FEC BER performance of the FEC system at the low post-FEC BER values where a system would typically operate. Thus, conventional systems do not use communication link or FEC-related parameters to optimize the post-FEC BER performance of FEC systems.

Aspects and embodiments of the present disclosure address these and other challenges by providing post-FEC BER estimation or prediction using deep neural networks (DNNs). These approaches can be used for estimation or prediction with little or no transient simulation or silicon data collection during final inference. Aspects and embodiments of the present disclosure perform adaptations of FEC or communication link parameters (e.g., SerDes parameters) based on the estimated post-FEC BER.

Previous solutions relied on extensive data collection based on transient (time domain) simulation or silicon measurements of various data statistics, such as codeword, burst, or signal-to-noise ratio (SNR) histograms. These data statistics are processed using a semi-analytic post-FEC BER prediction model to estimate post-FEC BER performance. Aspects and embodiments of the present disclosure can train a DNN for post-FEC BER estimation purposes such that, after training is complete, post-FEC BER performance can be estimated with significantly reduced or no data collection of data statistics based on transient simulation or silicon data collection.

As described above, FEC-related parameters are usually static in a system, thus locking the system into a specific, apriori chosen performance/power/latency tradeoff, where the latency refers to latency through the FEC system. Aspects and embodiments of the present disclosure use DNN-based post-FEC BER performance estimation for the adaptation or modification of FEC-related parameters to optimize post-FEC BER performance. Aspects and embodiments of the present disclosure can optimize selected SerDes or link component parameters for post-FEC BER performance by considering only those parameters that are likely to have a significant impact on post-FEC BER performance, rather than a secondary impact.

Aspects and embodiments of the present disclosure can be applied to any communication system employing forward error correction. The communication system can include serial links (e.g., printed circuit board (PCB) links, copper cables, optical links, read channels (e.g.,—systems including but not limited to serial links (PCB/copper cable/optical links etc.), read channel applications (e.g., hard disk, flash SSDs), or similar systems. The communication system can be implemented in a personal computer (PC), set-top box (STB), server, network router, switch, bridge, data processing unit (DPU), network card, data center, communication links in automobile systems, or any device or system capable of sending signals over a communication channel to another device.

It should be noted that in the subsequent discussions, references to post-FEC BER may refer to its actual value (e.g., 1e⁻²⁴) or its equivalent log₁₀ value (e.g., −24 for 1e⁻²⁴ actual value of 1e⁻²⁴). Most mathematical operations involving post-FEC BER are performed in the log₁₀ domain; however, converting between the actual value and the log₁₀ domain, or vice versa, is a straightforward operation. Additionally, although post-FEC BER is often used as the post-FEC performance criterion, all concepts regarding post-FEC BER are equally applicable to metrics such as post-FEC codeword failure rate (CFR), also known as block error rate (BLER), which are related to post-FEC BER by simple, well-known relationships.

As described above, traditional methods for estimating post-FEC BER require extensive data collection through simulations or hardware measurements. In some embodiments, DNNs can be leveraged to predict post-FEC BER, thereby reducing the need for such intensive data collection. The DNN can be used to estimate post-FEC BER performance for a class of channels or links within a given SerDes architecture. In some cases, the DNN input feature lists, DNN configurations, and training control mechanisms are fixed or predetermined. However, there are many possible choices for DNN input feature lists, as well as various DNN configurations and training control mechanisms. It may be beneficial to reduce computational complexity during the prediction/inference process by identifying and excluding features from a feature list or network parameters that are not critical for high accuracy.

Aspects and embodiments of the present disclosure can be used to select the best possible features and/or DNN configurations. These aspects and embodiments can reduce computational complexity during the prediction/inference process by identifying and excluding features from a feature list or network parameters that are not critical for high accuracy. The present disclosure proposes: (i) post-FEC-related metrics to train a particular DNN configuration; (ii) post-FEC quality metrics to determine the efficacy of a given list of DNN features and configurations; and (iii) algorithms to choose an optimal or suitable list of DNN features and configurations, thereby enabling dynamic optimization of DNN feature and configuration choices.

Aspects and embodiments of the present disclosure can introduce several post-FEC-related weighting criteria to enhance the training of DNNs for post-FEC BER estimation. Aspects and embodiments of the present disclosure can use various quality metrics to assess the effectiveness of different DNN feature lists and configurations by comparing predicted post-FEC BER values to reference values, often using log-domain differences and internal training metrics such as training loss or validation loss profiles. To dynamically optimize the DNN, the aspects and embodiments of the present disclosure can employ algorithms such as full parallel grid search, sequential grid search, and stochastic hill climbing, which systematically explore different combinations of features and configurations. This approach aims to achieve optimal prediction accuracy and efficiency in post-FEC BER estimation.

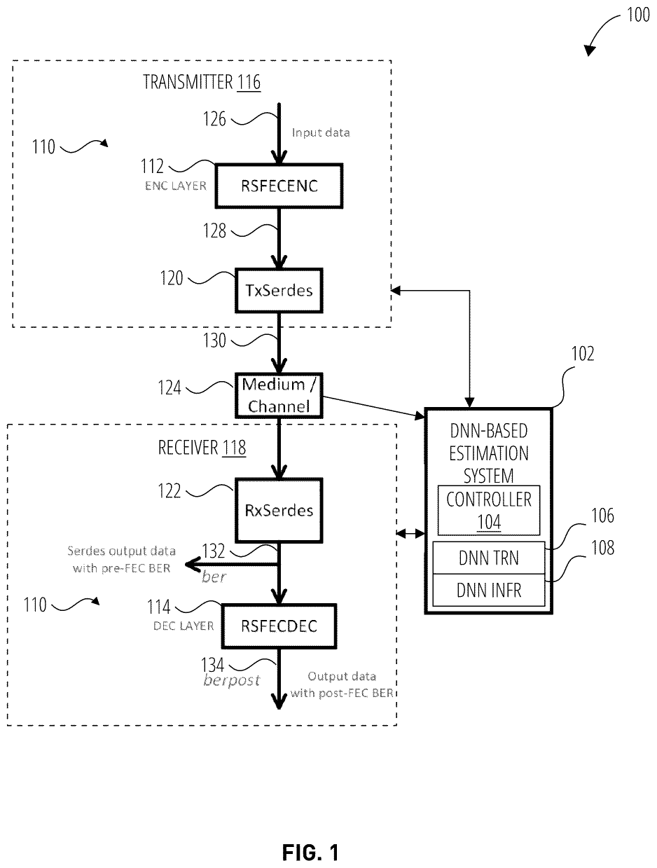

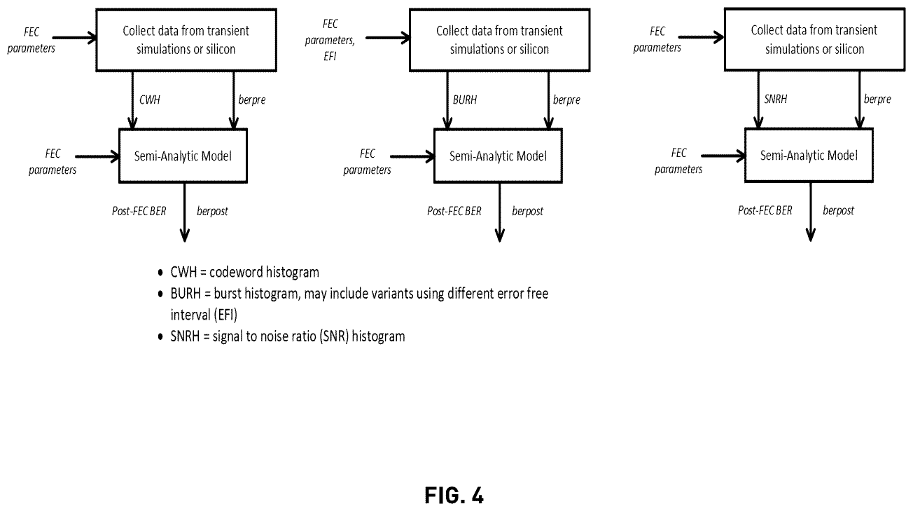

FIG. 1 is a block diagram of a communication system 100 having a DNN-based estimation system 102 to optimize post-FEC BER performance of an FEC system 110 according to at least one embodiment. The DNN-based estimation system 102 is described in more detail below with respect to FIG. 4 to FIG. 10, whereas FIG. 1 to FIG. 3 describe communication systems in which the DNN-based estimation system 102 can be used.

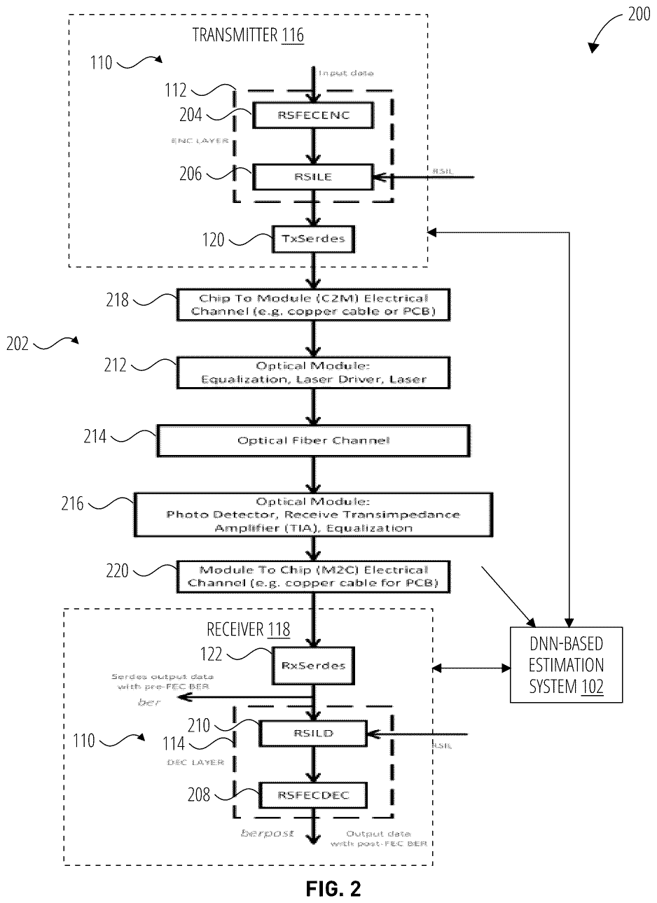

The communication system 100 can include an FEC system 110 and a SerDes system connected to a communication channel 124. In particular, the communication system 100 includes a transmitter 116 (also referred to as a transmitter device or transmitting device), a receiver 118 (also referred to as a receiver device or receiving device), and the DNN-based estimation system 102 operatively coupled to the FEC system 110 and receiver 118. The DNN-based estimation system 102 can receive data from the encoding layer 112, the transmitter circuit 120, the communication channel 124, the receiver circuit 122, and the decoding layer 114, as described in more detail below. In this embodiment, the FEC system 110 includes one or more FEC engines, such as Reed-Solomon (RS) FEC engines, with an RS code and RS interleaving (RSILE, RSILD), as illustrated in FIG. 2. In other embodiments, other error correcting codes can be used, such as a Bose-Chaudhuri-Hocquenghem code (BCH code) and BCH interleaving (BCHILE, BCHILD), Hamming codes, extended Hamming codes, Golay codes, parity codes including low-density parity check (LDPC) codes, multidimensional parity codes, triple modular redundancy codes, Nordstrom-Robinson codes, cyclic redundancy check (CRC) codes, or the like.

In at least one embodiment, the transmitter 116 is part of a first transceiver that also includes a receiver (not illustrated in FIG. 1), and the receiver 118 is part of a second transceiver that also includes a transmitter (not illustrated in FIG. 1). The transmitter 116 includes a transmitter circuit 120, such as a SerDes TX circuit. The transmitter circuit 120 sends signals over a communication channel 124 (also referred to as a “channel,” “communication medium,” or “transmission medium”). The receiver 118 includes a receiver circuit 122, such as a SerDes RX circuit. The receiver circuit 122 receives signals over the communication channel 124.

In at least one embodiment, the FEC system 110 includes an encoding layer 112 at the transmitter 116 and a decoding layer 114 at the receiver 118. The encoding layer 112 can encode input data 126 (e.g., user or input bits) into forward error correction (FEC) codewords 128 which can be mapped to FEC symbols and bits before being sent to the transmitter circuit 120. In at least one embodiment, the FEC system 110 uses a Reed-Solomon (RS) FEC algorithm. The encoding layer 112 can thus be an RS FEC encoder (RSFECENC). Other encoding operations may be performed in the encoding layer 112 (and decoding operations in the decoding layer 114). In other embodiments, other encoding operations can be performed in the transmitter circuit 120 and receiver circuit 122, such as precoding, Gray coding, run-length encoding, or the like. During the encoding process, the encoding layer 112 (e.g., RSFECENC) usually processes groups of bits called FEC symbols, which are typically groups of, say, 8 or 10 bits at a time, and then FEC codewords 128, which, depending on the FEC, can include many FEC symbols. Of course, the equivalent binary bits or equivalent modulated symbols (e.g., the ones actually sent by the transmitter circuit 120 (e.g., SerDes TX circuit)) are transmitted through a transmission medium or communication channel 124, which produces an analog waveform. In particular, after the encoding process, the transmitter circuit 120 (e.g., SerDes TX circuit) sends the equivalent binary bits in a bit stream or equivalent modulated symbols as an analog waveform through communication channel 124, as illustrated in FIG. 1. The receiver circuit 122 (e.g., SerDes RX circuit) processes the analog signal, performing operations such as equalization/detection and clock/data recovery, and produces a bit stream 132, which, in the absence of impairments or noise in the communication channel 124, would match the transmitted bit stream 130 at the SerDes TX input.

It should be noted that the bits of the bit stream 132 at the output of the receiver circuit 122 (e.g., SerDes RX circuit) are produced with a finite pre-FEC BER, which can be high. These pre-FEC bits at the output of the receiver circuit 122 are typically regrouped as FEC symbols for the decoding layer 114. During the decoding process, the decoding layer 114 decodes the RX SerDes output to produce output data 134. The underlying bits of the output data 134 have significantly improved (i.e., lower) post-FEC BER than the pre-FEC BER observed at the SerDes RX output. In at least one embodiment, the decoding layer 114 is an RS decoder (e.g., RSFECDEC). Other encoding and decoding FEC algorithms can be used for the encoding layer 112 and decoding layer 114. The receiver circuit 122 may use an external controller 104 to aid in the adaptation of one or more of its internal parameters to optimize the pre-FEC BER performance at the output of the receiver circuit 122. The terms encoding/decoding layers are generic, but the functionality of these layers can be found in systems that use other terminologies, such as the physical coding sub-layer (PCS) in IEEE standards, or similar. Other standards bodies may use different names for where such functionality resides.

In addition, interleaving may be applied in conjunction with the FEC system. In at least one embodiment, the encoding layer 112 can include an FEC encoder and a first interleaver, and the decoding layer 114 can include an FEC decoder and a second interleaver. The second interleaver may also be called a ‘de-interleaver’. The interleaving may be of various types, operating on bits, pairs of bits, or FEC symbols. Depending on the interleaver type, the first interleaver reorders groups of bits, pairs of bits, or FEC symbols on the encoding side, and the second interleaver performs the reverse operation on the decoding side. It should be noted that the use of an interleaver causes additional latency in the communication system; the higher the interleave factor, the greater the additional latency.

In other embodiments, the system can include additional components, as illustrated and described below with respect to FIG. 2.

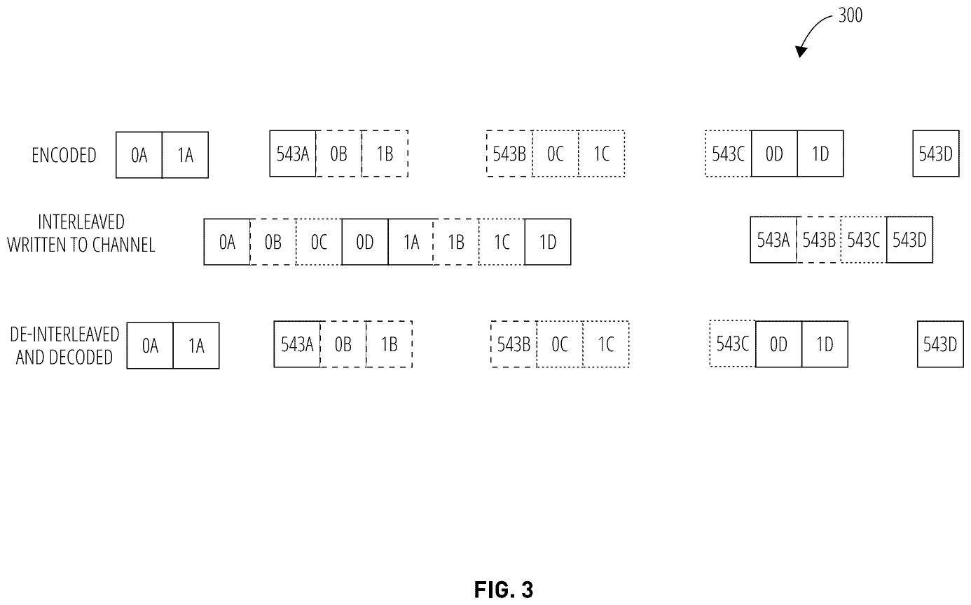

FIG. 2 is a block diagram of a communication system 200 having a DNN-based estimation system 102 to optimize post-FEC BER performance of an FEC system 110 for a linear or direct drive multi-part optical link 202 with interleavers, according to at least one embodiment. The communication system 200 is similar to communication system 100, except that communication system 200 includes a linear or direct drive multi-part optical link 202 with interleavers. As described above, interleaving may be applied in conjunction with the FEC system. In at least one embodiment, the encoding layer 112 can include the FEC encoder 204 and a first interleaver 206. In at least one embodiment, the decoding layer 114 can include the FEC decoder 208 and a second interleaver 210. The second interleaver 210 may also be called a ‘de-interleaver.’ This interleaving for the FEC encoder 204 (RSFEC) is denoted as RSILE for the first interleaver 206 in the encoding layer 112 and RSILD for the second interleaver 210 in the decoding layer 114. The interleaving may be of various types, operating on bits, pairs of bits, or FEC symbols. Depending on the interleaver type, the first interleaver 206 reorders groups of bits, pairs of bits, or FEC symbols on the encoding side, and the second interleaver 210 performs the reverse operation on the decoding side. A common form of interleaving is FEC symbol interleaving by an interleave factor (denoted as RSIL) when used in conjunction with the FEC encoder 204 (RSFECENC). An example of FEC symbol interleaving with RSIL=4 is shown in FIG. 3 for an encoded FEC codeword size of Nfec=544. It should be noted that the use of an interleaver causes additional latency in the communication system; the higher the interleave factor, the greater the additional latency.

In addition to the interleavers, the optical link 202 includes other components, such as a transmit optical module 212, optical fiber 214, and receive optical module 216. The TX optical module 212 may include additional equalization, a laser driver, and a laser. The RX optical module 216 may include a photodiode, receive transimpedance amplifier (RXTIA), and additional equalization. The optical link 202 can include a chip-to-module (C2M) electrical channel (e.g., copper cable or PCB) on the TX side and a module-to-chip (M2C) electrical channel (e.g., copper cable or PCB) on the RX side, labeled as C2M electrical channel 218 and M2C electrical channel 220. Other variants of the optical links involving the use of classical re-timer blocks or re-timer blocks on one or both sides of the link are also possible.

The interleaving may be of various types, operating on bits, pairs of bits, or FEC symbols. Depending on the interleaver type, it reorders groups of bits, pairs of bits, or FEC symbols on the encoding side and performs the reverse operation on the decoding side. A common form of interleaving is FEC symbol interleaving by some factor, which is denoted as RSIL when used in conjunction with an RS FEC. An example of FEC symbol interleaving with RSIL=4 is shown in FIG. 3 for an encoded FEC codeword size of 544 (Nfec=544). The use of an interleaver introduces additional latency into the system; the higher the interleave factor, the greater the additional latency.

FIG. 3 illustrates an example of FEC symbol interleaving with an interleave factor of four for an encoded FEC codeword 300, according to at least one embodiment. The encoded FEC codeword 300 has a codeword size of 544. Each square represents one FEC symbol, and each line pattern represents an adjacent FEC codeword after initial encoding.

### DNN-Based Post-FEC Estimation

Referring back to FIG. 1, as described above, post-FEC estimation has traditionally relied on extensive data collection based on transient (time domain) simulation or silicon measurements of various data statistics, such as codeword, burst, or signal-to-noise ratio (SNR) histograms. These statistics are then processed using a semi-analytic post-FEC BER prediction model to estimate the post-FEC BER. However, a deep neural network (DNN) can be trained for post-FEC BER estimation, such that, after training is complete, post-FEC BERs can be estimated with significantly reduced or no data collection based on transient simulation or silicon data.

As also described herein, there are FEC-related parameters of the FEC system 110 that can be adjusted by the DNN-based estimation system 102. Conventionally, FEC-related parameters are static in a traditional FEC system, locking the system into a specific a priori chosen performance/power/latency tradeoff. The DNN-based estimation system 102, as described in the various embodiments here, determines a post-FEC correlated performance metric indicative of an estimated post-FEC BER of the FEC system 110 in order to optimize post-FEC BER performance. The post-FEC correlated performance metrics are those that correlate well with post-FEC BER performance. The DNN-based estimation system 102 can dynamically adapt the FEC-related parameters of the FEC system 110 to optimize post-FEC BER performance. The FEC-related parameters can include encoding/decoding layer parameters. In at least one embodiment, the FEC-related parameters include an interleave factor (RSIL), as illustrated in FIG. 2.

In at least one embodiment, the transmitter circuit 120 and receiver circuit 122 have link parameters (e.g., SerDes parameters). In at least one embodiment, the link parameter is a phase noise parameter of a phase-locked loop (PLL) of the receiver circuit 122. In at least one embodiment, the DNN-based estimation system 102 can dynamically adapt the link parameters of the transmitter circuit 120 and receiver circuit 122 to optimize post-FEC BER performance. It should be noted that, conventionally, the link parameters could be adjusted but only based on some pre-FEC performance criteria. That is, a conventional controller would only measure the pre-FEC BER performance to optimize the SerDes parameters. As described above, there is no practical way to measure the post-FEC BER performance of the FEC system 110 directly for low post-FEC BERs, where a system would typically operate. An exception, where post-FEC BER can actually be measured (either in simulation or silicon), is to exacerbate the system impairments, such as noise or jitter, to manifest actual post-FEC errors.

The embodiments described herein allow SerDes parameters to be optimized based on post-FEC performance criteria by training a DNN to assist in post-FEC BER estimation and using the trained DNN to infer post-FEC BER for dynamic performance optimization. The DNN-inferred post-FEC BER can be used to dynamically optimize performance tradeoffs by adapting FEC parameters, such as the FEC interleaving factor. Selected SerDes or link parameters can also be optimized or adapted for optimal post-FEC performance. In particular, the embodiments described herein can modify or adjust link parameters and/or FEC-related parameters to optimize the post-FEC BER performance of the FEC system 110. The link parameters can be adapted either directly on the SerDes hardware (e.g., transmitter circuit 120 and receiver circuit 122) or through the use of an external controller 104 (also referred to as an adaptation controller), which could be a microcontroller (MCU) or FPGA that is separate from the DNN-based estimation system 102. The DNN-based estimation system 102 may include one or more GPUs for processing data for training the DNN and making inferences using the trained DNN. In at least one embodiment, the DNN-based estimation system 102 is implemented as one or more processing devices, such as a GPU for computations and operations of the DNN training logic 106 and DNN inference logic 108, and a controller 104 for adapting the FEC parameters and link parameters. In another embodiment, the DNN-based estimation system 102 is implemented in an auxiliary device, such as a Deep Learning Accelerator (DLA), a data processing unit (DPU), or similar device.

In at least one embodiment, the DNN-based estimation system 102 includes DNN training logic 106 and DNN inference logic 108. To estimate post-FEC performance (i.e., post-FEC BER estimation), the DNN training logic 106 can train on data aggregated from multiple links to create a trained DNN model or models, which can subsequently be used to infer post-FEC BER performance for specific links. During the training phase, the DNN training logic 106 can use collections of FEC codeword histograms (i.e., measured FEC codeword histograms), burst histograms, SNR histogram data, and optionally pre-FEC BER measurements obtained via transient simulations of links or silicon data. However, during inference, the DNN inference logic 108 can determine a final post-FEC BER estimation with minimal or even no transient simulation or transient silicon data. The DNN inference logic 108 can use the post-FEC BER estimation to optimize or adapt selected SerDes or link parameters, as well as FEC-related parameters.

### Link Parameters

As described herein, the DNN-based estimation system 102 can adapt link parameters, such as SerDes parameters, to optimize post-FEC BER performance using a post-FEC BER estimation obtained by a trained DNN. Examples of link parameters include:
Analog front end (AFE) parameters, such as continuous time linear equalizer (CTLE) peaking/boost setting, low-frequency gain setting, low-frequency pole/zero (corner frequency) setting, mid-frequency gain setting, and mid-frequency pole/zero (corner frequency) setting.
Receiver feed forward equalizer (RXFFE) fixed tap settings, such as first post-cursor f(1) or first pre-cursor f(−1) settings, which also significantly affect the phase response of the RXFFE.
Number of RXFFE taps enabled
Number of decision feed forward equalizer (DFFE) taps enabled
Number of digital echo cancellation (DEX) taps enabled
Number of analog echo cancellation (AEX) taps enabled
Maximum likelihood sequence detector (MLSD) trace back depth (also known as path memory)

Alternatively, the DNN-based estimation system 102 can adapt other link parameters to optimize post-FEC BER performance using a post-FEC BER estimation obtained by a trained DNN. Additionally, as described herein, the DNN-based estimation system 102 can adapt both link parameters and FEC parameters together.

### FEC Parameters

As described herein, the DNN-based estimation system 102 can adapt FEC parameters to optimize post-FEC BER performance using a post-FEC BER estimation obtained by a trained DNN. Examples of FEC parameters include:
FEC RS interleaving factor (already discussed in detail)
Concatenated scheme: FEC BCH interleaving factor.
Hard or soft decision decoding of BCH or RS FEC
BCH coding enabled or disabled
FEC coding scheme
Link/FEC retry enabled or not

Alternatively, the DNN-based estimation system 102 can adapt other FEC parameters to optimize post-FEC BER performance using a post-FEC BER estimation obtained by a trained DNN. Additionally, as described herein, the DNN-based estimation system 102 can adapt both link parameters and FEC parameters together.

### Codeword and Burst Histograms

The following is a description of codeword and burst histograms for post-FEC BER estimation used in training a DNN. Two types of histograms are commonly used in traditional post-FEC BER estimation techniques. These histograms are generated from raw FEC symbol error statistics at the SerDes output, which are themselves derived from raw bit error statistics from the SerDes Rx. Note that, in order for the SerDes Rx to compute actual raw bit error information, it must be aware of the transmitted bits so it can compare the received bits with the transmitted bits to determine whether a bit error has occurred. As is well known to those skilled in the art, such bit error measurements can be made using a training pattern, such as a pseudo-random bit sequence (PRBS) pattern known to both the SerDes TX and SerDes Rx. Let e(n) represent the bit error stream at bit time n at the SerDes output. Thus, when a bit is in error, e(n)=1, and when a bit is not in error, e(n)=0.

An FEC symbol error stream, fe(m), at FEC symbol times m, can be constructed from the bit error stream e(n). For a given FEC, let L be the number of bits in an FEC symbol. FEC symbol errors are determined by examining contiguous groups of L bits. If, in any group of L bits (i.e., bits in an FEC symbol corresponding to the mth group), any bit is in error, then the corresponding FEC symbol is declared to be in error (i.e., fe(m)=1). Only if none of the bits in the group of L bits is in error is the FEC symbol declared to be error-free (i.e., fe(m)=0). This can also be equivalently represented in the following Equation 1:

$$f e ( m ) = {\sum }_{i = n - ( L - 1 )}^{n} e ( n ) , \qquad ( Equation 1 )$$

where ⊕ should be noted that the sum represents an ‘or’ sum. For example, for L=8, this would result in the following Equation 2:

$$f e ( m ) = e ( n - 7 ) ⊕ e ( n - 6 ) ⊕ e ( n - 5 ) ⊕ e ( n - 4 ) ⊕ e ( n - 3 ) ⊕ e ( n - 2 ) ⊕ e ( n - 1 ) ⊕ e ( n ) , \qquad ( Equation 2 )$$

where @ represents the ‘or’ logical operator. Another exemplary value for L could be L=10. The FEC symbol errors fe(m) can now be used to construct metrics that are indicative of and well correlated with post-FEC BER performance.

From the FEC symbol error stream fe(m), the DNN-based estimation system 102 can compile and generate a histogram or probability density function (PDF) representing the probability of occurrence of a given number of FEC symbol errors in an FEC codeword of size Nfec, based on a set of FEC symbol error measurements spanning Ncw codewords. A codeword histogram (CWH) essentially maps the number of FEC symbol errors in a codeword of size Nfec to the probability of occurrence for that number of errors. An example of such a codeword histogram in tabular format is shown in Table 1:

TABLE 1
Example of Codeword Histogram

| Number of FEC Symbol Errors | Probability of Occurrence |
|---|---|
| in Codeword of Length Nfec (i) | hm(i, ber) |
| 0 | 0.889 |
| 1 | 1e⁻¹ |
| 2 | 1e⁻² |
| 3 | 1e⁻³ |
| 4 | 0 |
| 5 | 0 |
| and so on . . . | 0 |

Let us denote such a measurement-based histogram as hm(i, ber), where i represents the number of FEC symbol errors (as shown in the first column of Table 1), and ber represents the pre-FEC BER at which the codeword measurements were taken. Additionally, let hml(i, ber) represent the base-10 logarithm of the corresponding measured histogram, as shown in Equation 3:

$$h m l ( i , ber ) = log 10 ( h m ) \qquad ( Equation 3 )$$

### Approximate Codeword Histograms (CWH)

The baseline codeword histogram deviation metric (i.e., codeword histogram difference metric or SNR histogram difference metric) is obtained from a measured codeword histogram, which in turn is derived from measured FEC symbol errors fe(m) and the underlying bit errors e(n), as described previously. Obtaining the underlying true bit errors e(n) requires the ability to compare the received detected bits with the corresponding transmitted bits. This is typically accomplished in a training mode, where the transmitter sends a pattern, such as a pseudo-random binary sequence (PRBS), known to both the transmitter and receiver. However, it is highly desirable to be able to obtain codeword histograms without transmitting a training pattern, i.e., to compute the histogram when the transmitter is sending live user data not known to the receiver.

To achieve this, it is possible to directly obtain an approximate measurement of the FEC symbol error statistics by using information from the FEC decoder itself. Upon receiving a codeword from the SerDes, the FEC decoder will take one of several possible actions: (i) correct some number of FEC symbol errors in that codeword at the correct error locations in the received codeword; (ii) not make any correction attempt when there are no errors in the received codeword; (iii) not make any correction attempt when there are errors in the received codeword; or (iv) perform a mis-correction, i.e., fail to correct all the actual FEC symbol errors in the received codeword and possibly attempt to correct one or more FEC symbols not corresponding to the actual FEC symbol error locations in the codeword. The third and fourth scenarios are undesirable, with the fourth scenario being particularly harmful. However, FEC theory suggests that the probability of the last two scenarios occurring is significantly lower than that of the first two scenarios and thus negligible for many FEC codes. The higher the correction capability of the FEC code, the lower is the probability of undesirable scenarios. Thus, simply by examining the number of FEC symbol error corrections per codeword, fdec_corrcw(r), for the rth codeword attempted by the FEC decoder and considering them to be the actual number of FEC symbol errors in the received codeword, the DNN-based estimation system 102 can generate an approximate measured histogram. For technical accuracy, this is denoted as hma(i, ber), to distinguish it from hm(i, ber), which is the measured histogram derived from the true FEC symbol error stream obtained with a training pattern. The log₁₀ version of this is denoted by Equation 4:

$$hmal ( i , ber ) = log 10 ( h m a ) \qquad ( Equation 4 )$$

It should be noted that in scenarios (i) and (ii), fdec_corrcw will correspond to the true number of FEC symbol errors per codeword, whereas in scenarios (iii) and (iv), it will not. However, as noted earlier, the probability of scenarios (iii) and (iv) is typically very small compared with the probability of scenarios (i) or (ii). In subsequent block diagrams, the codeword histograms will be generically denoted by the abbreviation ‘CWH.’

### Burst Histograms (BURH)

A burst histogram represents the probability of a burst of a certain length occurring, as opposed to the probability of a certain number of errors within a fixed codeword length. Specifically, it is the probability of having a certain number of consecutive FEC symbols in error. For example, consider an error event in units of FEC symbols, where an ‘E’ represents an error in the FEC symbol and a ‘0’ represents no error in the FEC symbol. An isolated FEC symbol error—an isolated ‘E’ with no other errors nearby—can be represented as ‘ . . . 0000E0000 . . . ’ and corresponds to a burst length of 1. An error event such as ‘ . . . 0000EE0000 . . . ’ represents a burst of length 2, and so on. An example of such a codeword histogram is shown in Table 2:

TABLE 2
Example of Burst Histogram

| Number of Consecutive FEC | |
|---|---|
| Symbol Errors Across | Probability of Occurrence |
| Simulation/Measurements | hm(i, ber) |
| 0 | 0.889 |
| 1 | 1e⁻¹ |
| 2 | 1e⁻² |
| 3 | 1e⁻³ |
| 4 | 0 |
| 5 | 0 |
| and so on . . . | 0 |

In addition, it may be useful to consider an error-free interval (EFI) to evaluate burst error events in a more pessimistic manner. For example, the event ‘ . . . 0000E0E . . . ’ would normally be considered as two bursts of length 1 each. However, if a more pessimistic approach is taken (which may be justified in links with highly correlated errors), then with an EFI=1, the same error event would be counted as having a single burst of length 3. Similarly, with an EFI of 2, an event such as ‘ . . . 0000E00E0000 . . . ’ would be considered to have a burst length of 4. In subsequent block diagrams, burst histograms will be generically denoted by the abbreviation ‘BURH.’

### SNR Histograms

The following describes SNR histograms used in training a DNN. In at least one embodiment, a SerDes transmitter (TX) (e.g., transmitter circuit 120) typically transmits a binary data sequence, modulates it with a pulse amplitude modulation (PAM) format such as PAM2 (two amplitude levels) or PAM4 (four amplitude levels). These are example modulation formats; others may also be considered. The modulated sequence may be equalized with transmit equalization and sent through the communication channel 124, followed by a SerDes receiver (RX) equalizer (e.g., receiver circuit 122), which produces a received equalized output y(n). This output may be equalized to a non-return-to-zero (NRZ) target or to a partial response (PR) target. If a known pseudo-random binary sequence (PRBS) is transmitted through the link (communication channel 124), a received error signal, errtrue(n), can be computed with respect to the known transmitted bits converted to the corresponding equalized/modulated signal ytx(n), as expressed in Equation 5:

$$e r r t r u e ( n ) = y ( n ) - y t x ( n ) \qquad ( Equation 5 )$$

If a known PRBS sequence is not used, the SerDes RX can still compute a received detected error signal, errdet(n), using a sliced or data-detected estimate of ytx(n), referred to here as ydet(n), as expressed in Equation 6:

errdet(n)=y(n)−ydet(n) (Equation 6)

The traditional nominal SNR metric, SNRnom, is typically computed using the variance of the measured or detected error over a large number of samples, as shown in Equation 7:

$$errdetvarnom = \frac{1}{K} {{\sum }_{n = 1}}^{K} {errdet ( n )}^{2} \qquad ( Equation 7 )$$

where K is typically a very large number to achieve good averaging, for example, 1e⁵, 1e⁶, or more equalized samples. For simplicity, the expression above for the variance assumes a nominally zero-mean error sequence, whether it is errtrue(n) or errdet(n). This will be the case in most systems, especially those with explicit hardware or circuits to remove any non-zero DC mean. As is well known in the engineering community, a more general expression for the variance can eliminate the impact of any non-zero mean with only minor changes, as expressed in Equation 8:

$$errdetvarnom = \frac{1}{K} {\sum }_{n = 1}^{K} {( errdet ( n ) - errdetmn )}^{2} \qquad ( Equation 8 )$$

where errdetmn is the mean of the errdet(n) sequence and can be computed as shown in Equation 9:

$$errdetmn = \frac{1}{K} {\sum }_{n = 1}^{K} errdet ( n ) \qquad ( Equation 9 )$$

However, for the sake of simplicity, the simpler expression for variance computations is used throughout this disclosure. It should be understood that any of the subsequent expressions for variance could be modified to properly account for a non-zero mean.

If the nominal signal power in the transmitted signal or received equalized signal is denoted as sigvar, then SNRnom is traditionally computed as shown in Equation 10:

$$SNRnom ( dB ) = 10 * log 10 ( sigvar / errdetvarnom ) \qquad ( Equation 10 )$$

The signal power can be computed from the set of expected equalized signal values, which will be taken from the set of values for ytx(n) or ydet(n). For example, in a PAM4 modulated system with transmitted symbol values of 3, 1, −1, and −3, the nominal signal power can be computed as shown in Equation 11:

$$sigvar = ( 1 / 4 ) * ( 3 \hat{} 2 ) + ( 1 / 4 ) * ( 1 \hat{} 2 ) + ( 1 / 4 ) * ( ( - 1 ) \hat{} 2 ) + ( 1 / 4 ) * ( ( - 3 ) \hat{} 2 ) = 5 \qquad ( Equation 11 )$$

In the expression, the factors of (¼) represent the probability of occurrence for each possible PAM4 symbol value. For a partial response (PR) equalized system, the signal variance can be computed based on the expected received PAM4 PR symbols. For example, for a (1+D) PR1 system, the PAM4 PR1 system symbol values will be 6, 4, 2, 0, −2, −4, and −6, and sigvar can be computed in a similar fashion, accounting for the probability of occurrence of each specific symbol value.

Having described the SNR calculation, it can be observed that using a single number, as described above, does not provide adequate insight into or always correlate well with post-FEC performance behavior. As such, SNR metrics taken from an SNR histogram can be considered, where each SNR value measured is defined over a window of time, L. From multiple such measured SNR values, a measured SNR histogram can be obtained. Exemplary values of L could be in the hundreds or thousands of equalized samples and should be chosen appropriately depending on the application. Over the time window of L received PAM2 or PAM4 (or other) modulated symbols or corresponding equalized samples, a statistical variance or, equivalently, a standard deviation of these error quantities can be computed as expressed in Equation 12 and Equation 13:

$$errtruevar = \frac{1}{L} {\sum }_{n = 1}^{L} {errtrue ( n )}^{2} \qquad ( Equation 12 )$$

$$errdetvar = \frac{1}{L} {\sum }_{n = 1}^{L} {errdet ( n )}^{2} \qquad ( Equation 13 )$$

If the nominal signal power in the transmitted signal or the received equalized signal (it is not critical which one is used) is denoted as sigvar, then the SNR for the above error variants is defined as shown in Equation 14 and Equation 15:

$$SNRTRUE ( dB ) = 10 * log 10 ( sigvar / errtruevar ) \qquad ( Equation 14 )$$

$$SNRDET ( dB ) = 10 * log 10 ( sigvar / errdetvar ) \qquad ( Equation 15 )$$

It should be noted that the SerDes RX may transfer raw error data, such as errtrue(n) or errdet(n), to the DNN-based estimation system 102, which may then compute the SNR and SNR histograms. Alternatively, the SerDes hardware may compute the SNR metrics internally using appropriate hardware blocks to implement Equation 14 and Equation 15, and the resulting SNR data can be sent to the DNN-based estimation system 102.

It may be beneficial for the value of L to be related to the FEC codeword size. In an exemplary system with the well-known code (Nfec=544, Kfec=514, Tfec=15) defined over a Galois field of 10 bits, the codeword size is 544 FEC symbols or 5440 bits. For a PAM4 system, this corresponds to 2720 PAM4 symbols, since each PAM4 symbol comprises 2 bits. Thus, a value of L=2720 may be desirable.

From the SNRTRUE or SNRDET data, the DNN-based estimation system 102 can compile and generate the histogram or probability density function (PDF) statistics representing the probability of occurrence of the various measured SNR values. An SNR histogram is essentially a mapping between the SNR value over window L and the probability of occurrence for that SNR value.

For example, the DNN-based estimation system 102 can denote a measurement-based histogram as h_{SNR}(SNRi), including possible measured values of the SNR (either SNRTRUE or SNRDET), where i is an index that references a list of SNR values over which the histogram is computed. A histogram could be computed over a range from SNRmin=14 to SNRmax=24 dB in steps of SNRstep=0.1 dB, representing a list of Q SNR values indexed by i=1 to 101, where in this example Q=101. From many measurements of the SNR, for example, NSNR=10,000 measurements, the DNN-based estimation system 102 can compute the measured SNR histogram. Each of these measurements consists of L individual measurements of the equalized error errtrue(n) or errdet(n) to obtain errtruevar or errdetvar, as previously described. Now suppose the SNR value of 19.2 dB occurs 10 times. For the above example of 14 to 24 dB with steps of 0.1 dB, the value 19.2 dB corresponds to index i=53. Then, the probability assigned to 19.2 dB at index i=53 in the histogram is 10/NSNR=1e⁻³.

Also, let hSNRL(SNRi) represent the base-10 logarithm of the corresponding measured and target codeword histograms, as shown in the following Equation 16:

$$hSNRL ( SNRi ) = log 10 ( hSNRi ) \qquad ( Equation 16 )$$

In the case of interleaving, the calculation of the SNR can be modified to account for interleaving as follows. The following refers to computations using either the true error (errtrue) or the detected error (errdet), using the generic variable err. Likewise, their corresponding SNRs are represented by the generic variable SNR, which can refer to either SNRtrue or SNRdet. Let us consider a window of M PAM4 symbols that comprise one FEC symbol. For example, for a well-known FEC code (Nfec=544, Kfec=514, Tfec=15) defined over a Galois field of 10 bits, the FEC symbol size is 10 bits. Thus, M=5 would be chosen since each PAM4 symbol consists of 2 bits.

$$errvarfsym = \frac{1}{M} {\sum }_{n = 1}^{M} {err ( n )}^{2} \qquad ( Equation 17 )$$

$$SNRFSYM ( dB ) = 10 * log 10 ( sigvar / errvarfsym ) \qquad ( Equation 18 )$$

The sequence of SNRFSYM values can be passed through an equivalent RS de-interleaver function, RSILD, such that individual SNRFSYM values are manipulated in the same way as FEC symbol errors would be through a de-interleaver, as illustrated in FIG. 3. The output of this manipulation results in a deinterleaved SNR, denoted as SNRFSYMIL, which reflects the properties of the deinterleaver and correlates well with post-FEC bit error rate performance, accounting for the deinterleaver behavior. This equivalent RSILD functionality may be implemented in hardware or software. It will be designed differently from a standard RSILD block, which operates on integer FEC symbols or FEC symbol errors. From the SNRFSYM, a windowed or averaged SNR post-interleaving can be computed as set forth in Equation 19:

$$SNRIL = \frac{1}{K} {\sum }_{l = 1}^{K} SNRFSYMIL ( l ) , \qquad ( Equation 19 )$$

where K represents the windowing span. To equivalently match the prior window of L for the non-deinterleaved case, for example, K could have a value of L/M, which implies that our effective averaging window is L=K×M. SNR histograms would now be computed using SNRIL.

In at least one embodiment, the DNN-based estimation system 102 can receive equalized error data from the receiver circuit 122. The receiver circuit 122 (SerDes RX) also typically has an associated pre-FEC SNR, which can be characterized. A nominal SNR, SNRnom, can be measured by taking the variance of a large number of equalized error samples and is mainly reflective of pre-FEC performance and pre-FEC BER. In at least one embodiment, the DNN-based estimation system 102 can receive SNR data from the receiver circuit 122. The DNN-based estimation system 102 can collect and process this data as part of DNN training. Once the DNN is trained, this data may not necessarily be collected or processed as part of DNN inference.

In at least one embodiment, the DNN-based estimation system 102 can receive equalized error data from the receiver circuit 122. The receiver circuit 122 (SerDes RX) also typically has an associated pre-FEC SNR, which can be characterized. A nominal SNR, SNRnom, can be measured by taking the variance of a large number of equalized error samples and is mainly reflective of pre-FEC performance and pre-FEC BER. In at least one embodiment, the DNN-based estimation system 102 can receive SNR data from the receiver circuit 122. The DNN-based estimation system 102 can determine an SNR histogram (and a related post-FEC correlated performance metric) using equalized error data (or the SNR data) received from the receiver circuit 122. The DNN-based estimation system 102 can adapt encoding/decoding layer parameters (FEC-related parameters) and/or SerDes parameters using the SNR histograms (and related post-FEC correlated performance metric). The DNN-based estimation system 102 can collect and process this data as part of DNN training. Once the DNN is trained, this data may not necessarily be collected or processed as part of DNN inference.

In subsequent block diagrams and descriptions, the SNR histograms based on SNR or SNRIL will be generically denoted by the abbreviation ‘SNRH.’

### Traditional Post-FEC BER Estimation Techniques

FIG. 4 are block diagrams of three high-level types of post-FEC BER estimation techniques according to various implementations.

### Post-FEC BER Estimation Based on the ‘Random’ Binomial Model

A classical model for computing post-FEC BER requires knowledge of only the pre-FEC BER and the FEC codeword size to estimate the post-FEC BER. However, this model assumes that errors are random and uncorrelated, and uses a binomial probability distribution to compute post-FEC BERs. As such, it will not yield accurate post-FEC BER estimates for channels/links that have correlated or burst errors, including links where the SerDes RX is equalized to a partial response and/or utilizes precoding or concatenated codes in addition to RS FEC.

### Post-FEC BER Estimation Based on Multinomial Model and Variants

Other post-FEC modeling/estimation techniques in the literature attempt to account for correlation in FEC symbol errors using ‘multinomial’ models. These models, which comprise an underlying set of multinomial probabilities, make use of codeword histograms (CWH) or burst histograms (BURH). Codeword histograms can be measured directly from transient simulation and/or silicon data. Likewise, burst histogram data for a given EFI can also be measured directly from transient simulation and/or silicon data, as described above. It can also be extracted from the codeword histogram data. The codeword histograms or burst histograms, along with the pre-FEC BER, can be fed into a semi-analytic model together with the corresponding FEC parameters. The semi-analytic model then determines the post-FEC BER estimation. A block diagram of the flow of such post-FEC BER estimation techniques is shown in FIG. 4.

### Post-FEC BER Estimation Based on SNR Histograms

In at least one embodiment, another post-FEC modeling estimation technique includes using SNR histograms (SNRH), as described above. In this embodiment, SNR histograms can be measured directly from transient simulation and/or silicon data. This data can be collected for different FEC parameters. The SNRH and the pre-FEC BER can be fed into a semi-analytic model, along with the corresponding FEC parameters. The semi-analytic model determines the post-FEC BER estimation.

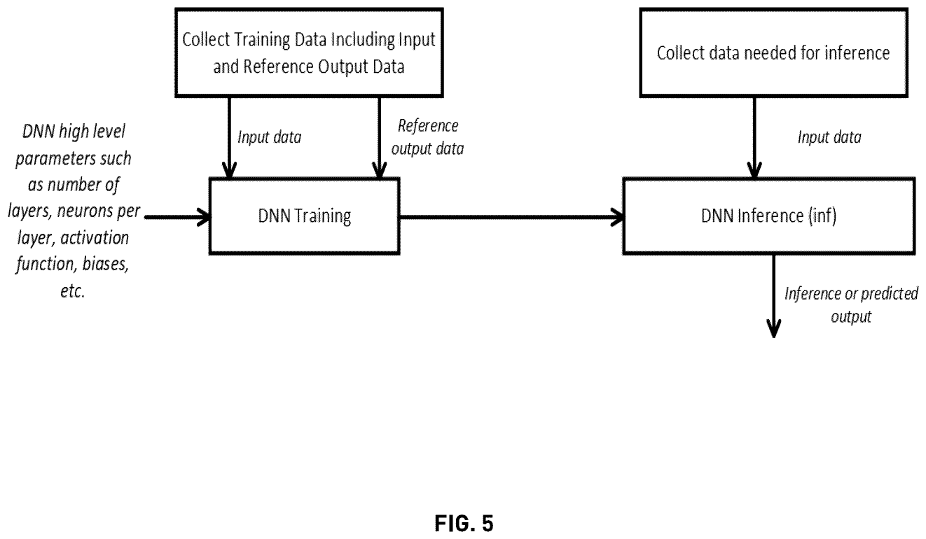

FIG. 5 is a block diagram of a DNN training and inference architecture according to at least one embodiment. In this architecture, a DNN is used to predict post-FEC BER as the desired output. The DNN-predicted post-FEC BER can be used to adapt FEC-related parameters and/or link parameters (i.e., SerDes parameters).

A DNN model takes certain input data and reference output data so that, upon training, the DNN is able to create a model for the relationship between the input data and reference output data. Once the model has been trained, it can be used for inference or prediction to take a new set of input data and predict the corresponding output data using the DNN model. There are various generic training algorithms available for public use. For the embodiments described herein, the output reference data and predicted output data are post-FEC BER for communication links. The input data with which the DNN is trained, and new input data used to infer post-FEC BER data, may vary depending on the formulation of the algorithm.

### Generalized DNN Training and Inference Based on Channel Properties, Link/SerDes Properties, Channel/Receiver Impairment Properties

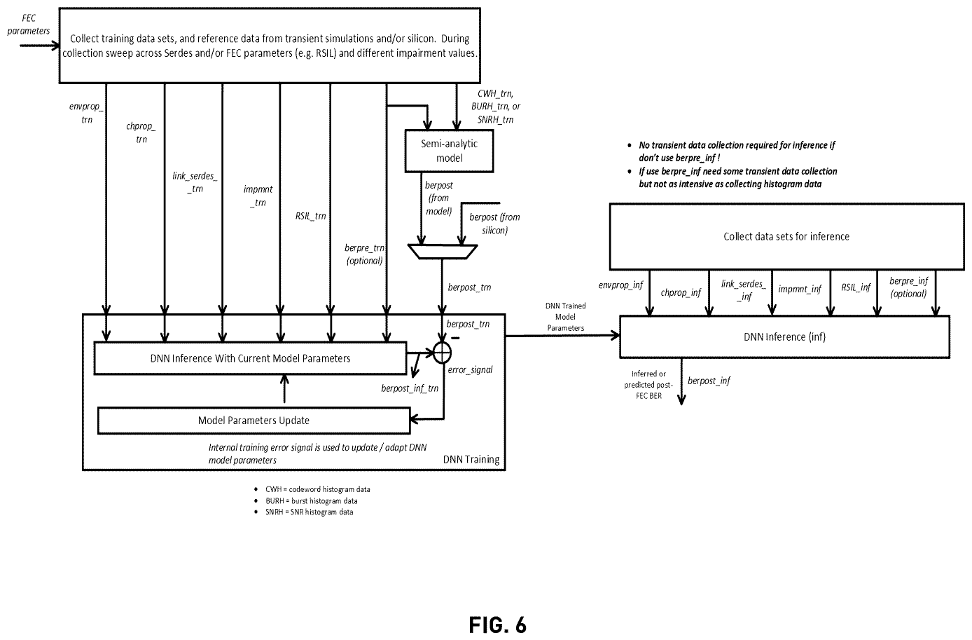

FIG. 6 is a block diagram of a post-FEC BER estimation architecture using DNN-based training according to at least one embodiment.

The post-FEC BER performance of a communication link or channel has a complex dependence on the properties of the channel and the various impairments present in the system. The block diagram in FIG. 6 shows the overall architecture for training and inference in our proposed system. Data is collected via transient simulations to generate codeword histograms, burst histograms, or SNR histograms, depending on which semi-analytical model type is used during the training phase for post-FEC BER estimation. The histogram data may also be collected from silicon, and if post-FEC BER data is available in silicon, it may be collected as well. From the semi-analytical model or silicon data, the post-FEC BER is denoted as berpost_trn. Additionally, the environmental properties in which the SerDes and channel are operating, selected link/SerDes properties/settings, and key impairment properties for the link being considered can be characterized. The collection of environmental, channel, link/SerDes, and impairment properties-denoted generically as envprop_trn, chprop_trn, link_serdes_trn, and impmnt_trn are also recorded, optionally with the corresponding pre-FEC BER (berpre_trn) and the interleaving factor, (RSIL_trn). All this information is collected and recorded over a large aggregate collection of links and is used to train a DNN model, with the goal that the DNN model's output matches berpost_trn as closely as possible. The input layer of the DNN will consist of as many parameters as needed to characterize the channel, link/SerDes, and impairment values, along with berpre_trn (optionally) and RSIL_trn. The output layer consists of a single neuron whose output value represents the post-FEC BER. Inside the training block, some additional implicit details are shown. The training will start with some initial DNN model parameters, which will be used to infer the interim post-FEC BER during training, denoted as berpost_trn_inf. A training error signal will be computed between this interim berpost_trn_inf value and the reference berpost_trn value, and the error signal will be used to update or adapt the DNN model parameters. It should be noted that in subsequent figures, these details of the DNN training block are omitted.

### Example Environmental Properties for Training/Inference

Operating temperature for the SerDes, channel, or other link components
Operating voltage of the channel, link components, transmitter SerDes, and receiver SerDes
Nominal manufacturing process corner (e.g., slow/nominal/fast) of the transmitter SerDes and receiver SerDes

### Example Channel Properties Used for Training/Inference

Channel through-path (signal transmission path as opposed to crosstalk or other impairment paths) loss at one or more frequencies, such as the Nyquist frequency, half-Nyquist frequency, or others
Channel through impulse response values. For multi-part optical links, the response could be an aggregate of all the individual component responses, including optical components such as the optical module transmitter response, optical fiber transmission response, and optical transimpedance amplifier (which converts light to current) response.
Channel S-parameters—these represent the most comprehensive and detailed representation of channel properties and account for both through responses, crosstalk responses, differential-to-common mode conversion, and common-to-differential mode conversion.

### Example Link/SerDes Properties or Settings Used for Training/Inference

Transmit optical link power for optical links
Other optical module settings such as equalization/gain values
TX SerDes launch amplitude
RX SerDes ADC full-scale voltage
TX or RX PLL phase noise control (e.g., different PLL controls may offer different tradeoffs between SerDes power and phase noise properties, whose low-frequency characteristics can significantly affect post-FEC behavior)
RX AFE noise control (e.g., different RX AFE controls may offer different tradeoffs between SerDes power and AFE bandwidth or output noise)

### Example Impairment Properties

Crosstalk aggregate noise root mean square (r.m.s.) or standard deviation value. For multi-part optical links, multiple r.m.s. values of the crosstalk for each link section would be used
Crosstalk impulse responses
Crosstalk S-parameter responses
Transmitter noise r.m.s. or standard deviation value
Transmitter noise power spectral density profile(noise magnitude vs. frequency)
Transmitter jitter components in terms of r.m.s. values, peak-to-peak values, or phase noise profiles, depending on the component
Receiver noise power spectral density profile(noise magnitude vs. frequency)
Receiver noise r.m.s. or standard deviation value
Receiver jitter components in terms of r.m.s. values, peak-to-peak values, or phase noise profiles, depending on the component
For optical links, optical transmitter module noise r.m.s. or standard deviation value
For optical links, optical transmitter module noise power spectral density profile (noise magnitude vs. frequency)
For optical links, fiber properties such as responsivity frequency profile
For optical links, optical receiver transimpedance amplifier noise r.m.s. or standard deviation value
For optical links, optical receiver transimpedance amplifier noise power spectral density profile (noise magnitude vs. frequency)
Other transmitter and receiver impairments characterized in various forms such as r.m.s. value, peak-to-peak value, power spectral densities, etc. Impairments could consist of transmitter digital-to-analog converter (DAC) quantization effective number of bits (ENOB), receiver analog-to-digital converter (ADC) ENOB, clock data recovery (CDR) self-jitter, residual voltage offsets at various points in the receiver, residual gain mismatches at various points in the receiver, and residual phase mismatches at various points in the receiver
Channel common-mode to differential-mode conversion factor at one or more frequencies, or common-mode to differential-mode frequency response profile
Channel differential-mode to common-mode conversion factor at one or more frequencies, or differential-mode to common-mode frequency response profile. Note that the use of channel S-parameters in lieu of through impulse responses may automatically capture some of the channel-related impairments, such as channel common-mode to differential-mode conversion or vice versa.

### Use of Optional Pre-FEC BER

Using the pre-FEC BER during training and inference may improve the accuracy of the overall estimation process. The use of pre-FEC BER during inference does require some transient data collection, whether from simulation or silicon. However, this data collection effort is significantly less intensive than that required to collect codeword, burst, or SNR histograms. If the list of channel properties and impairment properties is comprehensive enough, the use of pre-FEC BER may not be needed at all and thus is considered optional. In this scenario, no transient data collection is required during the inference process to estimate berpost_inf.

### Use of Subsets of Impairments

Note that the number of impairments used for training or inference need not be the full set of impairments present. Some impairments might be excluded from the list if experience or other theoretical considerations show they impact post-FEC BER less, or if the subset of impairments does not vary across all possible link training or inference cases. For example, ADC ENOB may not vary significantly across link cases and corresponding TX/RX settings invoked by the link and possibly could be excluded.

### Delta Post-FEC BER Approach to Training and Inference

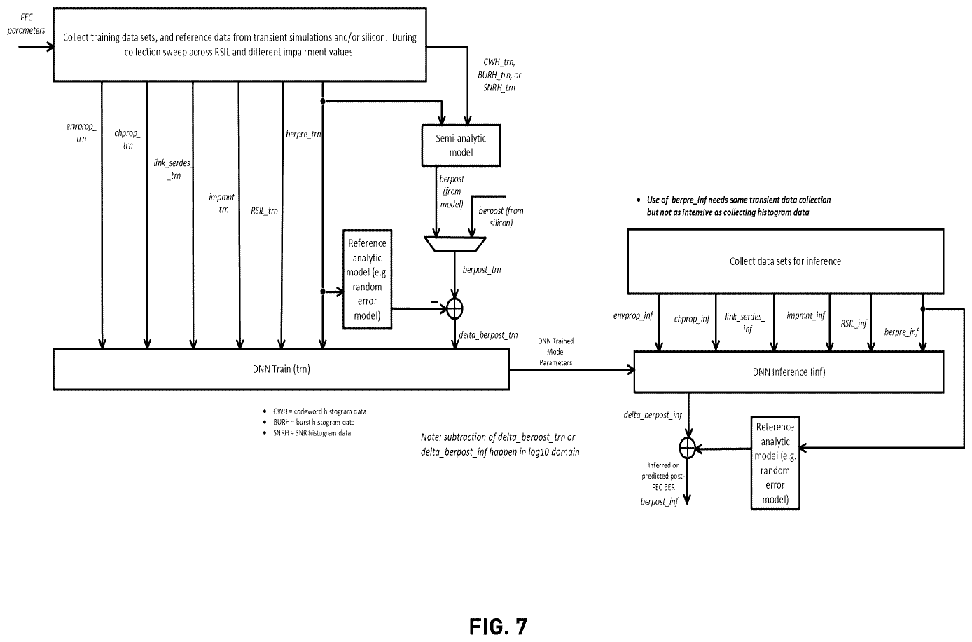

FIG. 7 is a block diagram of an alternative architecture for post-FEC training and inference according to at least one embodiment. The architecture is used to train and infer what is called a ‘delta post-FEC BER.’ This delta post-FEC BER is the difference (in the log 10 domain) between the post-FEC BER predicted by the semi-analytic model for a given channel and the post-FEC BER predicted by some other reference analytic model, with both models operating on data for the same pre-FEC BER. An example reference model is the pure random error model behavior as determined solely by the pre-FEC BER for that channel. The random error model is well known in the literature and is based on a binomial random probability distribution of the FEC symbol error statistics. With this approach, instead of training on the post-FEC BER, which can vary over a much wider dynamic range, training can be performed on the delta post-FEC BER, which can have a smaller dynamic range. Thus, prediction efficacy may be facilitated or possibly performed with simpler DNN models. Once the trained DNN model is obtained, during the inference process, instead of directly inferring or predicting the post-FEC BER, the delta post-FEC BER can be inferred and then added to the corresponding random error model post-FEC BER for the same pre-FEC BER. The result of this addition gives the final inferred or predicted post-FEC BER. The subtraction/addition operations are, of course, performed in the log 10 domain.

Also, the random error model need not be the only possible reference model. Other analytic models, such as Markov chain-based analytical models, could also be used as reference models.

### Top Level System Block Diagrams Incorporating DNN Training and Inference

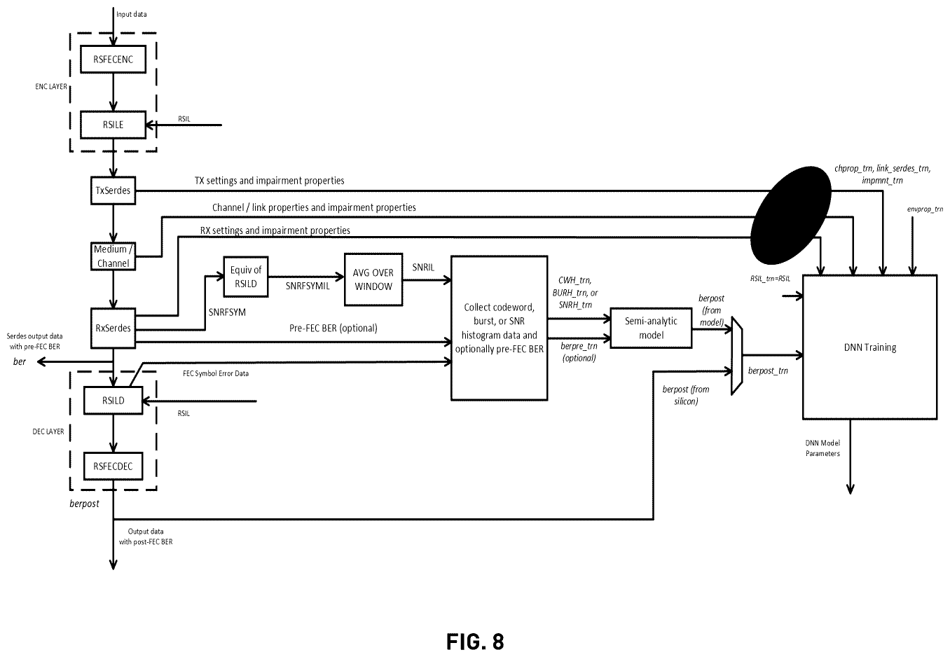

FIG. 8 is a block diagram of an overall link/SerDes/FEC architecture incorporating DNN-based training according to at least one embodiment. It should be noted that various channel properties, link properties, TX SerDes settings, impairment properties, and RX SerDes settings are aggregated into the generic variables chprop_trn, link_serdes_trn, and impmnt_trn.

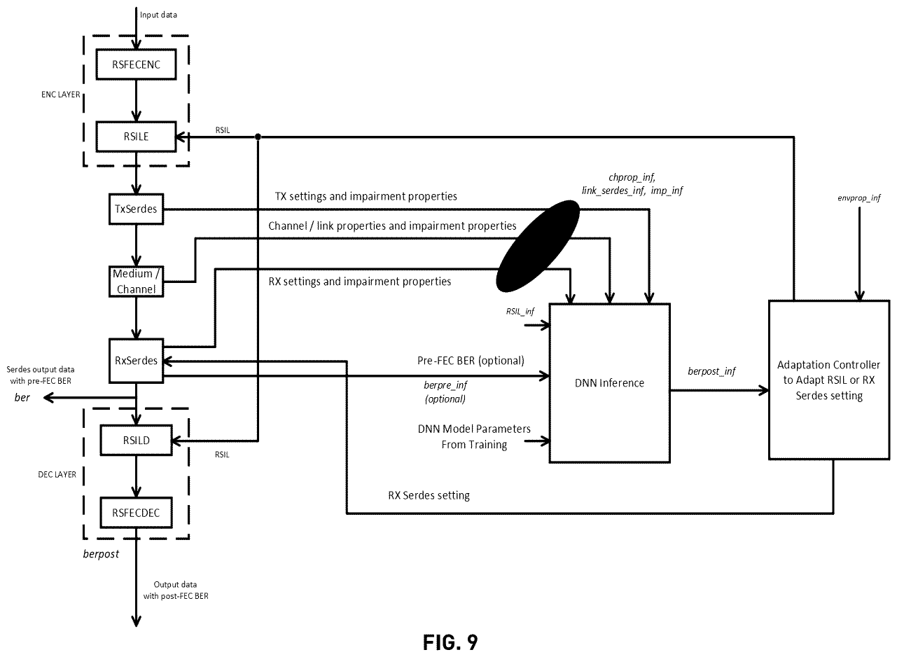

FIG. 9 is a block diagram of an overall link/SerDes/FEC architecture incorporating DNN-based inference according to at least one embodiment. The architecture shows the DNN-based inference/post-FEC BER estimation once the DNN-based training of FIG. 8 is completed. The DNN model parameters of FIG. 9 would be populated using the final trained model values from FIG. 8. As shown, the estimated post-FEC BER can be used to adapt the FEC interleaving factor RSIL or, for example, a particular RX SerDes setting. This can be performed by using a grid search to infer post-FEC BER across different RSIL values or RX SerDes setting values. One could choose the optimal value of RSIL or SerDes RX setting or choose the RSIL or SerDes RX setting at which increasing RSIL or changing the RX setting does not result in significant further improvement in post-FEC BER.

### Alternative Training/Inference Framework

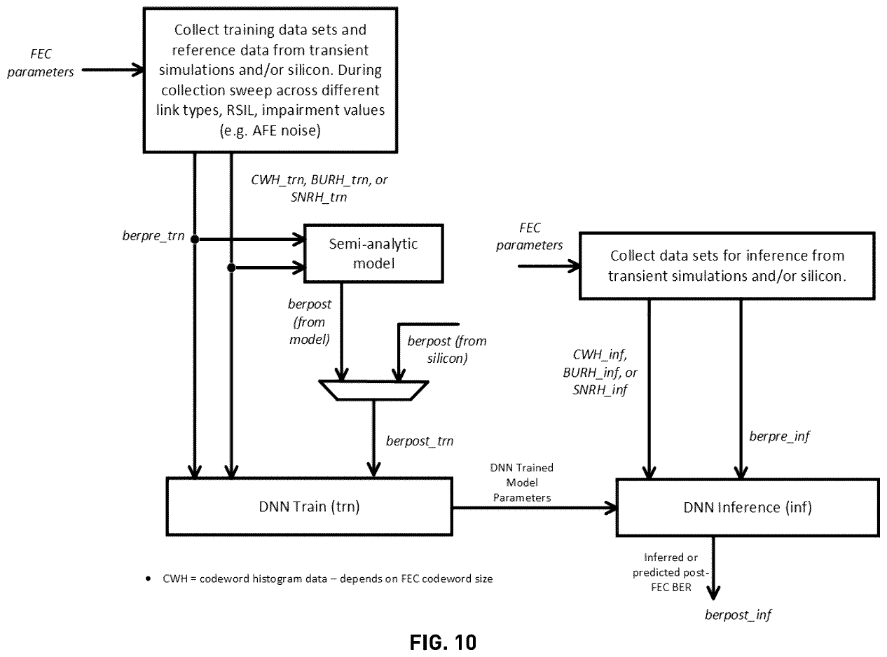

FIG. 10 is a block diagram of an alternative framework for training and inference according to at least one embodiment. In this framework, the DNN model can be trained using only the pre-FEC BER and either codeword histogram, burst histogram, or SNR histogram information collected from transient simulation or silicon data. During training, as much silicon-provided data as possible should be obtained for the post-FEC BER reference data for medium and higher impairment values. During the inference phase, collect codeword histogram, burst histogram, or SNR histogram data and pre-FEC BER data, and use the DNN model to estimate the post-FEC BER. Compared with the more generalized framework of FIG. 6, there is no reduction in data collection requirements during the inference phase. However, compared with prior solutions, this approach reduces dependence on the use of the semi-analytical model to obtain post-FEC BER for medium and higher impairment values. Additionally, the accuracy may be better than the more generalized approach since histograms are used directly for inference and training, and the process is not based on channel or impairment properties but solely on the histogram data.

Periodic DNN Training and/or Inference for Post-FEC BER Estimation and Adaptation

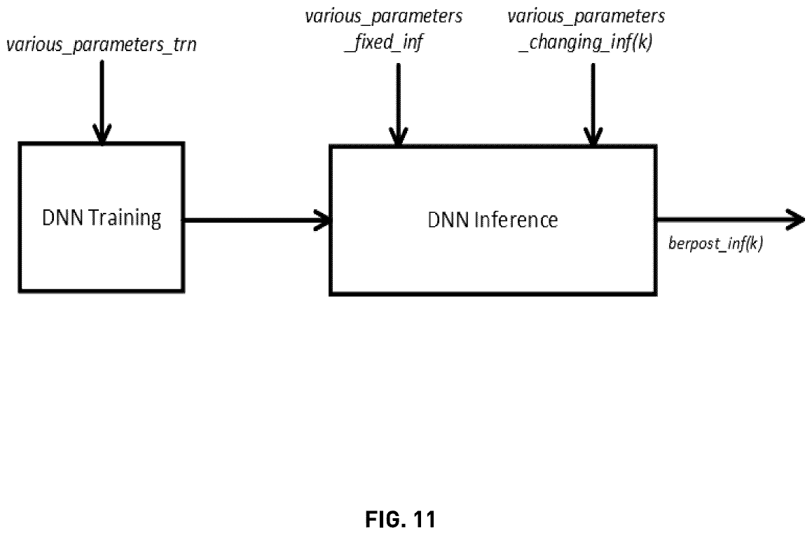

The discussion thus far may suggest that once DNN training has been accomplished, the post-FEC BER is estimated one time for a given link based on DNN inference. In practice, DNN training and/or DNN inference can be performed periodically. For example, after performing training and then estimating post-FEC BER through inference for a particular link, the environmental temperature may change. The post-FEC BER can be periodically estimated using inference, keeping all other inference parameters the same as before while only changing the temperature parameter. An example of this periodic inference is shown in FIG. 11, where the variable k represents the time period at which post-FEC BER is re-inferred.

FIG. 11 is a block diagram illustrating periodic inference, where some parameters from inference are kept fixed while other inference parameters are varied, and k represents the time period at which post-FEC BER is re-inferred according to at least one embodiment.

For example, k could be set to 24 hours, such that the post-FEC BER is re-inferred or estimated once every day, with the new temperature of the environment being updated for the re-inference once per day. This can be done periodically without retraining the DNN. Only if some environmental conditions change and exceed the ranges established during the original training phase would the DNN need to be retrained. This can still be done as long as new relevant data is collected for retraining. For example, suppose initial training was performed in the range of −40 degrees Celsius to 75 degrees Celsius. If the device temperatures exceed 75 degrees Celsius and reach up to 100 degrees Celsius, inference based on the prior DNN model parameters may no longer be accurate. The DNN would need to be retrained for higher temperatures, and if any training parameters (e.g., receiver noise) were significantly different at the higher temperature, the corresponding proper values of the relevant training parameters would need to be provided for DNN training.

### DNN Training Guardrails

To work with a training set that will produce sensible model parameters and more consistent predicted post-FEC BERs during inference, some filtering criteria can be considered for the training data set to ensure it does not contain anomalous cases, such as a SerDes receiver whose equalization or clock data recovery is not stable or is not behaving as expected in a well-designed system. Also, depending on the semi-analytic model used, it is possible that, due to scarce available data or numerical issues, the semi-analytical model's post-FEC estimated BER during training could be noisy or non-monotonic for a particular link or channel where the impairment is swept in a monotonically increasing value. Examples of such guard railing criteria to filter out bad training data include:
Whether or not SNR histograms are used for the semi-analytic model, ensure that SNR histograms are not multimodal but have a single, well-defined peak. Multimodal SNR histograms may indicate receiver equalization or clock data recovery drift.
Ensure that codeword histograms are sufficient in length before use in the semi-analytic model. For example, if only one or two bins are observed in the data, do not use them.
Ensure that codeword histograms do not have large ‘holes’, a codeword histogram with non-zero probability bins for lower values, followed by one or more bins without data, and then again followed by non-zero probability bins.
For a given link if there is monotonically swept impairment data, ensure that the semi-analytic model provides monotonic outputs and potentially discard any data which deviate significantly from the post-FEC BER vs. impairment value average trend line or replace such deviating data with data corresponding with the average trend line.

### Variations

The system to which DNN-based post-FEC BER estimation and adaptation has been applied utilizes a single RS FEC encoder and decoder. Note that other types of encoder/decoder configurations are possible.
It is possible to implement a concatenated FEC system, such as an RS encoder/interleaver followed by a BCH encoder/interleaver on the encoding/transmit side, and an RS deinterleaver/RS decoder preceded by a BCH deinterleaver/BCH decoder on the decoding/receive side.
The block diagram in FIG. 9 shows adaptation of the RS interleaving parameters. Other FEC or SerDes parameters could also be adapted, provided their values are properly incorporated into both the training and inference phases of system operation.
For SerDes parameters, it is important to be judicious in selecting which parameters to adapt using a DNN-based adaptation flow. For example, it may be preferable to adapt only major parameters that are not easily amenable to traditional adaptation methods, such as a least mean squared adaptation algorithm.
The adaptation block diagram in FIG. 9 could be appropriately modified to work with the delta post-FEC BER estimation approach as well.
Although indicated in the block diagram, it is explicitly noted here that data collection during the training phase can be performed using a hybrid approach, with a mix of silicon-obtained post-FEC BER reference data and semi-analytic model-obtained post-FEC reference data. Non-zero post-FEC BER data from silicon can be available at higher noise levels or other higher values of impairments, with higher impairment values being applied to the link either via external stimuli or potentially self-generated SerDES impairments. At lower impairment levels, since even silicon may not be able to produce non-zero post-FEC BER data in a reasonable time, codeword histogram or SNR data would need to be collected from silicon, and reference post-FEC BER data generated from the histogram data using one or more semi-analytic models.

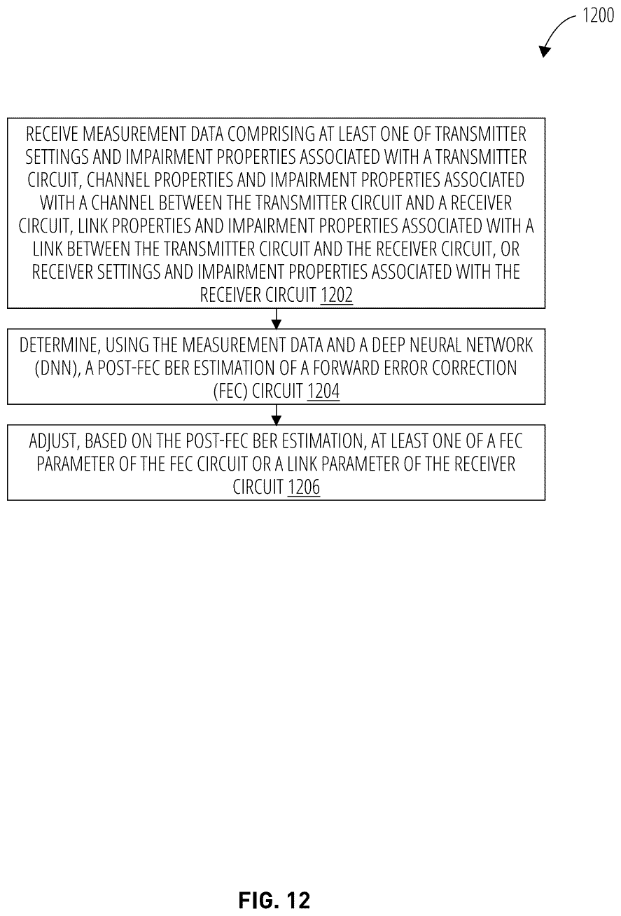

FIG. 12 is a flow diagram of an example method 1200 for determining a post-FEC BER estimation using a DNN according to at least one embodiment. Method 1200 can be performed using one or more processing units (e.g., CPUs, GPUs, accelerators, physics processing units (PPUs), data processing units (DPUs), etc.), which may include (or communicate with) one or more memory devices. In at least one embodiment, the method 1200 can be performed by using a processing device or devices. In at least one embodiment, the method 1200 can be performed using processing units of the DNN-based estimation system 102 of FIG. 1 or FIG. 2. In at least one embodiment, method 1200 can be performed by the DNN-based estimation system 102 of FIG. 2. In at least one embodiment, processing units performing method 1200 can execute instructions stored on a non-transient computer-readable storage medium. In at least one embodiment, the method 1200 can be performed using multiple processing threads (e.g., CPU threads and/or GPU threads), with individual threads executing one or more functions, routines, subroutines, or operations of the method. In at least one embodiment, processing threads implementing the method 1200 can be synchronized (e.g., using semaphores, critical sections, and/or other thread synchronization mechanisms). Alternatively, processing threads implementing the method 1200 can be executed asynchronously with respect to each other. Various operations of method 1200 can be performed in a different order than shown in FIG. 12. Some operations of the method 1200 can be performed concurrently with other operations. In at least one embodiment, one or more operations shown in FIG. 12 may not always be performed.

At block 1202, processing units executing method 1200 can receive measurement data comprising at least one of: transmitter settings and impairment properties associated with a transmitter circuit; channel properties and impairment properties associated with a channel between the transmitter circuit and a receiver circuit; link properties and impairment properties associated with a link between the transmitter circuit and the receiver circuit; or receiver settings and impairment properties associated with the receiver circuit. At block 1204, processing units executing method 1200 can determine, using the measurement data and a DNN, a post-FEC BER estimation of a FEC circuit. At block 1206, processing units executing method 1200 can adjust, based on the post-FEC BER estimation, at least one of a FEC parameter of the FEC circuit or a link parameter of the receiver circuit.

In at least one embodiment, the processing units executing method 1200 can train the DNN based on training data and at least one of a codeword histogram, a burst histogram, or an SNR histogram. The training data can include one or more of the following: additional transmitter settings and impairment properties associated with the transmitter circuit; additional channel properties and impairment properties associated with the channel between the transmitter circuit and the receiver circuit; additional link properties and impairment properties associated with the link between the transmitter circuit and the receiver circuit; and additional receiver settings and impairment properties associated with the receiver circuit. In some embodiments, the training data includes pre-FEC performance training data.

In at least one embodiment, the processing units executing method 1200 can train the DNN by: determining, using the DNN with current model parameters, a first training post-FEC BER estimation; determining, using a semi-analytic model and at least one of the codeword histogram, the burst histogram, or the SNR histogram, a second training post-FEC BER estimation; determining an error signal between the first training post-FEC BER estimation and the second training post-FEC BER estimation; updating, using the error signal, the current model parameters to obtain trained model parameters for the DNN; and outputting the trained model parameters of the DNN.

In at least one embodiment, the processing units executing method 1200 can train the DNN by: determining, using the DNN with current model parameters, a first training post-FEC BER estimation; determining, using a semi-analytic model and at least one of the codeword histogram, the burst histogram, or the SNR histogram, a second training post-FEC BER estimation; determining, using a random error model and pre-FEC performance training data, a third training post-FEC BER estimation; determining a difference estimation between the second training post-FEC BER estimation and the third training post-FEC BER estimation; determining an error signal between the first training post-FEC BER estimation and the third training post-FEC BER estimation; updating, using the error signal, the current model parameters to obtain trained model parameters for the DNN; outputting the trained model parameters of the DNN; determining, using the DNN with the trained model parameters, a second difference estimation; determining, using pre-FEC performance data and the random error model, a second post-FEC BER estimation; and determining, using the second difference estimation and the second post-FEC BER estimation, the post-FEC BER estimation.

In a further embodiment, the processing units executing method 1200 can adjust at least one of the FEC parameters or the link parameters by changing an interleave factor of an interleaver of the FEC system from a first value to a second value.

In a further embodiment, the processing units executing method 1200 can adjust at least one of the FEC parameters or the link parameters by changing a first interleave factor of a first interleaver of the FEC system from a first value to a second value, and changing a second interleave factor of a second interleaver of the FEC system from a third value to a fourth value.

In a further embodiment, where the receiver circuit is a SerDes circuit, the processing units executing method 1200 can adjust at least one of the FEC parameters or the link parameters by changing a SerDes parameter of the SerDes circuit from a first value to a second value.

In a further embodiment, where the receiver circuit is a SerDes circuit, the processing units executing method 1200 can adjust at least one of the FEC parameters or the link parameters by changing an interleave factor of an interleaver of the FEC system from a first value to a second value, and changing a SerDes parameter of the SerDes circuit from a third value to a fourth value.

As described above with respect to FIG. 4, traditional approaches to estimating post-FEC BER use various semi-analytic models that require extensive data collection, either via transient simulations or silicon measurements. As illustrated and described with respect to FIG. 5 through FIG. 12, a DNN can be used to estimate post-FEC BER performance for a class of channels or links for a given SerDes architecture. The DNN can minimize or eliminate the need for intensive data collection from transient simulations or silicon measurements. Although the training process requires extensive data collection, once the DNN is trained, the DNN model parameters can be used to infer or predict post-FEC BER for new, unseen data based on the chosen input feature list, without further extensive data collection. For the embodiments described above with respect to FIG. 5 through FIG. 12, the DNN input feature lists, DNN configurations, and training control mechanisms are fixed or otherwise predetermined. The DNN can be trained using various input features or properties and a reference output post-FEC BER. Various examples of features used for training were provided. For example, for channel properties, one could consider channel impulse responses, channel crosstalk impulse responses, or S-parameter responses for the channel, crosstalk, or other attributes of the channel. Environmental features could include knowledge of process, temperature, or voltage of the chip. Examples of impairment features could be noise or jitter values. Link-level features could consist of transmit launch amplitude or optical power in optical systems, receiver (RX) analog-to-digital converter (ADC) full-scale voltage, etc. FEC-related features could include the interleaving factor or choice of RS encoding/decoding scheme. The aggregation of all these features can be considered a feature list or a feature set, denoted as feat_list. Based on the feature list, input data corresponding to this feature list (e.g., actual values of the impulse response or S-parameter data for channel features) and reference post-FEC BER output data, the DNN is trained to obtain trained model parameters. There may be many input data sets used during training. The DNN training process typically splits the input data into three parts: data used for actual training updates and computation of a training loss metric, DNN used for validation during the training process (which can be used as a concurrent metric of training accuracy based on computation of a validation loss metric), and data used for inference or prediction to obtain an inferred post-FEC BER. Some feature lists may be more effective than others in post-FEC BER training/prediction efficacy, and some may also require more intensive computational resources than others. For example, for channel crosstalk, using impulse responses (comprised of hundreds or thousands of values) is more computationally intensive than using, say, an integrated crosstalk noise (ICN) value for each crosstalk aggressor lane. Likewise, the DNN configuration used for training/inference may have different topologies and may employ different constraints in the training criteria. For example, a DNN topology may consist of an input layer, multiple hidden layers, and one or more output layers. Some layers may be fully interconnected or only partially connected, with some fraction of connections dropped out or removed between certain layers (often referred to as the dropout ratio). Some layers may have a given number of nodes or neurons, and other layers may have different numbers of neurons. Other topologies may exist in addition to those described thus far; for example, there are tree-based topologies known as XGBoost networks. Some networks may be convolutional neural networks (CNNs) or long short-term memory (LSTM) networks. Some DNN topologies or constraints—henceforth called DNN configuration or dnncfg—may be more efficacious in terms of the accuracy of the predicted/post-FEC BER or may vary in computational complexity.

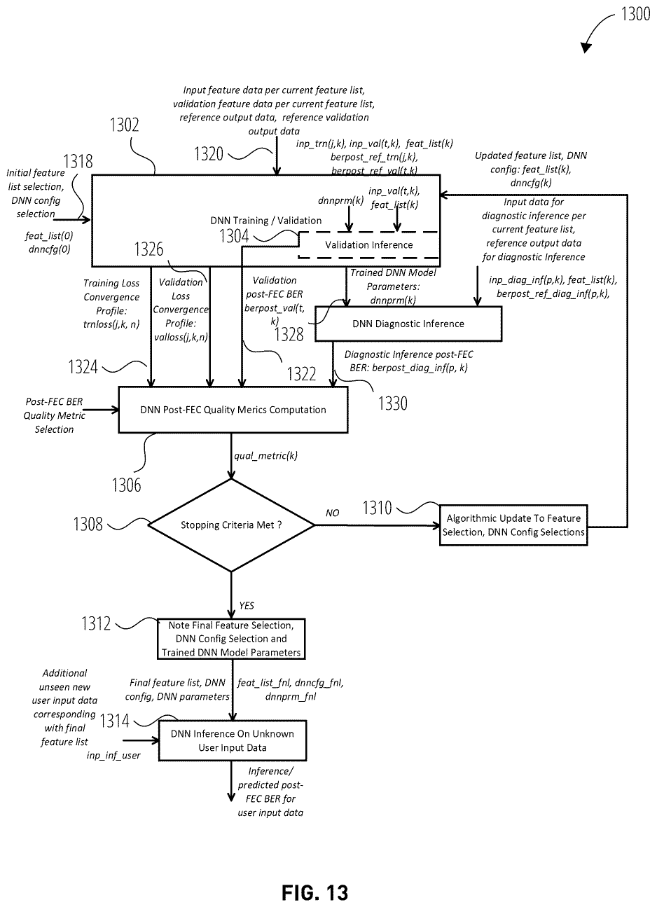

As shown in FIG. 5, an exemplary feature list can include pre-selected environmental properties, channel properties, SerDes link properties, impairment properties, and the RS interleave factor. However, as described above, there are many choices of DNN input feature lists, DNN configurations, and training control mechanisms. Moreover, among the many possible DNN input feature lists, some features or the choice of certain network configurations or parameters may not be critical for achieving good accuracy in post-FEC BER estimation yet may consume considerable computing resources. It may be beneficial to reduce computational complexity during the prediction/inference process by identifying and excluding features from a feature list or network parameters that are not critical for high accuracy. The embodiments described below with respect to FIG. 13 through FIG. 17 propose a dynamic feature and network configuration optimization logic (hereinafter referred to as “DNN optimization logic”) that determines the DNN input feature lists, DNN configurations, and training control mechanisms to be used for a given SerDes architecture.

In at least one embodiment, the DNN optimization logic evaluates a quality metric associated with a trained DNN relative to a quality criterion. The DNN can estimate a post-FEC bit error rate of an FEC circuit. The DNN optimization logic can update at least one of a feature set or a neural network configuration when the quality metric does not satisfy the quality criterion. The DNN optimization logic can retrain the DNN with an updated feature set or an updated neural network configuration and re-evaluate the quality metric. The DNN optimization logic can select a final feature set or a final neural network configuration for DNN inference when the quality metric satisfies the quality criterion. The DNN optimization logic can store trained DNN model parameters corresponding to the final feature set or final neural network configuration.

In at least one embodiment, the DNN optimization logic can identify an initial feature set and an initial neural network configuration for training the DNN to estimate the post-FEC bit error rate. The DNN optimization logic can train the DNN using the initial feature set and the initial neural network configuration. In at least one embodiment, to evaluate the quality metric, the DNN optimization logic can determine one or more DNN training metrics associated with the training of the DNN using the initial feature set and the initial neural network configuration. The DNN optimization logic can determine a post-FEC BER quality metric associated with the training of the DNN using the initial feature set and the initial neural network configuration. The post-FEC BER error value can represent a difference (in the log 10 domain) between the predicted/inferred post-FEC BER of a given DNN feature list/configuration and the corresponding reference post-FEC BER value on validation data or diagnostic inference data. The DNN optimization logic can combine the one or more DNN training metrics and the post-FEC BER quality metric to obtain the quality metric. In at least one embodiment, the post-FEC BER quality metric is a post-FEC BER error value representing a difference between a predicted post-FEC BER of the initial feature set and the initial neural network configuration and a reference post-FEC BER. In at least one embodiment, the one or more DNN training metrics include at least one of a training loss convergence profile or a validation loss convergence profile.

In at least one embodiment, the DNN optimization logic can update the feature set or the neural network configuration using a full parallel grid search, a sequential grid search, or a stochastic hill climbing (SHC) based grid traversal. The DNN optimization logic can implement a set of algorithms for the overall process of dynamic DNN network optimization using full parallel grid search, sequential grid search, and SHC-based grid traversal, where the grid represents various choices of DNN feature lists and DNN configuration types.

In at least one embodiment, the DNN model parameters can be trained based on input training data, validation data, reference output data, and validation output data. In at least one embodiment, the DNN model parameters can be trained based on pre-FEC performance training data (e.g., pre-FEC BER metrics). In at least one embodiment, the DNN optimization logic can perform at least one of a validation inference or a diagnostic inference to determine a post-FEC BER quality metric associated with the training of the DNN using the initial feature set and the initial neural network configuration. In this embodiment, the quality metric is based on at least the post-FEC BER quality metric.

In at least one embodiment, a communication system includes a processing device, a receiver circuit, and an FEC circuit operatively coupled to the receiver circuit. The processing device is operatively coupled to both the receiver circuit and the FEC circuit. The processing device can receive measurement data corresponding to the final feature set. Using the measurement data and the trained DNN model parameters, the processing device can determine the post-FEC BER estimation of the FEC circuit. The trained DNN model parameters correspond to the final feature set or the final neural network configuration. Based on the post-FEC BER estimation, the processing device can adjust at least one of an FEC parameter of the FEC circuit or a link parameter of a transmitter or the receiver circuit.

In at least one embodiment, the FEC circuit includes an interleaver and a decoder. The FEC parameter can be an interleave factor of the interleaver. To adjust at least one of the FEC parameter or the link parameter, the processing device can change the interleave factor from a first value to a second value. In at least one embodiment, the receiver circuit includes a SerDes circuit. The link parameter can be a SerDes parameter of the SerDes circuit. To adjust at least one of the FEC parameter or the link parameter, the processing device can change the SerDes parameter from a first value to a second value. In at least one embodiment, the receiver circuit includes a SerDes circuit, and the FEC circuit includes an interleaver. The FEC parameter can be an interleave factor of the interleaver, and the link parameter can be a SerDes parameter of the SerDes circuit. To adjust at least one of the FEC parameter or the link parameter, the processing device can change the interleave factor from a first value to a second value and the SerDes parameter from a third value to a fourth value.

In at least one embodiment, the communication system includes a receiver and a transmitter. The receiver includes the receiver circuit, the FEC circuit, and the processing device. The transmitter includes a second FEC circuit. The processing device can send an indication to the second FEC circuit, instructing it to adjust an FEC parameter of the second FEC circuit.

In at least one embodiment, a communication system includes a receiver circuit, an FEC circuit, and a processing device. The processing device can determine a first post-FEC quality metric associated with training a DNN using an initial feature list and an initial network configuration, the DNN being used to obtain a post-FEC BER estimation of the FEC circuit. The processing device can obtain at least one of an updated feature list or an updated network configuration for training the DNN in response to the first post-FEC quality metric not satisfying a quality criterion. The processing device can determine a second post-FEC quality metric associated with training the DNN using the updated feature list or the updated network configuration. The processing device can obtain a final feature list and a final network configuration for DNN inference in response to the second post-FEC quality metric satisfying the quality criterion. The processing device can store a set of trained DNN model parameters of the DNN trained using the updated feature list or the updated network configuration. In a further embodiment, the processing device can identify an initial feature list and an initial network configuration for training a DNN used to obtain a post-FEC BER estimation of the FEC circuit. The processing device can train the DNN using the initial feature list and the initial network configuration.

In at least one embodiment, to determine the first post-FEC quality metric, the processing device can determine one or more DNN training metrics associated with the training of the DNN using the initial feature list and the initial network configuration. The processing device can determine a post-FEC BER quality metric associated with the training of the DNN using the initial feature list and the initial network configuration. The processing device can combine the one or more DNN training metrics and the post-FEC BER quality metric to obtain the first post-FEC quality metric. In at least one embodiment, the post-FEC BER quality metric is a post-FEC BER error value representing a difference between a predicted post-FEC BER of the initial feature list and initial network configuration and a reference post-FEC BER. In at least one embodiment, the one or more DNN training metrics comprise at least one of a training loss convergence profile or a validation loss convergence profile. In at least one embodiment, the processing device can update at least one of the updated feature list or the updated network configuration using a full parallel grid search, a sequential grid search, or an SHC-based grid traversal.

In at least one embodiment, the DNN model parameters are trained based on input training data, validation data, reference output data, and validation output data. The processing device can perform at least one of a validation inference or a diagnostic inference to determine a post-FEC BER quality metric associated with the training of the DNN using the initial feature list and the initial network configuration. In this embodiment, the first post-FEC quality metric is based at least on the post-FEC BER quality metric.

In at least one embodiment, a communication system includes a SerDes circuit coupled to a communication channel, an FEC system operatively coupled to the SerDes circuit, and a processing device operatively coupled to both the SerDes circuit and the FEC system. The processing device can identify an initial feature list and an initial network configuration for training a DNN used to obtain a post-FEC BER estimation of the FEC system. The processing device can train the DNN using the initial feature list and the initial network configuration. The processing device can determine a first post-FEC quality metric associated with training the DNN using the initial feature list and the initial network configuration. The processing device can obtain at least one of an updated feature list or an updated network configuration for training the DNN in response to the first post-FEC quality metric not satisfying a quality criterion. The processing device can determine a second post-FEC quality metric associated with training the DNN using the updated feature list or the updated network configuration. The processing device can obtain a final feature list and a final network configuration for DNN inference in response to the second post-FEC quality metric satisfying the quality criterion. The processing device can store a set of trained DNN model parameters of the DNN trained using the updated feature list or the updated network configuration.

In at least one embodiment, the processing device can receive measurement data corresponding to the final feature list. The processing device can determine, using the measurement data and the set of trained DNN model parameters, the post-FEC BER estimation of the FEC circuit. The processing device can adjust, based on the post-FEC BER estimation, at least one of an FEC parameter of the FEC system or a link parameter of the SerDes circuit. In at least one embodiment, the FEC system includes an interleaver and a decoder. The FEC parameter can include an interleave factor of the interleaver. To adjust at least one of the FEC parameter or the link parameter, the processing device can change the interleave factor from a first value to a second value. In at least one embodiment, the FEC system includes: a first interleaver; a first decoder; a second interleaver; and a second decoder. The one or more parameters can include a first interleave factor of the first interleaver and a second interleave factor of the second interleaver. The processing device, to adjust at least one of the FEC parameter or the link parameter, can change the first interleave factor from a first value to a second value and change the second interleave factor from a third value to a fourth value.

In at least one embodiment, the DNN optimization logic can use (i) post-FEC related weighting metrics to train a particular DNN configuration, (ii) post-FEC quality metrics to determine the efficacy of a given DNN feature list and network configuration, and/or (iii) several algorithms to choose an optimal or suitable list of DNN features and DNN configurations, thereby allowing dynamic optimization of DNN features and network configuration choices.

In at least one embodiment, in order to facilitate dynamic network feature and configuration optimization, the DNN optimization logic uses various post-FEC related weighting criteria to train the DNN for post-FEC BER estimation, and computes various post-FEC related quality metrics which help characterize the efficacy or goodness of a given list of DNN features and DNN configuration. These metrics may be based on a combination of one or more post-FEC BER error values which would be the difference (in the log 10 domain) between predicted/inferred post-FEC BER of a given DNN feature list and DNN configuration and the corresponding reference post-FEC BER value on validation data or diagnostic inference data. The metrics may also possibly incorporate internal DNN training metrics such as training loss or validation loss profiles. Finally, a set of algorithms is proposed for the overall process of the dynamic DNN network optimization using full parallel grid search, sequential grid search, and a SHC-based grid traversal where the grid represents various choices of DNN feature lists and DNN configuration types. An example of operations of the DNN optimization logic are illustrated and described below with respect to an example method 1300 of FIG. 13. The dynamic optimization in method 1300 is described with a high-level block diagram. The optimization per the flow chart of FIG. 13 can be performed for different realizations of a semi-analytic model.

### Dynamic Network Optimization of DNN Feature List/Configurations

FIG. 13 is a flow chart of an example method 1300 for dynamic feature and network configuration optimization of a DNN, according to at least one embodiment. The method 1300 may be performed by processing logic (e.g., DNN optimization logic) that may comprise hardware (e.g., circuitry, dedicated logic, programmable logic, microcode, etc.), software (e.g., instructions executed on a processing device to perform hardware simulation), or a combination thereof. In one embodiment, the method 1300 is performed by a computing system, computing device, processing device, CPU, GPU, DPU, network switch, or other electronic devices.

In this embodiment, the method 1300 can dynamically optimize a feature list (also referred to as a feature set) and a DNN configuration (also referred to as neural network configuration). The feature list may be dynamically optimized across K iterative steps, with the feature list at the k-th iteration denoted as feat_list(k). Likewise, the DNN configuration at the k-th iteration is denoted as dnncfg(k). Below is a description of various relevant variables and parameters used in the method 1300:
The parameter K is the number of iterations used for the overall dynamic network optimization of the DNN feature list and DNN configuration.
The parameter N is the number of epochs or periods of training for a given iteration in the overall dynamic network optimization.
The parameter J is the number of input data sets used for training per current feature list.
The parameter T is the number of input data sets used for validation during training per current feature list.
The parameter P is the number of diagnostic input data sets used for inference per current feature list for overall dynamic network optimization.
The variable k is the k-th iteration in the overall dynamic network optimization process.
The variable n is the n-th training epoch.
The variable j is the j-th input data set for training per current feature list in the k-th iteration during overall dynamic network optimization.
The variable t is the t-th input data set for validation during training per current feature list in the k-th iteration during overall dynamic network optimization.
The variable p is the p-th input data set for inference per current feature list in the k-th iteration during overall dynamic network optimization.

At block 1302, the processing logic can receive a first input 1318 and a second input 1320. The first input 1318 can include an initial feature list selection and DNN configuration selection. The second input 1320 can include input feature data per current feature list, validation feature data per current feature list, reference output data, and reference validation output data. It should be noted that the reference data may come from silicon measurements or an underlying semi-analytical model, as described herein. As illustrated in FIG. 13, the second input 1320 can include: inp_trn(j,k), inp_val(t,k), and inp_diag_inf(p,k). The inp_trn(j,k) represents the j-thinput data set used for training per current feature list feat_list(k). The inp_val(t,k) represents the t-th input data set used for training per current feature list feat_list(k). The inp_diag_inf(p,k) represents the p-th input data set used for training per current feature list feat_list(k). Although all information is used during training the various input sets are partitioned and denoted by the corresponding suffixes ‘trn’, ‘val’, ‘diag_inf” to denote how they are used—the ‘-trn’ data are used for core training, the ‘val’ data are used during training for validation, and ‘_diag_inf’ can be thought of as data used during a tentative or preliminary inference process vs. inference on final user data.

In at least one embodiment, the second input 1320 can also include berpost_ref_trn(j,k), berpost_ref_val(t,k), berpost_ref_diag_inf(p,k), berpost_val(t,k), and berpost_diag_inf(p,k). The berpost_ref_trn(j,k) represents the reference post-FEC BER of the j-th input data set used during iteration k. The berpost_ref_val(t,k) represents the reference post-FEC BER of the t'th input data set used for validation during iteration k. The berpost_ref_diag_inf(p,k) represents the reference post-FEC BER of the p-th input data set used for diagnostic inference during iteration k. The berpost_val(t,k) represents the predicted validation post-FEC BER of the t'th input data set used during iteration k. The berpost_diag_inf(p,k) represents the predicted diagnostic inference post-FEC BER of the p-th input data set used during iteration k.

At block 1302, the processing logic can perform DNN training and validation. At a given k-th iteration, the processing logic trains the DNN on the J training data sets and, for the corresponding T validation data sets, records a validation post-FEC BER 1322 (labeled berpost_val(t,k)). The processing logic also records a corresponding training loss 1324 (trn_loss(k,n)), also referred to as the training loss convergence profile, and a corresponding validation loss 1326 (val_loss(k,n)), also referred to as the validation loss convergence profile.

In at least one embodiment, using the trained DNN model parameters 1328 (dnnprm(k)), the processing logic performs a validation inference at block 1304 across the P diagnostic inference data sets and record their corresponding diagnostic inference post-FEC BER 1330 (berpost_diag_inf(p,k)). Each of the k iterations corresponds to a different choice of feature list feat_list(k) and DNN configuration dnncfg(k).

### DNN Config Post-FEC BER Training Weighted Optimization Criteria

When training the DNN on a set of data during a given iteration, the processing logic can apply several post-FEC BER-related criteria to the training algorithm. Described below are two proposed beneficial and exemplary criteria for post-FEC BER training: Post-FEC BER Input Data Set Weighting and Post-FEC BER Asymmetric Error Weighting.

### Post-FEC BER Input Data Set Weighting

With the first criterion, the processing logic can weight the input data set differently depending on the reference post-FEC BER value. If the reference post-FEC BER value is already extremely good, the processing logic can disregard some optimism or pessimism in the predicted values encountered with real input data, as these are likely to lead to good post-FEC BER predictions. Mathematically, the processing logic can specify a weight vector, wtvec(j,k), across the input data values using the following example pseudo-code:

```
If berpost_ref_trn(j,k) < −berwt_thr
  wtvec(j,k)=inp_wt_val
Else:
  wtvec(j,k)=1.0
```

It should be noted that standard DNN training algorithms allow the use of a weight factor constructed in the manner described above. Exemplary values for berwt_thr could be −40, −45, or −50 (in the log 10 domain), and inp_wt_val could be 0.1 or 0.01. Additionally, the processing logic can sweep across different values of berwt_thr and inp_wt_val to dynamically optimize the network.

### Post-FEC BER Asymmetric Error Weighting

Another weighting criterion can directly affect the standard DNN training algorithm's internal objective function. Using this approach, the processing logic can weight the internal error that drives the training algorithm. The internal error is defined as the difference between the reference post-FEC BER and the temporarily computed predicted post-FEC BER during the training process. The error, error_trn, is calculated as the predicted post-FEC BER minus the reference post-FEC BER. Specifically, the processing logic can assign more weight to negative internal errors (optimistic predictions) than to positive internal errors (pessimistic predictions), making the processing logic less likely to produce negative errors than positive errors. Mathematically, the processing logic can express this weighting, wterr, as shown in the following example pseudo-code:

```
If error_trn < 0
  wterr=asymmWt
else:
    wterr=1.0
```

Again, standard DNN training algorithms allow for the incorporation of a weight definition function using the above type of formulation. Exemplary values for asymmWt are 50 and 100, but this value can also be varied during the dynamic network optimization process.

### Other DNN Configuration Parameters

In addition to the above post-FEC BER-related parameters, other generic DNN parameters can also be optimized as previously mentioned. For example, if the DNN under consideration has four hidden layers (excluding the input and output layers), the number of neurons in each layer—NN1, NN2, NN3, and NN4—can be optimized. These values can be set equally (NN1=NN2=NN3=NN4), with exemplary values such as 100, 500, 1000, or 2000, or they can be optimized independently for each layer. Similarly, the dropout ratios for each hidden layer (DR1, DR2, DR3, DR4) and the dropout ratio for the output layer (DROUT) can be optimized either collectively or independently.

### Post-FEC BER Intermediate and Overall Quality Metrics

At block 1306, the processing logic can perform DNN post-FEC quality metric computations. The following defines some post-FEC BER quality metrics that can be used during the dynamic network optimization process. The validation and diagnostic inference post-FEC BERs can be defined as follows:

$$err\_diag \_inf ( p , k ) = berpost\_diag \_inf ( p , k ) - berpost\_ref \_diag \_inf ( p , k )$$

$$err\_val \_inf ( t , k ) = berpost\_val ( p , k ) - berpost\_ref \_val ( t , k )$$

The processing logic can compute aggregate quality scores for both diagnostic inference errors and validation errors. One exemplary algorithm that computes various scores involves the following mathematical steps, described in terms of pseudo-code for the k-th iteration.

```
infsum(k)=0
mxpfil_inf_err(k)=−0.01
inf_sum_large=0
mn_inf_err(k)=1e9
  for p in 1 to P
    infterm_large=0
    if err_diag_inf(p,k) < mn_inf_err(k)
      mn_inf_err(k)=err_diag_inf(p,k)
    if err_diag_inf(p,k) < −err_band
      infterm=negwt*|err_diag_inf(p,k)|
    else if err_diag_inf(p,k) > 0 and
err_diag_inf(p,k) < err_pos_thr
      infterm=|err_diag_inf(p,k)|
      if (infterm > mxpfil_inf_err(k))
        mxpfil_inf_err(k)=infterm
    else if err_diag_inf(p,k) > err_pos_thr
      if (berpost_diag_inf(p,k) < −ber_pess_thr)
        infterm=0
        infterm_large=0
      else:
        infterm=|err_diag_inf(p,k)|
        infterm_large=|err_diag_inf(p,k)|
    else:
      infterm=0
    infsum(k)=infsum(k)+infterm
    infsum_large(k)=infsum_large(k)+infterm_large
  infsum(k)=(infsum(k)/P)+mn_inf_err(k)
  infsum_large(k)=infsum_large(k)/P
```

Exemplary values of negwt are 1.5, err_band=3, err_pos_thr=10, ber_pess_thr=35.

From the above operations, the processing logic can obtain several key quantities for the k-th iteration: mn_inf_err(k), infsum(k), mxpfil_inf_err(k), and infsum_large(k). The quantity mn_inf_err(k) represents the minimum negative (optimistic) inference error. The quantity infsum(k) represents an aggregate quality score that emphasizes more negative errors while considering filtered positive errors within a certain range (0 to err_pos_thr). It also disregards positive errors that exceed err_pos_thr if they result in a good predicted post-FEC BER (better than-ber_pess_thr). The quantity mxpfil_inf_err(k) represents the filtered maximum positive errors for positive errors in the range 0 to err_pos_thr. The quantity infsum_large(k) represents the average aggregate quality score of large errors when the predicted post-FEC BER exceeds ber_pess_thr.

Similarly, by using the above algorithm and substituting validation errors for diagnostic inference errors, the processing logic can determine key validation quantities: mn_val_err(k), valsum(k), mxpfil_val_err(k), and valsum_large(k). In this case, the algorithm loops across the index t (instead of p) and iterates over index values from 1 to T.

Using these intermediate quantities, the processing logic can compute three overall post-FEC BER quality score metrics, which characterize how well the DNN has trained during the k-th iteration:

$$qual\_metric1 ( k ) = ( inf\_sum ( k ) + val\_sum ( k ) ) / 2$$

$$qual\_metric2 ( k ) = ( mn\_inf \_err ( k ) + mxpfil\_inf \_err ( k ) )$$

$$qual\_metric3 ( k ) = ( mn\_inf \_err ( k ) + mxpfil\_inf \_err ( k ) + mn\_val \_err ( k ) + mxpfil\_val \_err ( k ) ) \text{} / 2$$

### Quality Metrics Incorporating Training/Validation Loss Signatures

Although the quality metrics defined above capture the desired efficacy of post-FEC BER estimation accuracy, one can be somewhat more conservative in defining the metric by accounting for the behavior of the training loss and/or validation loss profiles. It is known in the DNN literature that it is possible for the validation errors to be reasonably small, yet the quality of the DNN training model may still be suboptimal if the validation loss profile is noisy, especially towards the end of training, or if it deviates significantly from the training loss profile.

As described above, the loss profiles trn_loss(k, n) and val_loss(k, n), where n corresponds to the training index/epoch and k is the overall optimization iteration, are considered. In an exemplary metric, only the validation loss behavior may be considered, since poor training loss behavior is generally already captured by having a poor-quality metric based on the training errors. It should be noted that the loss profile is already computed over the respective data sets, i.e., trn_loss is based on the loss profile over P diagnostic inference data sets, and trn_val is the loss profile for T validation data sets.

The loss value should generally be a monotonically decreasing quantity versus n, the training epoch. If it is non-monotonic, especially towards the end of the training period (defined by N epochs of training), or if it is very noisy (i.e., exhibits a lot of variation), then that could indicate potential deficiencies in model quality, despite the validation errors being reasonably small. Let val_loss_tail(k, n) be the validation loss profile over the last 20% of the N training epochs. The number 20% is exemplary and could be anything from 0 to 99%.

Two methods to characterize the quality of the validation loss, qual_val_loss for the k-th iteration, could be expressed as follows:

$$qual\_val \_loss ( k ) = max ( val\_loss \_tail ( k , n ) ) - min ( val\_loss \_tail ( k , n ) ) ,$$

$$where the max / min are across the last 20 \% of the training epochs , or$$

$$qual\_val \_loss ( k ) = s tandard\_deviation ( val\_loss \_tail ( k , n ) ) ,$$

where the standard deviation is taken across the last 20% of the training epochs

The validation quality loss metric can now be incorporated into the overall quality metrics defined earlier to obtain modified quality loss metrics:

$$qual\_metric1v ( k ) = qual\_val \_loss ( k ) + ( ( inf\_sum ( k ) + val\_sum ( k ) ) / 2$$

$$qual\_metric2v ( k ) = qual\_val \_loss ( k ) + ( mn\_inf \_err ( k ) + mxpfil\_inf \_err ( k ) )$$

$$qual\_metric3v ( k ) = qual\_val \_loss ( k ) + ( mn\_inf \_err ( k ) + mxpfil\_inf \_err ( k ) + mn\_val \_err ( k ) + mxpfil\_val \_err ( k ) ) / 2$$

It should be noted that although not done, the above metrics could still include the impact of training loss profile in a manner similar to which the validation loss profile behavior was incorporated.

### Quality Metrics Involving Large Pessimistic Errors

Generally speaking, qual_metric2 and qual_metric3 should track the trends of qual_metric1 (of course may give somewhat different results). However, qual_metric2 and qual_metric3 do not incorporate the infsum(k) or valsum(k) terms. Usually this is not an issue since large errors greater than an error threshold, err_pos_thr, typically occur when the post-FEC BER is very good and is usually a “don't care” scenario. However, there could be a pathological situation when the DNN does not converge, one encounters large errors>err_pos_thr and the training/validation profiles are not noisy even though they are large in absolute value. To protect against any such pathological case, the processing logic can incorporate the use of inf_sum_large(k) and val_sum_large(k) into additionally modified metrics which can be helpful especially for qual_metric2 and qual_metric3, as expressed in the following:

$$qual\_metric1vl ( k ) = qual\_val \_loss ( k ) + ( ( inf\_sum ( k ) + val\_sum ( k ) + inf\_sum \_large ( k ) + valsum\_large ( k ) ) / 2$$

$$qual\_metric2vl ( k ) = qual\_val \_loss ( k ) + ( mn\_inf \_err ( k ) + mxpfil\_inf \_err ( k ) ) + ( ( inf\_sum \_large ( k ) + valsum\_large ( k ) ) / 2 )$$

$$qual\_metric3vl ( k ) = qual\_val \_loss ( k ) + ( mn\_inf \_err ( k ) + mxpfil\_inf \_err ( k ) + mn\_val \_err ( k ) + mxpfil\_val \_err ( k ) / 2 + ( ( inf\_sum \_large ( k ) + valsum\_large ( k ) ) / 2 )$$

### Higher Level Control Algorithms and Stopping Criteria Across Iterations

Having established options for various post-FEC BER overall quality metrics, as well as various post-FEC BER-related weighting criteria for training, various approaches can be considered to perform dynamic network optimization as illustrated in the block diagram of FIG. 13. In this block diagram, the quality metric qual_metric can, for example, be any of the previously defined metrics: qual_metric1, qual_metric2, qual_metric3, qual_metric1v, qual_metric2v, or qual_metric3v.

Suppose there are F possible feature lists and C possible DNN configuration lists over which the processing logic needs to search. There are K=F×C possible combinations of feature lists and DNN configurations to be considered. Here are some concrete examples for descriptive purposes:

Let F=2, with two exemplary possible feature lists (feat_list) over which the processing logic will optimize the DNN:
1. TX launch amplitude, channel through impulse response, channel cross talk impulse response
2. TX launch amplitude, channel through impulse response, channel cross talk integrated cross talk noise

Now consider the exemplary possible variations of the DNN:
1. inp_wt_val possible values: 0.01, 0.05, 0.1
2. berwt_thr values: −35 and −40
3. asymmWt values: no weighting, 50, 100, 200
4. DNN configuration (dnncfg): (i) fixed number of layers and fixed number of neurons with a fully interconnected network; (ii) fixed number of layers and fixed number of neurons (as above), but with each layer randomly dropping 10% of the connections

Based on these choices, the processing logic will have a total of three inp_wt_val cases, two berwt_thr cases, three asymmWt value cases, and two DNN topology variant cases, resulting in 3×2×3×2=36 DNN configuration cases. Thus, there are thirty-six combinations (C=36).

Considering all combinations of features and DNN configurations, the processing logic has a total of K=F×C=2×36=72 possible feature/DNN configuration choices to consider in order to dynamically optimize the DNN for the best possible post-FEC BER estimation accuracy according to one of the previously defined quality metrics.

As described above, the processing logic can use several methods to perform dynamic network optimization to choose the feature list and DNN configuration that provides the best post-FEC BER estimation accuracy based on one of the quality metrics defined above.

### Full Parallel Grid Search

In one exemplary method of dynamic network optimization, the processing logic performs a full grid search based on the flow illustrated in FIG. 13 by searching through all possible K versions of the feature list and DNN configurations. Here, the processing logic would initialize k=1 and, after each iteration is complete, increment k by 1. A stopping criterion at block 1308 can be used. The stopping criterion can be whether k has become equal to K. After each iteration, the processing logic can store the quality metric. Once the stopping criterion is met at block 1308 for the full grid search, the processing logic can determine the optimum k and corresponding feature list/DNN configuration as the k value for which the minimum quality metric score is achieved (block 1312).

Full Parallel Grid Search with Early Stopping

A variant of the above procedure would be to proceed as described above, but instead of completing the full grid search of all k values from 1 to K, the processing logic can stop the search if the qual_metric falls below a target value. In this case, the optimum k and corresponding feature list/DNN configuration would be the one at which the quality metric fell below the quality metric target. For example, the stopping criterion can be expressed as follows:

$$qual\_metric ( k ) < qual\_target$$

### Sequential Grid Search

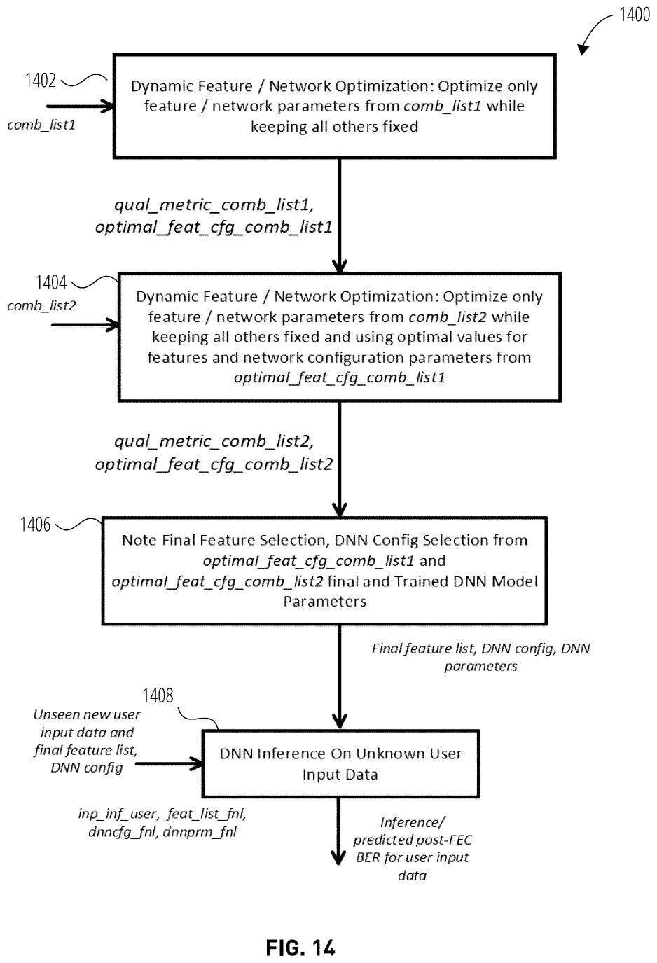

Instead of performing a full grid search across all K=F*C possible combinations of input feature lists and network configurations, the processing logic can perform a sequential optimization/search. In this approach, it searches for a subset of features and/or configurations, finds the optimum from the initial search, retains the optimum values, and then continues with a full parallel grid search among the remaining features/configurations or performs additional sequential optimizations of subsets of features/configurations. A high-level block diagram of this sequential scheme is shown in FIG. 14.

FIG. 14 is a flow chart of an example method for a sequential grid search for dynamic feature and network configuration optimization of a DNN according to at least one embodiment. The method 1400 may be performed by processing logic (e.g., DNN optimization logic) that may comprise hardware (e.g., circuitry, dedicated logic, programmable logic, microcode, etc.), software (e.g., instructions run on a processing device to perform hardware simulation), or a combination thereof. In one embodiment, the method 1400 is performed by a computing system, a computing device, a processing device, a CPU, a GPU, a DPU, a network switch, or other electronic devices.

The following example uses the parameter examples described above to illustrate the sequential optimization process. At block 1402, the processing logic can pick a first set of parameters from the features/configurations and call it comb_list1. For comb_list1, the processing logic can make the following example choices:
Sweep across the two feature list options (2 choices)
Sweep across asymmWt values of 50, 100, 200 (3 choices)
Keep inp_wt_val fixed at 0.1
Keep berwt_thr fixed at −40
Keep DNN configuration fully interconnected

If the processing logic performs a parallel grid search optimization across comb_list1, it effectively has F=2, C=3, and K=F*C=6 possible feature/configurations to search. The processing logic can use the flow of FIG. 13 to find the optimal quality metric for this optimization as qmet_comb_list1 and the optimal combination of feature/configuration values as optimal_feat_cfg_comb_list1.

At block 1404, the processing logic can pick a second combination of input feature list and configurations and call it comb_list2. In this step, asymmWt can be fixed at the optimal value from step 1 (block 1402), and now search over comb_list2 comprising the other choices, namely inp_wt_val of 0.01, 0.05, 0.1 and berwt_thr of −35, −40, for a total of C=3×2=6 configurations. Since there is no input feature list sweep in this step, the processing logic will have F=1, C=6, and K=F*C=6 for this step. The optimal values from comb_list2, i.e., inp_wt_val and berwt_thr, combined with the optimal choices from comb_list1 (one of the input feature lists and the optimal value of asymmWt), can be used to obtain the final sequentially optimized feature lists and network configurations (at block 1406). The final feature lists and network configurations obtained at block 1406 can then be used for inference/prediction using new unseen user data at block 1408.

It should be noted that with sequential optimization, the total number of training/validation/diagnostic inferences had to be performed across only 12 combinations of features/network configurations (i.e., 6 combinations in the first step+6 combinations in the second step=12) to arrive at the optimal setting. Of course, there is a tradeoff between full parallel grid search and sequential grid search: the sequential grid search will be faster, but the full parallel grid search will guarantee the global optimum within the grid, whereas the sequential grid search may only find a local optimum.

The sequential grid search example for the exemplary feature lists/network configurations considered here was broken up into 2 steps and 2 partitions of the feature lists/network configurations. In other embodiments, the processing logic can use a larger number of steps and corresponding partitions of the feature lists/network configurations.

### Combination of Parallel Grid Search and Stochastic Hill Climbing

The stochastic hill climbing (SHC) search can be used as an alternative, more efficient method than grid search for parameters that exhibit a monotonically increasing behavior. In the prior example, there were a total of 5 parameter sets that were optimized to obtain the feature list/DNN configuration. For example:
feat_list: feature list, 2 possible cases/values in the example
dnncfg: DNN topology configuration choice, 2 possible cases in the example
asymmWt: 3 possible values in the example
inp_wt_val: 3 possible values in the example
ber_wt_thr: 2 possible values in the example
dnncfg: DNN topology configuration choice (2 possible cases in the example)

Of these, feat_list and dnncfg each comprise values that may not have a monotonic relationship between them. For example, in feat_list, using impulse responses for the crosstalk responses versus integrated noise has no numeric monotonic relationship.

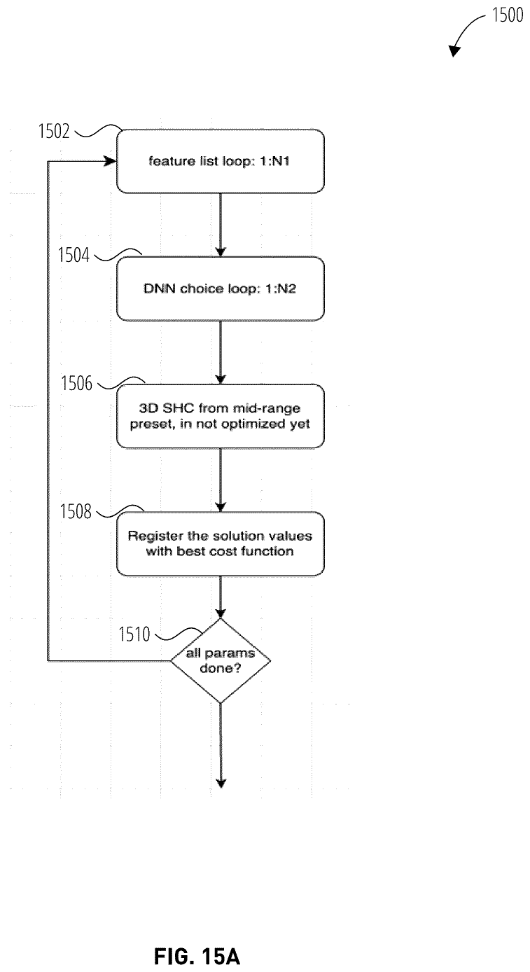

However, the other parameters—aymmWt, inp_wt_val, and ber_wt_thr—can be swept over monotonically increasing values. Using this approach of partitioning our parameters into a non-monotonic set and a monotonic set, the processing logic can perform network optimization by performing a grid search across the non-monotonic parameters and, for each non-monotonic grid point, performing a SHC algorithm on the monotonically related parameters. Since there are three exemplary monotonically related parameters, the processing logic can perform an exemplary 3D SHC search. The processing logic can start from a preset value of the monotonic parameters and grid values of the non-monotonic parameters. This overall flow is illustrated in FIG. 15A and FIG. 15B.

FIG. 15A and FIG. 15B are flow diagrams of an example method 1500 for performing a 3D SHC search for dynamic feature and network configuration optimization of a DNN according to at least one embodiment. The method 1500 may be performed by processing logic (e.g., DNN optimization logic) that may comprise hardware (e.g., circuitry, dedicated logic, programmable logic, microcode, etc.), software (e.g., instructions run on a processing device to perform hardware simulation), or a combination thereof. In one embodiment, the method 1500 is performed by a computing system, a computing device, a processing device, a CPU, a GPU, a DPU, a network switch, or other electronic devices.

As illustrated in FIG. 15A, the processing logic selects a feature list at block 1502 (feature list loop: 1:N1) and selects a DNN configuration at block 1504 (i.e., DNN choice loop: 1:N2). The processing logic performs a 3D SHC search from a mid-range preset (block 1506) and registers the solution values with the best cost function. The details of the 3D SHC search are illustrated and described with respect to FIG. 15B. At block 1510, the processing logic can determine whether all parameters are done. If not, the processing logic returns to block 1502 and selects another feature list at block 1502 and DNN configuration at block 1504.

Referring to FIG. 15B, in SHC optimization, the processing logic can start from a preset value of the monotonic parameters and grid values of the non-monotonic parameters (block 1514). The processing logic loops through each monotonic parameter one at a time. At each parameter element, the processing logic performs a cost function/quality metric evaluation at the current parameter element and at a +/−D programmable displacement value and evaluates the cost function for each point (block 1516). If the current element's cost function is the best, then the processing logic exits the loop and moves to the next parameter optimization (at block 1514). If the displacement element values are better, then the processing logic continues to evaluate the cost function in the direction of improvement until improvement ceases (blocks 1520 and 1522). While the processing logic optimizes the next parameter's elements, it holds the optimized values of the previously optimized parameters. Once the SHC values of all 3D parameters are completed (block 1524), the processing logic continues with the next grid search values of the non-monotonic parameters and repeats the inner 3D SHC optimization.

It should be emphasized that the examples thus far have involved a small number of non-monotonic and monotonic parameters, each of which has had a limited number of exemplary cases/values. The flowcharts and algorithms can be applied to an arbitrary number of parameters and corresponding possible values. Moreover, it should be noted that employing SHC becomes more efficient relative to a full parallel grid search as the number of monotonic parameters increases and the number of possible values for each increase.

### Application Usage Methodologies

In some embodiments, the processing logic performs a sweep of both input features and DNN network configurations to find the best network to estimate post-FEC BER as accurately as possible. At various stages of the full production cycle, it may be advantageous to vary only the feature list or the DNN network configurations. For example, during the signal integrity channel design phase, it may be advantageous to vary both the feature list (including channel properties) while keeping the DNN network configurations fixed as determined in simulation. The goal is to optimize the channel design such that insertion loss, crosstalk, and coupling between the paths are optimized for various TX launch amplitudes.

However, in the lab or production phase, it is likely more practical to keep the feature list constant since the channel is already designed, and the processing logic must accommodate the loss and crosstalk of the physical channel. At this stage, the processing logic may only vary the DNN configurations to find the best DNN that reliably predicts post-FEC BER inference/prediction.

### Variations

Although the embodiments described herein refer to post-FEC BER, it should be understood that other related or correlated quantities, such as codeword failure rate (CFR), also known as block error rate (BLER), could be similarly trained for and predicted.

As described above, the processing logic can perform a training/prediction method for delta post-FEC BER (as opposed to direct training/prediction of absolute post-FEC BER). The optimization algorithms and quality metrics described herein can also be applied to the delta post-FEC BER approach to post-FEC BER training/estimation.

The techniques described herein can be applied to a wide variety of networks, not just a standard interconnected DNN with input, hidden, and output layers. Such variants may include convolutional neural networks (CNNs), recurrent neural networks (RNNs) with memory such as long short-term memory networks (LSTMs) or gated recurrent unit (GRU) networks, XGBoost tree networks, etc.

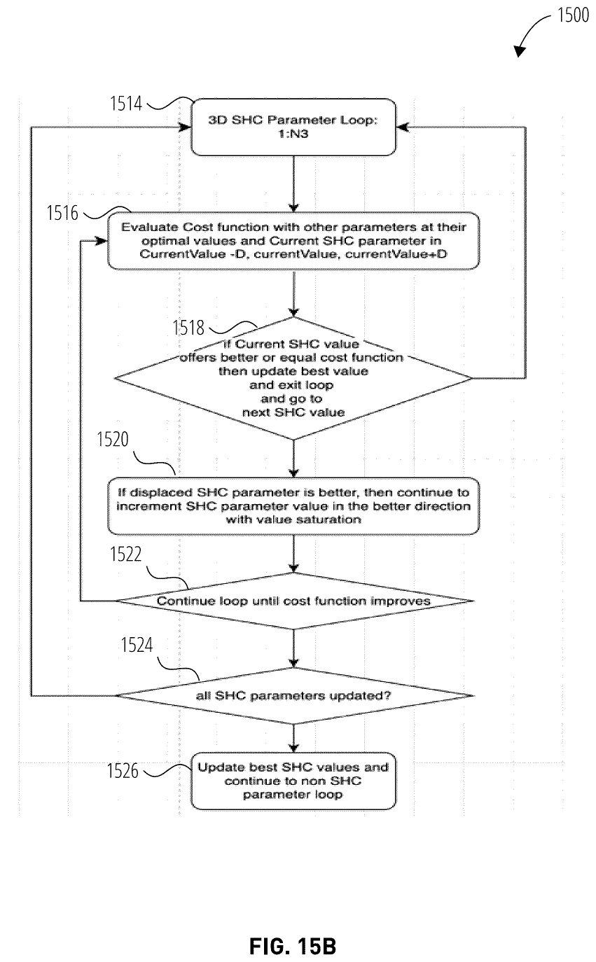

FIG. 16 is a flow diagram of an example method 1600 for optimizing a DNN for enhanced bit error rate prediction according to at least one embodiment. The method 1600 can be performed using one or more processing units (e.g., CPUs, GPUs, accelerators, physics processing units (PPUs), data processing units (DPUs), etc.), which may include (or communicate with) one or more memory devices. In at least one embodiment, the method 1600 can be performed using a processing device or processing logic. In at least one embodiment, the method 1600 can be performed using processing units of method 1300 of FIG. 13. In at least one embodiment, processing units performing the method 1600 can execute instructions stored on a non-transient computer-readable storage medium. In at least one embodiment, the method 1600 can be performed using multiple processing threads (e.g., CPU threads and/or GPU threads), with individual threads executing one or more functions, routines, subroutines, or operations of the method. In at least one embodiment, processing threads implementing the method 1600 can be synchronized (e.g., using semaphores, critical sections, or other thread synchronization mechanisms). Alternatively, processing threads implementing the method 1600 can be executed asynchronously with respect to each other. Various operations of method 1600 can be performed in a different order than shown in FIG. 16. Some operations of the method 1600 can be performed concurrently with other operations. In at least one embodiment, one or more operations shown in FIG. 16 may not always be performed.

At block 1602, processing units executing method 1600 can evaluate a quality metric of a trained DNN relative to a quality criterion. The trained DNN can be used to estimate a post-FEC bit error rate of an FEC circuit. At block 1604, processing units executing method 1600 can update at least one of a feature set or network configuration when the quality metric does not satisfy the quality criterion. At block 1606, processing units executing method 1600 can retrain the DNN with an updated feature set or configuration and re-evaluate the quality metric. At block 1608, processing units executing method 1600 can select a final feature set or configuration for DNN inference when the quality metric satisfies the criterion. At block 1610, processing units executing method 1600 can store trained DNN model parameters corresponding to the final feature set or configuration.

In a further embodiment, processing units executing method 1600 can identify an initial feature set or network configuration for training a DNN to estimate a post-FEC bit error rate of an FEC circuit. The processing units can train the DNN using the initial feature set or network configuration.

In a further embodiment, processing units evaluating the quality metric can determine one or more DNN training metrics associated with the training of the DNN using the initial feature set or network configuration. The processing units can determine a post-FEC BER quality metric associated with the training of the DNN using the initial feature set or neural network configuration. The processing units can combine the one or more DNN training metrics and the post-FEC BER quality metric to obtain the quality metric. In at least one embodiment, the post-FEC BER quality metric is a post-FEC BER error value representing a difference between a predicted post-FEC BER of the initial feature set or network configuration and a reference post-FEC BER. In at least one embodiment, the one or more DNN training metrics comprise at least one of a training loss convergence profile or a validation loss convergence profile.

In a further embodiment, processing units updating the updated feature set or the updated neural network configuration use a full parallel grid search, a sequential grid search, or an SHC-based grid traversal.

In at least one embodiment, DNN model parameters of the DNN are trained based on input training data, validation data, reference output data, and validation output data. In at least one embodiment, processing units executing method 1600 can perform at least one of a validation inference or a diagnostic inference to determine a post-FEC BER quality metric associated with the training of the DNN using the initial feature set or network configuration. In this embodiment, the quality metric is based on at least the post-FEC BER quality metric.

In at least one embodiment, processing units can receive measurement data corresponding to the final feature set and determine, using the measurement data and the trained DNN model parameters, the post-FEC bit error rate of the FEC circuit. The processing units can adjust, based on the post-FEC bit error rate, at least one of a FEC parameter of the FEC circuit or a link parameter of a transmitter or the receiver circuit. In at least one embodiment, adjusting at least one of the FEC parameter or the link parameter includes changing an interleave factor of an interleaver of the FEC circuit from a first value to a second value.

In at least one embodiment, the receiver circuit is a SerDes circuit. The processing units adjusting at least one of the FEC parameter or the link parameter can change a SerDes parameter of the SerDes circuit from a first value to a second value. In at least one embodiment, the receiver circuit is a SerDes circuit. The processing units adjusting at least one of the FEC parameter or the link parameter can change an interleave factor of an interleaver of the FEC circuit from a first value to a second value, and a SerDes parameter of the SerDes circuit from a third value to a fourth value.

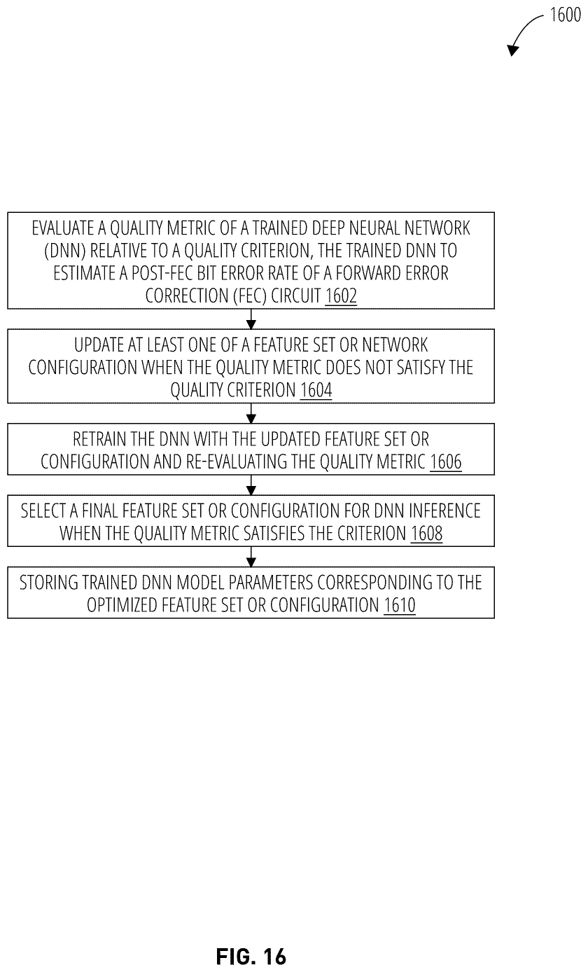

FIG. 17 is a flow diagram of an example method 1700 for optimizing a DNN for enhanced bit error rate prediction according to at least one embodiment. The method 1700 can be performed using one or more processing units (e.g., CPUs, GPUs, accelerators, physics processing units (PPUs), data processing units (DPUs), etc.), which may include (or communicate with) one or more memory devices. In at least one embodiment, the method 1700 can be performed using a processing device or processing devices. In at least one embodiment, the method 1700 can be performed using processing units of method 1300 of FIG. 13. In at least one embodiment, processing units performing the method 1700 can execute instructions stored on a non-transient computer-readable storage medium. In at least one embodiment, the method 1700 can be performed using multiple processing threads (e.g., CPU threads and/or GPU threads), with individual threads executing one or more functions, routines, subroutines, or operations of the method. In at least one embodiment, processing threads implementing the method 1700 can be synchronized (e.g., using semaphores, critical sections, or other thread synchronization mechanisms). Alternatively, processing threads implementing the method 1700 can be executed asynchronously with respect to each other. Various operations of method 1700 can be performed in a different order than shown in FIG. 17. Some operations of the method 1700 can be performed concurrently with other operations. In at least one embodiment, one or more operations shown in FIG. 17 may not always be performed.

At block 1702, processing units executing method 1700 can identify an initial feature list and an initial network configuration for training a DNN used to obtain a post-FEC bit error rate of an FEC circuit. At block 1704, processing units executing method 1700 can train the DNN using the initial feature list and the initial network configuration. At block 1706, processing units executing method 1700 can determine a first post-FEC quality metric associated with training the DNN using the initial feature list and the initial network configuration. At block 1708, processing units executing method 1700 can obtain at least one of an updated feature list or an updated network configuration for training the DNN in response to the first post-FEC quality metric not satisfying a quality criterion. At block 1710, processing units executing method 1700 can determine a second post-FEC quality metric associated with training the DNN using the updated feature list or the updated network configuration. At block 1712, processing units executing method 1700 can obtain a final feature list and a final network configuration for DNN inference in response to the second post-FEC quality metric satisfying the quality criterion. At block 1714, processing units executing method 1700 can store a set of trained DNN model parameters of the DNN trained using the updated feature list or the updated network configuration.

In a further embodiment, processing units determining the first post-FEC quality metric can determine one or more DNN training metrics associated with the training of the DNN using the initial feature list and the initial network configuration. Additionally, the processing units can determine a post-FEC BER quality metric associated with the training of the DNN using the initial feature list and the initial network configuration. The processing units can combine the one or more DNN training metrics and the post-FEC BER quality metric to obtain the first post-FEC quality metric.

In a further embodiment, processing units updating at least one of the updated feature list or the updated network configuration can use a full parallel grid search, a sequential grid search, or an SHC-based grid traversal.

In at least one embodiment, processing units performing the method 1700 can perform at least one of a validation inference or a diagnostic inference to determine a post-FEC BER quality metric associated with the training of the DNN using the initial feature list and the initial network configuration. In this embodiment, the first post-FEC quality metric is based on at least the post-FEC BER quality metric.

In at least one embodiment, processing units can receive measurement data corresponding to the final feature set and determine, using the measurement data and the trained DNN model parameters, the post-FEC bit error rate of the FEC circuit. The processing units can adjust, based on the post-FEC bit error rate, at least one of a FEC parameter of the FEC circuit or a link parameter of a transmitter or the receiver circuit. In at least one embodiment, adjusting at least one of the FEC parameter or the link parameter includes changing an interleave factor of an interleaver of the FEC circuit from a first value to a second value.

In at least one embodiment, the receiver circuit is a SerDes circuit. The processing units, when adjusting at least one of the FEC parameter or the link parameter, can change a SerDes parameter of the SerDes circuit from a first value to a second value. In at least one embodiment, the receiver circuit is a SerDes circuit. The processing units, when adjusting at least one of the FEC parameter or the link parameter, can change an interleave factor of an interleaver of the FEC circuit from a first value to a second value, and a SerDes parameter of the SerDes circuit from a third value to a fourth value.

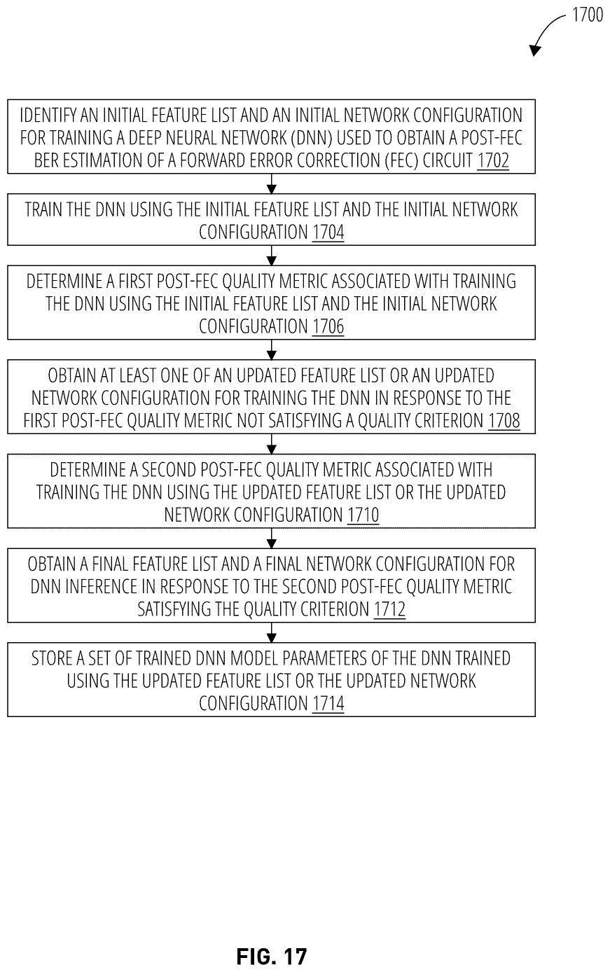

FIG. 18 illustrates an example computer system 1800, which includes a network controller 1844 with a DNN-based estimation system 102 for optimizing post-FEC BER performance of an FEC system, in accordance with at least some embodiments. In at least one embodiment, computer system 1800 may be a system with interconnected devices and components, a System on Chip (SoC), or a combination thereof. Computer system 1800 may be equipped with a processor 1802 that includes execution units for executing instructions. In at least one embodiment, computer system 1800 may include, without limitation, a processor 1802 with execution units and logic to perform algorithms for processing data. The processors may include, for example, the PENTIUM® Processor family, Xeon™, Itanium®, XScale™, StrongARM™, Intel® Core™, or Intel® Nervana™ microprocessors available from Intel Corporation of Santa Clara, California, although other systems (including PCs with other microprocessors, engineering workstations, set-top boxes, and similar devices) may also be used. Computer system 1800 may execute a version of the WINDOWS® operating system available from Microsoft Corporation of Redmond, Washington, although other operating systems (such as UNIX and Linux), embedded software, and/or graphical user interfaces may also be used.

In at least one embodiment, computer system 1800 may be used in other devices, such as handheld devices and embedded applications. Examples of handheld devices include cellular phones, Internet Protocol devices, digital cameras, personal digital assistants (PDAs), and handheld PCs. Embedded applications may include a microcontroller, a digital signal processor (DSP), a SoC, network computers (NetPCs), set-top boxes, network hubs, wide area network (WAN) switches, or any other system capable of performing one or more instructions. In one embodiment, computer system 1800 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64-Port InfiniBand NDR Switch).

In at least one embodiment, computer system 1800 may include, without limitation, processor 1802, which may include one or more execution units 807 configured to execute a Compute Unified Device Architecture (CUDA®) program (CUDA® is developed by NVIDIA Corporation of Santa Clara, California). A CUDA program may be at least a portion of a software application written in the CUDA programming language. Computer system 1800 may be a single-processor desktop or server system, or a multiprocessor system. Processor 1802 may include, without limitation, a complex instruction set computer (CISC) microprocessor, a reduced instruction set computing (RISC) microprocessor, a Very Long Instruction Word (VLIW) microprocessor, a processor implementing a combination of instruction sets, or any other processor device, such as a digital signal processor. Processor 1802 may be coupled to a processor bus 1804 that transmits data signals between processor 1802 and other components in computer system 1800.

In at least one embodiment, processor 1802 may include, without limitation, a Level 1 (L1) internal cache memory (cache) 1806. In at least one embodiment, processor 1802 may have a single internal cache or multiple levels of internal cache. In at least one embodiment, cache memory may reside externally to processor 1802. In at least one embodiment, processor 1802 may also include a combination of both internal and external caches. In at least one embodiment, a register file 1808 may store different types of data in various registers including, without limitation, integer registers, floating point registers, status registers, and instruction pointer registers.

In at least one embodiment, execution unit 1810, including, without limitation, logic to perform integer and floating-point operations, also resides in processor 1802. Processor 1802 may also include a microcode (“ucode”) read-only memory (“ROM”) that stores microcode for certain macro instructions. In at least one embodiment, execution unit 1810 may include logic to handle a packed instruction set 1812. In at least one embodiment, by including the packed instruction set 1812 in an instruction set of a general-purpose processor 1802, along with associated circuitry to execute instructions, operations used by many multimedia applications may be performed using packed data in a general-purpose processor 1802. In at least one embodiment, many multimedia applications may be accelerated and executed more efficiently by using the full width of a processor's data bus for performing operations on packed data, which may eliminate a need to transfer smaller units of data across the processor's data bus to perform one or more operations on one data element at a time.

In at least one embodiment, execution unit 1810 may also be used in microcontrollers, embedded processors, graphics devices, DSPs, and other types of logic circuits. In at least one embodiment, computer system 1800 may include, without limitation, a memory 1814. In at least one embodiment, memory 1814 may be implemented as a Dynamic Random Access Memory (DRAM) device, a Static Random Access Memory (SRAM) device, a flash memory device, or other memory devices. Memory 1814 may store instruction(s) 1816 and/or data 1818 represented by data signals that may be executed by processor 1802.

In at least one embodiment, a system logic chip may be coupled to a processor bus 1804 and memory 1814. In at least one embodiment, the system logic chip may include, without limitation, a memory controller hub (“MCH”) 1820, and processor 1802 may communicate with MCH 1820 via processor bus 1804. In at least one embodiment, MCH 1820 may provide a high-bandwidth memory path to memory 1814 for instruction and data storage and for storage of graphics commands, data, and textures. In at least one embodiment, MCH 1820 may direct data signals between processor 1802, memory 1814, and other components in computer system 1800, and may bridge data signals between processor bus 1804, memory 1814, and a system I/O 1822. In at least one embodiment, a system logic chip may provide a graphics port for coupling to a graphics controller. In at least one embodiment, MCH 1820 may be coupled to memory 1814 through a high-bandwidth memory path, and graphics/video card 1826 may be coupled to MCH 1820 through an Accelerated Graphics Port (“AGP”) interconnect 1824.

In at least one embodiment, computer system 1800 may use system I/O 1822, which is a proprietary hub interface bus, to couple MCH 1820 to I/O controller hub (“ICH”) 1828. In at least one embodiment, ICH 1828 may provide direct connections to some I/O devices via a local I/O bus. In at least one embodiment, a local I/O bus may include, without limitation, a high-speed I/O bus for connecting peripherals to memory 1814, a chipset, and processor 1802. Examples may include, without limitation, an audio controller 1830, a firmware hub (“flash BIOS”) 1832, a wireless transceiver 1834, a data storage 1836, a legacy I/O controller 1838 containing a user input interface 1840, a keyboard interface, a serial expansion port 1842 such as a USB port, and a network controller 644, including the DNN-based estimation system 102 as described herein. Data storage 1836 may comprise a hard disk drive, a floppy disk drive, a CD-ROM device, a flash memory device, or another mass storage device.

In at least one embodiment, FIG. 18 illustrates a computer system 1800, which includes interconnected hardware devices or “chips.” In at least one embodiment, FIG. 18 may illustrate an example SoC. In at least one embodiment, devices illustrated in FIG. 18 may be interconnected with proprietary interconnects, standardized interconnects (e.g., Peripheral Component Interconnect Express (PCIe)), or some combination thereof. In at least one embodiment, one or more components of computer system 1800 are interconnected using compute express link (“CXL”) interconnects.

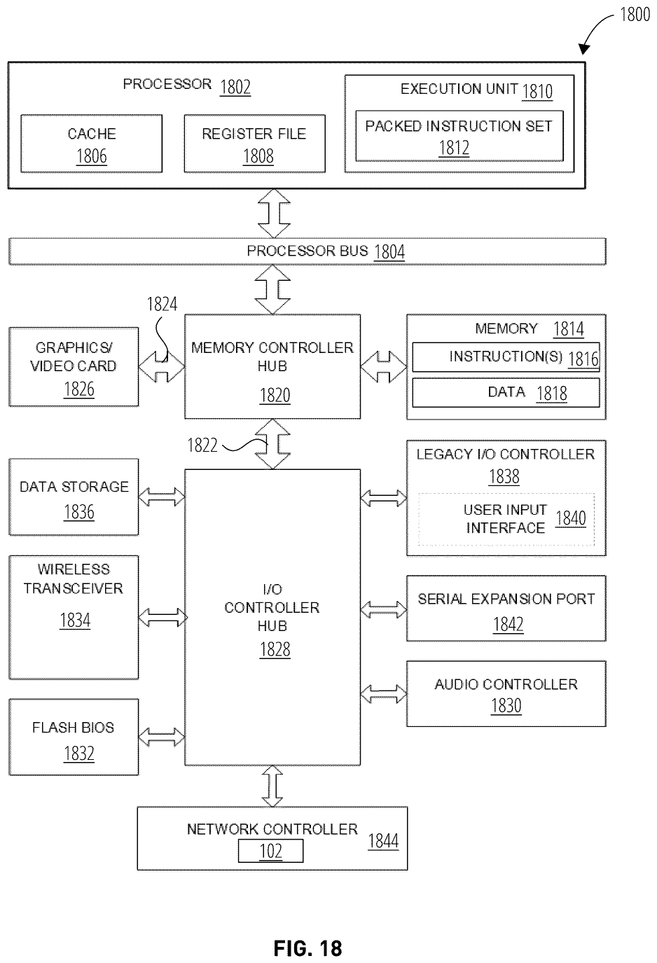

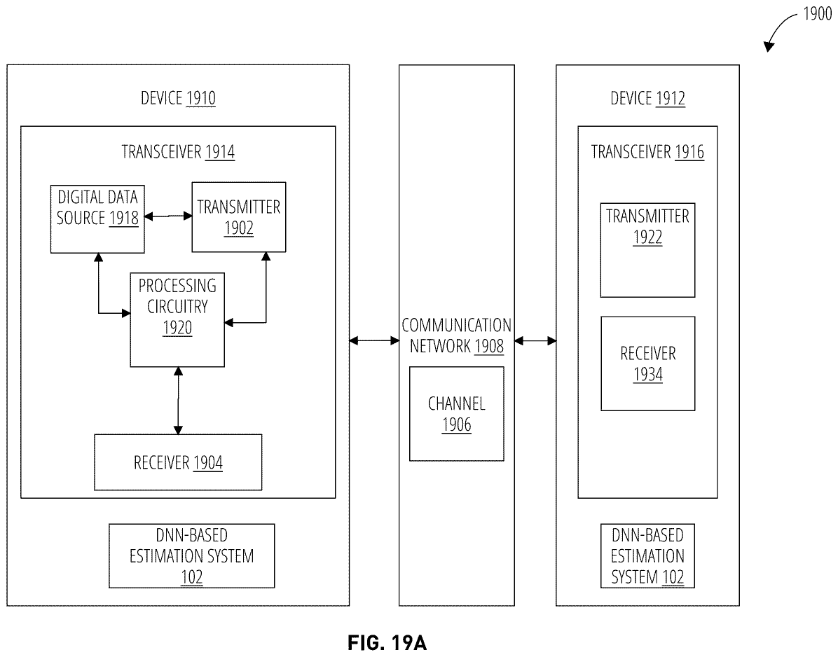

FIG. 19A illustrates an example communication system 1900 with a DNN-based estimation system 102 for optimizing post-FEC BER performance of an FEC system, in accordance with at least some embodiments. The communication system 1900 includes a device 1910, a communication network 1908 including a communication channel 1906, and a device 1912. In at least one embodiment, the devices 1910 and 1912 are integrated circuits of a personal computer (PC), laptop, tablet, smartphone, server, collection of servers, or similar devices. In some embodiments, the devices 1910 and 1912 may correspond to any appropriate type of device that communicates with other devices also connected to a common type of communication network 1908. According to embodiments, the transmitters 1902 and 1922 of devices 1910 or 1912 may correspond to transmitters of a graphics processing unit (GPU), a switch (e.g., a high-speed network switch), a network adapter, a central processing unit (CPU), a data processing unit (DPU), or similar components.

Examples of the communication network 1908 that may be used to connect devices 1910 and 1912 include wires, conductive traces, bumps, terminals, optical fibers, or similar media. In other embodiments, the communication network 1908 can be a Peripheral Component Interconnect Express (PCIe) interconnect. PCIe is a high-speed interface standard used to connect various hardware components, such as graphics cards (GPUs), solid-state drives (SSDs), network cards, and other peripherals. PCIe offers a scalable, high-speed, point-to-point connection between devices, including CPUs, GPUs, memory, and the like. In other embodiments, the communication network 1908 can be a high-speed interconnect, such as one that deploys the NVLink technology. The NVLink interconnect can be a GPU-GPU interconnect used between GPUs, a CPU-GPU interconnect between GPUs and CPUs, or an interconnect used between other devices. NVLink offers higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at the speed necessary for demanding tasks like real-time ray tracing or training neural networks. In one specific, but non-limiting example, the communication network 1908 is a network that enables data transmission between devices 1910 and 1912 using data signals (e.g., digital, optical, wireless signals), clock signals, or both. The embodiments described herein can be utilized in a system with a high-speed, scalable switch, such as a switch using NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or similar components. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit and a network interface comprising a receiver or transceiver to perform the corresponding operations and functionalities described herein. The processing unit can include a CPU, GPU, DPU, network adapter, network switch, NVLink switch, or similar components, as described herein.

Other examples of the communication network 1908 can include other chip-to-chip or die-to-die interconnects, such as GRS, LPI (low power interface), or LLI (low latency interface).

The device 1910 includes a transceiver 1914 for sending and receiving signals, such as data signals. These data signals may be digital or optical signals modulated with data or other suitable signals for carrying information.

The transceiver 1914 may include a digital data source 1918, a transmitter 1902, a receiver 1904, and processing circuitry 1920 that controls the transceiver 1914. The digital data source 1918 may include suitable hardware and/or software for outputting data in a digital format (e.g., binary code and/or thermometer code). The digital data output by the digital data source 1918 may be retrieved from memory (not illustrated) or generated according to input (e.g., user input). The transceiver 1914 can include the DNN-based estimation system 102 as described above with respect to FIG. 1 and FIG. 2.

The transceiver 1914 includes suitable software and/or hardware for receiving digital data from the digital data source 1918 and outputting data signals according to the digital data for transmission over the communication network 1908 to a transceiver 1916 of device 1912.

The receiver 1904 of device 1910 may include suitable hardware and/or software for receiving signals, such as data signals from the communication network 1908. For example, the receiver 1904 may include components for processing received signals to extract data for storage in memory. In at least one embodiment, the transceiver 1916 includes a transmitter 1922 and a receiver 1934. The transceiver 1916 receives an incoming signal and samples it to generate data samples, for example, using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO), that controls the sampling of subsequent data by the ADC. The transceiver 1916 can also include the DNN-based estimation system 102 as described above with respect to FIG. 1 and FIG. 2.

The processing circuitry 1920 may comprise software, hardware, or a combination thereof. For example, the processing circuitry 1920 may include a memory containing executable instructions and a processor (e.g., a microprocessor) that executes the instructions stored in the memory. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or the like. In some embodiments, the memory and processor may be integrated into a single device (e.g., a microprocessor with integrated memory). Additionally or alternatively, the processing circuitry 1920 may comprise hardware, such as an Application-Specific Integrated Circuit (ASIC). Other non-limiting examples of the processing circuitry 1920 include an Integrated Circuit (IC) chip, a CPU, a GPU, a DPU, a microprocessor, a Field-Programmable Gate Array (FPGA), a collection of logic gates or transistors, resistors, capacitors, inductors, diodes, or the like. Some or all of the processing circuitry 1920 may be provided on a Printed Circuit Board (PCB) or a collection of PCBs. It should be appreciated that any appropriate type of electrical component or collection of electrical components may be suitable for inclusion in the processing circuitry 1920. The processing circuitry 1920 may send and/or receive signals to and/or from other elements of the transceiver 1914 to control the overall operation of the transceiver 1914.

The transceiver 1914 or selected elements of the transceiver 1914 may take the form of a pluggable card or controller for the device 1910. For example, the transceiver 1914 or selected elements of the transceiver 1914 may be implemented on a network interface card (NIC).

The device 1912 may include a transceiver 1916 for sending and receiving signals, such as data signals, over a communication channel 1906 of the communication network 1908. The communication channel 1906 can be PCIe, NVLink, Ethernet, InfiniBand, Ground Reference Signal (GRS), Chip-to-Chip (C2C), Die-to-Die (D2D), or the like. The same or similar structure of the transceiver 1914 may be applied to transceiver 1916, and thus, the structure of transceiver 1916 is not described separately.

Although not explicitly shown, it should be appreciated that devices 1910 and 1912, as well as transceivers 1914 and 1916, may include other processing devices, storage devices, and/or communication interfaces generally associated with computing tasks, such as sending and receiving data.

FIG. 19B illustrates a block diagram of an example communication system 1924 employing a receiver 1934 with a DNN-based estimation system 102 for optimizing post-FEC BER performance of an FEC system, according to at least one embodiment. In the example shown in FIG. 19B, a Pulse Amplitude Modulation level-4 (PAM4) modulation scheme is employed for the transmission of a signal (e.g., digitally encoded data) from a transmitter (TX) 1902 to a receiver (RX) 1934 via a communication channel 1906 (e.g., a transmission medium). The communication channel 1906 can be PCIe, NVLink, Ethernet, InfiniBand, GRS, C2C, D2D, or similar. In this example, the transmitter 1902 receives input data 1926 (i.e., the input data at time n is represented as “a(n)”), which is modulated in accordance with a modulation scheme (e.g., PAM4) and sends the signal 1928 a(n), including a set of data symbols (e.g., symbols −3, −1, 1, 3, where the symbols represent coded binary data). It should be noted that while the PAM4 modulation scheme is described herein by way of example, other data modulation schemes can be used in accordance with embodiments of the present disclosure, including, for example, a non-return-to-zero (NRZ) modulation scheme, PAM3, PAM7, PAM8, PAM16, and others. For example, in an NRZ-based system, the transmitted data symbols consist of symbols −1 and 1, with each symbol value representing a binary bit. This is also known as a PAM level −2 or PAM2 system, as there are two unique values of transmitted symbols. Typically, a binary bit 0 is encoded as −1, and a bit 1 is encoded as 1, corresponding to the PAM2 values.

In the example shown, the PAM4 modulation scheme uses four (4) unique values of transmitted symbols to achieve higher efficiency and performance. The four levels are denoted by symbol values −3, −1, 1, and 3, with each symbol representing a corresponding unique combination of binary bits (e.g., 00, 01, 10, 11).

The communication channel 1906 is a destructive medium in that it acts as a low-pass filter, attenuating higher frequencies more than lower frequencies, and introduces inter-symbol interference (ISI) and noise from crosstalk, power supplies, electromagnetic interference (EMI), or other sources. The communication channel 1906 can be implemented over serial links (e.g., cables, PCB traces, copper cables, optical fibers, or similar), read channels for data storage (e.g., hard disks, flash solid-state drives (SSDs)), high-speed serial links, deep space satellite communication channels, or other applications. The receiver (RX) 1934 receives an incoming signal 1930 over the communication channel 1906. The receiver 1934 can output a received signal 1932, “v(n),” including the set of data symbols (e.g., symbols −3, −1, 1, 3, wherein the symbols represent coded binary data).

In at least one embodiment, the transmitter 1902 can be part of a SerDes IC. The SerDes IC can be a transceiver that converts parallel data to serial data and vice versa. The SerDes IC can facilitate transmission between two devices over serial streams, reducing the number of data paths, wires/traces, terminals, and so on. The receiver 1934 can also be part of a SerDes IC. The SerDes IC can include a clock-recovery circuit, which can be coupled to an ADC and an equalization block. In another embodiment, the SerDes IC can include an additional equalization block before a symbol detector.

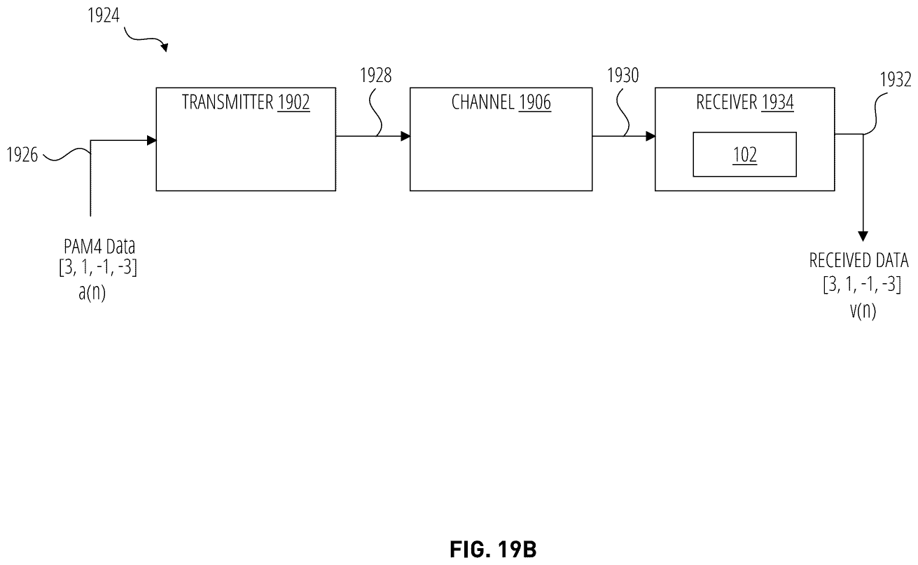

FIG. 20 is a block diagram of a computing system 2000 having two processing devices coupled to each other and to multiple networks, according to at least one embodiment. The computing system 2000 is designed with multiple integrated circuits (referred to as processing devices), where each integrated circuit includes a CPU and two GPUs, forming a powerful and flexible architecture. These processing devices are interconnected via NVLink (or other high-speed interconnects), enabling high-speed communication between the processing devices, and are also connected through a Network Interface Card (NIC) or Data Processing Unit (DPU) to ensure efficient data transfer across the computing system 2000. The coupling of processing devices through NVLink allows for seamless data exchange and parallel processing, enhancing overall computational performance. Additionally, these processing devices are connected to multiple networks through one or more NICs or DPUs, enabling the system to handle complex, multi-network tasks with high bandwidth and low latency. This configuration makes the computing system 2000 highly suitable for demanding applications that require significant processing power, such as artificial intelligence (AI), machine learning (ML), and data-intensive computing, while ensuring robust connectivity and scalability across various networked environments. The integrated circuits of the computing system 2000 can include one or more CPUs and one or more GPUs. An example of a multi-GPU architecture is illustrated in FIG. 20.

As illustrated in FIG. 20, the computing system 2000 includes a processing device 2002 with a multi-GPU architecture. In particular, the processing device 2002 includes a CPU 2006, a GPU 2008, and a GPU 2010. The CPU 2006 can be coupled to the GPU 2008 via a die-to-die (D2D) or chip-to-chip (C2C) interconnect 2012, such as a Ground-Referenced Signaling (GRS) interconnect. The CPU 2006 can be coupled to the GPU 2010 via a D2D or C2C interconnect 2014. The CPU 2006 can also be coupled to the GPU 2008 and GPU 2010 via PCIe interconnects. The CPU 2006 can be coupled to one or more NICs or DPUs, which are coupled to one or more networks. For example, as illustrated in FIG. 20, the CPU 2006 is coupled to a first NIC/DPU 2026, which is coupled to a network 2030. The CPU 2006 is also coupled to a second NIC/DPU 2028, which is coupled to the network 2030. The NIC/DPU 2026 and NIC/DPU 2028 can be coupled to the network 2030 over Ethernet (ETH) or InfiniBand (IB) connections.

The computing system 2000 also includes a processing device 2004 with a multi-GPU architecture. In particular, the processing device 2004 includes a CPU 2016, a GPU 2018, and a GPU 2020. The CPU 2016 can be coupled to the GPU 2018 via a D2D or C2C interconnect 2022. The CPU 2016 can be coupled to the GPU 2020 via a D2D or C2C interconnect 2024. The CPU 2016 can also be coupled to the GPU 2018 and GPU 2020 via PCIe interconnects. The CPU 2016 can be coupled to one or more NICs or DPUs, which are coupled to one or more networks. For example, as illustrated in FIG. 20, the CPU 2016 is coupled to a first NIC/DPU 2032, which is coupled to a network 2036. The CPU 2016 is also coupled to a second NIC/DPU 2034, which is coupled to the network 2036. The NIC/DPU 2032 and NIC/DPU 2034 can be coupled to the network 2036 over Ethernet (ETH) or InfiniBand (IB) connections.

In at least one embodiment, the processing device 2002 and the processing device 2004 can communicate with each other via a NIC/DPU 2038, such as over PCIe interconnects. The processing device 2002 and processing device 2004 can also communicate with each other over high-bandwidth communication interconnects 2040, such as an NVLink interconnect or other high-speed interconnects. The NIC/DPUs of FIG. 20 can be various embodiments of the DPUs described herein. The DNN-based estimation system 102 can be implemented in any receiver device of any of the devices described herein.

In at least one embodiment, the computing system 2000 is used for high-speed network communication and includes a processing unit (e.g., CPU 2006, GPU 2008, GPU 2010, CPU 2016, GPU 2018, GPU 2020, NIC/DPU 2026, NIC/DPU 2028, NIC/DPU 2032, NIC/DPU 2034, or NIC/DPU 2038) and a network interface coupled to the processing unit. The network interface can include a receiver or a transceiver and can perform the corresponding operations and functionalities described herein.

In at least one embodiment, the computing system 2000 includes a host device and an auxiliary device. The auxiliary device includes a device memory and a processor communicably coupled to the device memory. The auxiliary device performs the operations described herein with respect to FIG. 1 to FIG. 12. The auxiliary device can include a GPU, a DPU, or accelerator hardware.

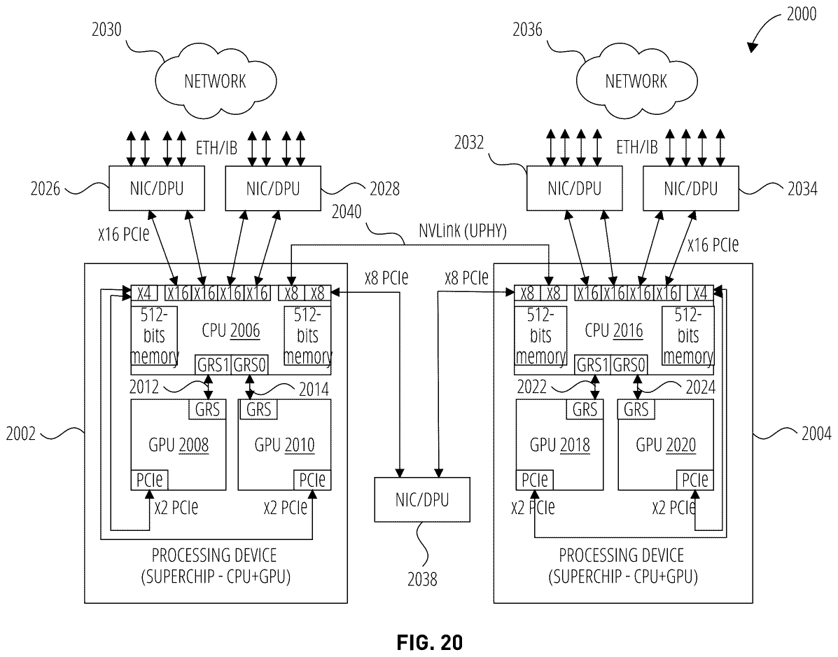

FIG. 21 is a block diagram of a computing system 2100 having a CPU 2102 and a GPU 2104 in a single integrated circuit according to at least one embodiment. The computing system 2100 can be a highly integrated design where a CPU 2102 and GPU 2104 are connected on a single integrated circuit, utilizing an NVLink C2C (Chip-to-Chip) interconnect 2106 to enable fast, low-latency communication between the two processing units. This close integration allows for efficient data transfer and parallel processing between the CPU 2102 and GPU 2104, optimizing performance for complex computational tasks. The GPU elements within the computing system 2100 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 2110. Additionally, the computing system 2100 can be designed to interface with high-speed I/O through PCIe interconnects 2108, ensuring rapid data transfer to and from external devices, further enhancing the system's capabilities in handling data-intensive tasks and providing robust connectivity to peripheral components. It should be noted that the C2C interconnects 2106 can be considered D2D interconnects since the CPU 2102 and the GPU 2104 are located on the same integrated circuit. The integrated circuit can include CPU memory (also referred to as main memory) and GPU memory, which are accessible by the CPU 2102 and the GPU 2104, respectively, over high-speed interconnects. The computing system 2100 can combine the performance of the GPU 2104 with the versatility of the CPU 2102. The CPU 2102 can be connected with high-bandwidth and memory-coherent C2C interconnects 2106 in a single integrated circuit. The computing system 2100 can support a link switch system.

The computing system 2100 can include the DNN-based estimation system 102 used for the various embodiments described herein with respect to FIG. 1 to FIG. 12. The DNN-based estimation system 102 can be implemented in any receiver device of any of the devices described herein.

In at least one embodiment, the computing system 2100 is used for high-speed network communication and includes a processing unit and a network interface coupled to the processing unit. The network interface can include a receiver or a transceiver and can perform the corresponding operations and functionalities described herein.

In at least one embodiment, the computing system 2100 includes a host device and an auxiliary device. The auxiliary device includes a device memory and a processor communicably coupled to the device memory. The auxiliary device performs the operations described herein with respect to FIG. 1 to FIG. 12. The auxiliary device can include a GPU, a DPU, or accelerator hardware.

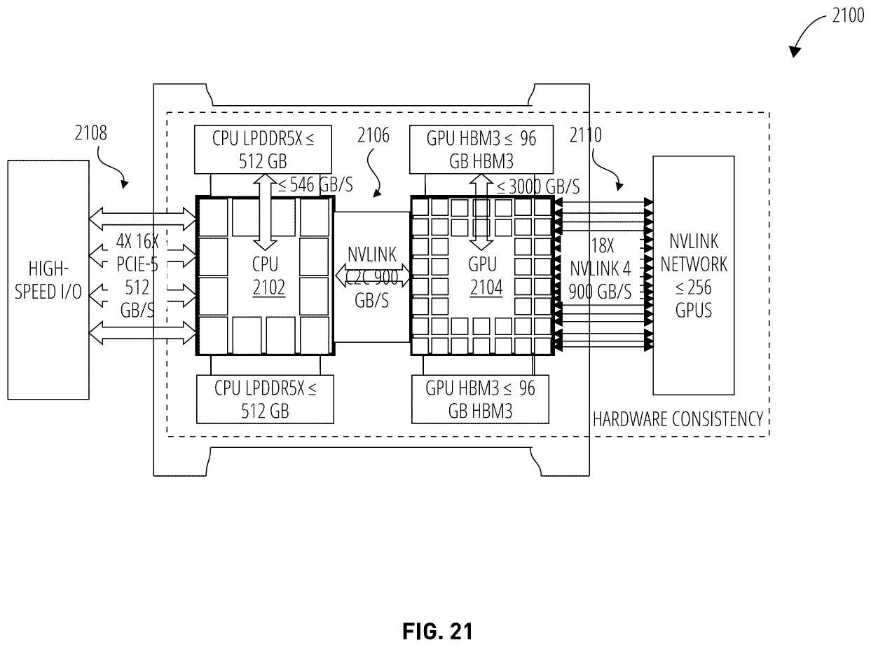

FIG. 22 is a block diagram of a computing system 2200 having tensor core GPUs 2208 according to at least one embodiment. The computing system 2200 can be a DGX H100 system, which is a high-performance computing platform designed to meet the demands of AI, ML, and deep learning (DL) workloads. The computing system 2200 can include multiple tensor core GPUs 2208 (e.g., NVIDIA H100 Tensor Core GPUs). Each tensor core GPU 2208 can be one of the integrated circuits described above with respect to FIG. 12. The tensor core GPUs 2208 can be optimized for AI/ML/DL applications, offering exceptional performance for deep learning training, inference, and high-performance computing tasks. The tensor core GPUs 2208 within the computing system 2200 are interconnected using high-speed communication interfaces such as NVLinks, enabling rapid data transfer between them, which is crucial for handling large-scale AI models and datasets with low latency. This computing system 2200 is designed for scalability, allowing for the integration of additional GPUs as required, making it versatile enough for research, development, and deployment in data centers for production AI workloads. Each GPU is equipped with Tensor Cores, specialized processing units that accelerate matrix operations-a fundamental component of AI and deep learning algorithms. These Tensor Cores enable the system to perform mixed-precision calculations efficiently, balancing speed and accuracy. Given the power consumption and heat generation of multiple tensor core GPUs 2208, the computing system 2200 can include advanced cooling solutions and power management features to ensure safe operation while maintaining peak performance. It is supported by a comprehensive software ecosystem, including NVIDIA's CUDA programming model, AI frameworks such as TensorFlow and PyTorch, and other HPC and AI software tools, which enable developers and researchers to harness the full power of the tensor core GPUs 2208 for their specific applications. The computing system 2200 is ideally suited for large-scale AI model training, real-time inference, scientific simulations, data analytics, and other compute-intensive tasks that require massive parallel processing power.

The tensor core GPUs 2208 can be coupled to multiple CPUs, such as CPU 2202 and CPU 2204, using switches 2206 (e.g., CX7 HCA/NIC with PCIe switch). The tensor core GPUs 2208 can be coupled to each other via switches 2210 (e.g., NVSwitches). The switches 2206 and switches 2210 can be coupled to high-speed transceiver modules 2212. The high-speed transceiver modules 2212 can be Octal Small Form-factor Pluggable (OSFP) modules. OSFP modules are high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in environments requiring continuous uptime. Additionally, OSFP modules are designed for high density, maximizing the number of high-speed connections within limited space, such as in densely packed server racks. By adhering to the latest networking standards, OSFP modules ensure the computing system 2200 remains capable of meeting increasing data demands and can be upgraded to support future advancements in network speeds, thus contributing to the system's overall performance and scalability.

In at least one embodiment, the computing system 2200 can be configured as a data-network with full-bandwidth intra-server NVLinks. In this example, all eight tensor core GPUs 2208 can simultaneously saturate eighteen NVLinks to other GPUs within the server. The bandwidth may be limited by over-subscription from multiple other GPUs. In another embodiment, the data-network configuration can utilize half-bandwidth intra-server NVLinks. In this scenario, all eight tensor core GPUs 2208 can half-subscribe to eighteen NVLinks connecting to GPUs in other servers, while four tensor core GPUs 2208 can fully saturate eighteen NVLinks to GPUs in other servers. This is equivalent to full bandwidth on AllReduce with Scalable Hierarchical Aggregation and Reduction Protocol (SHARP). The reduction in all-to-all (All2All) bandwidth is a trade-off between server complexity and cost. In at least one embodiment, all eight tensor core GPUs 2208 can independently transfer data using the Remote Direct Memory Access (RDMA) protocol over their own dedicated switches (e.g., 400 Gb/s HCA/NIC) in a multi-rail InfiniBand/Ethernet configuration. In this example, there is an aggregate full duplex bandwidth of 800 GBps to non-NVLink network devices.

The NICs and switches of computing system 2200 can include the various embodiments described herein with respect to FIG. 1 to FIG. 9.

In at least one embodiment, the computing system 2200 is used for high-speed network communication and includes a processing unit (e.g., CPU 2202, CPU 2204, switches 2206, tensor core GPUs 2208, switches 2210, high-speed transceiver modules 2212) and a network interface coupled to the processing unit. The network interface can include a receiver or a transceiver and perform the corresponding operations and functionalities described herein. The processing unit can include a CPU, GPU, DPU, network adapter, network switch, NVLink switch, or similar components.

In at least one embodiment, the computing system 2200 includes a host device and an auxiliary device. The auxiliary device includes a device memory and a processor communicably coupled to the device memory. The auxiliary device performs the operations described herein with respect to FIG. 1 to FIG. 9. The auxiliary device can include a GPU, a DPU, or accelerator hardware.

### Inference and Training Logic

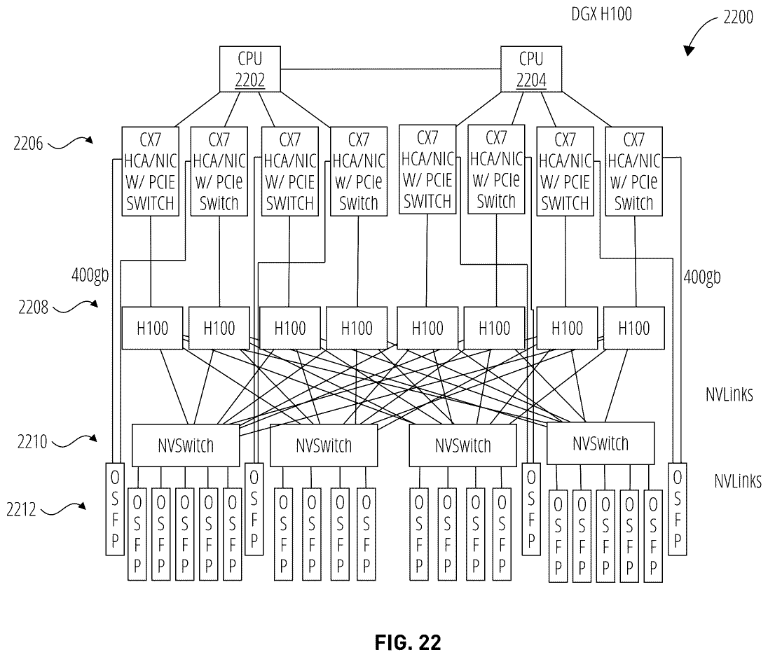

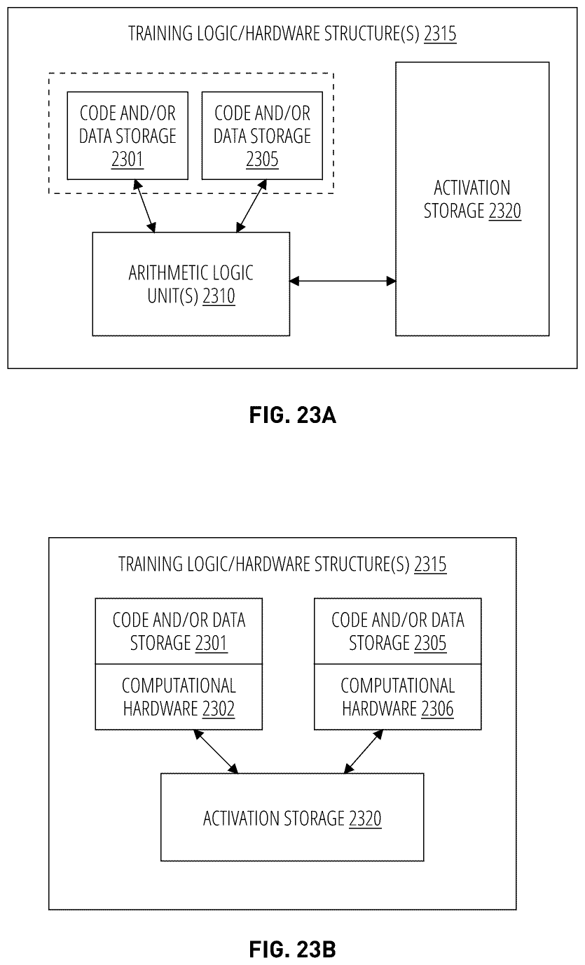

FIG. 23A illustrates inference and/or training logic 2315 used to perform inferencing and/or training operations associated with one or more embodiments.

In at least one embodiment, inference and/or training logic 2315 may include code and/or data storage 2301 to store forward and/or output weights, input/output data, and other parameters to configure neurons or layers of a neural network trained and/or used for inferencing. In at least one embodiment, training logic 2315 may include (or be coupled to) code and/or data storage 2301 that stores graph code or other software to control the timing and/or order in which weight and/or other parameter information is loaded to configure processing units, including logic units, integer and/or floating point units (collectively, arithmetic logic units (ALUs) or simply circuits). In at least one embodiment, code, such as graph code, loads weight or other parameter information into processor ALUs based on the architecture of a neural network to which such code corresponds. In at least one embodiment, code and/or data storage 2301 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 2301 may be included with other on-chip or off-chip data storage, including a processor's L1, L2, or L3 cache or system memory.

In at least one embodiment, any portion of code and/or data storage 2301 may be internal or external to one or more processors or other hardware logic devices or circuits. In at least one embodiment, code and/or data storage 2301 may be cache memory, DRAM, SRAM, non-volatile memory (e.g., flash memory), or other storage. In at least one embodiment, the choice of whether code and/or data storage 2301 is internal or external to a processor, or comprises DRAM, SRAM, flash, or some other storage type, may depend on available storage on-chip versus off-chip, latency requirements of training and/or inferencing functions being performed, batch size of data used in inferencing and/or training of a neural network, or some combination of these factors.

In at least one embodiment, inference and/or training logic 2315 may include, without limitation, code and/or data storage 2305 to store backward and/or output weights and/or input/output data corresponding to neurons or layers of a neural network trained and/or used for inferencing in aspects of one or more embodiments. In at least one embodiment, code and/or data storage 2305 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 2315 may include (or be coupled to) code and/or data storage 2305 that stores graph code or other software to control the timing and/or order in which weight and/or other parameter information is loaded to configure processing units, including logic units, integer and/or floating point units (collectively, arithmetic logic units (ALUs)).

In at least one embodiment, code, such as graph code, causes the loading of weight or other parameter information into processor ALUs based on the architecture of a neural network to which such code corresponds. In at least one embodiment, any portion of code and/or data storage 2305 may be included with other on-chip or off-chip data storage, including a processor's L1, L2, or L3 cache or system memory. In at least one embodiment, any portion of code and/or data storage 2305 may be internal or external to one or more processors or other hardware logic devices or circuits. In at least one embodiment, code and/or data storage 2305 may be cache memory, DRAM, SRAM, non-volatile memory (e.g., flash memory), or other storage. In at least one embodiment, the choice of whether code and/or data storage 2305 is internal or external to a processor, or comprises DRAM, SRAM, flash memory, or some other storage type, may depend on available storage on-chip versus off-chip, latency requirements of training and/or inferencing functions being performed, batch size of data used in inferencing and/or training of a neural network, or some combination of these factors.

In at least one embodiment, code and/or data storage 2301 and code and/or data storage 2305 may be separate storage structures. In at least one embodiment, code and/or data storage 2301 and code and/or data storage 2305 may be a combined storage structure. In at least one embodiment, code and/or data storage 2301 and code and/or data storage 2305 may be partially combined and partially separate. In at least one embodiment, any portion of code and/or data storage 2301 and code and/or data storage 2305 may be included with other on-chip or off-chip data storage, including a processor's L1, L2, or L3 cache or system memory.

In at least one embodiment, inference and/or training logic 2315 may include one or more arithmetic logic units (“ALUs”) 2310, including integer and/or floating point units, to perform logical and/or mathematical operations based, at least in part, on or indicated by training and/or inference code (e.g., graph code). The result of these operations may produce activations (e.g., output values from layers or neurons within a neural network) stored in activation storage 2320, which are functions of input/output and/or weight parameter data stored in code and/or data storage 2301 and/or code and/or data storage 2305. In at least one embodiment, activations stored in activation storage 2320 are generated according to linear algebraic and/or matrix-based mathematics performed by ALUs 2310 in response to instructions or other code, wherein weight values stored in code and/or data storage 2305 and/or code and/or data storage 2301 are used as operands along with other values, such as bias values, gradient information, momentum values, or other parameters or hyperparameters. Any or all of these may be stored in code and/or data storage 2305, code and/or data storage 2301, or another storage on or off-chip.

In at least one embodiment, ALUs 2310 are included within one or more processors or other hardware logic devices or circuits, whereas in another embodiment, ALUs 2310 may be external to a processor or other hardware logic device or circuit that uses them (e.g., a co-processor). In at least one embodiment, ALUs 2310 may be included within a processor's execution units or otherwise within a bank of ALUs accessible by a processor's execution units, either within the same processor or distributed between different processors of different types (e.g., central processing units, graphics processing units, fixed function units, etc.). In at least one embodiment, code and/or data storage 2301, code and/or data storage 2305, and activation storage 2320 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 2320 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement, and/or other logical circuits.

In at least one embodiment, activation storage 2320 may be cache memory, DRAM, SRAM, non-volatile memory (e.g., flash memory), or other storage. In at least one embodiment, activation storage 2320 may be completely or partially within or external to one or more processors or other logical circuits. In at least one embodiment, the choice of whether activation storage 2320 is internal or external to a processor, or comprises DRAM, SRAM, flash memory, or some other storage type, may depend on available storage on-chip versus off-chip, latency requirements of training and/or inferencing functions being performed, batch size of data used in inferencing and/or training of a neural network, or some combination of these factors.

In at least one embodiment, inference and/or training logic 2315 illustrated in FIG. 23A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 2315 illustrated in FIG. 23A may be used in conjunction with central processing unit (“CPU”) hardware, graphics processing unit (“GPU”) hardware, or other hardware, such as field-programmable gate arrays (“FPGAs”).

FIG. 23B illustrates inference and/or training logic 2315, according to at least one embodiment. In at least one embodiment, inference and/or training logic 2315 may include hardware logic in which computational resources are dedicated to, or otherwise exclusively used in conjunction with, weight values or other information corresponding to one or more layers of neurons within a neural network. In at least one embodiment, the inference and/or training logic 2315 illustrated in FIG. 23B may be used in conjunction with an application-specific integrated circuit (ASIC), such as a TensorFlow® Processing Unit from Google, an inference processing unit (IPU) from Graphcore™, or a Nervana® (e.g., “Lake Crest”) processor from Intel Corp. In at least one embodiment, the inference and/or training logic 2315 illustrated in FIG. 23B may be used in conjunction with central processing unit (CPU) hardware, graphics processing unit (GPU) hardware, or other hardware, such as field-programmable gate arrays (FPGAs). In at least one embodiment, inference and/or training logic 2315 includes code and/or data storage 2301 and code and/or data storage 2305, which may be used to store code (e.g., graph code), weight values, and/or other information, including bias values, gradient information, momentum values, and/or other parameter or hyperparameter information. In at least one embodiment illustrated in FIG. 23B, each of code and/or data storage 2301 and code and/or data storage 2305 is associated with a dedicated computational resource, such as computational hardware 2302 and computational hardware 2306, respectively. In at least one embodiment, each of computational hardware 2302 and computational hardware 2306 comprises one or more ALUs that perform mathematical functions, such as linear algebraic functions, only on information stored in code and/or data storage 2301 and code and/or data storage 2305, respectively, the result of which is stored in activation storage 2320.

In at least one embodiment, each of code and/or data storage 2301 and 2305 and the corresponding computational hardware 2302 and 2306, respectively, correspond to different layers of a neural network, such that the resulting activation from one storage/computational pair 2301/2302 (of code and/or data storage 2301 and computational hardware 2302) is provided as an input to the next storage/computational pair 2305/2306 (of code and/or data storage 2305 and computational hardware 2306), to mirror the conceptual organization of a neural network. In at least one embodiment, each of the storage/computational pairs 2301/2302 and 2305/2306 may correspond to more than one neural network layer. In at least one embodiment, additional storage/computation pairs (not shown), subsequent to or in parallel with storage/computation pairs 2301/2302 and 2305/2306, may be included in inference and/or training logic 2315.

### Neural Network Training and Deployment

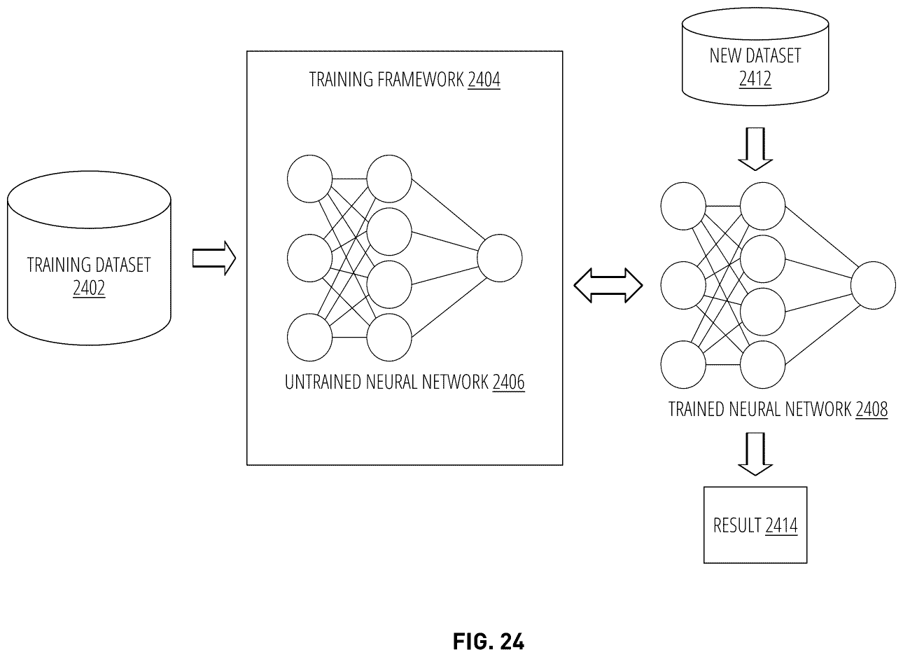

FIG. 24 illustrates training and deployment of a deep neural network, according to at least one embodiment. In at least one embodiment, untrained neural network 2406 is trained using a training dataset 2402. In at least one embodiment, training framework 2404 is a PyTorch framework, whereas in other embodiments, training framework 2404 may be TensorFlow, Boost, Caffe, Microsoft Cognitive Toolkit/CNTK, MXNet, Chainer, Keras, Deeplearning4j, or another training framework. In at least one embodiment, training framework 2404 trains an untrained neural network 2406 and enables it to be trained using processing resources described herein to generate a trained neural network 2408. In at least one embodiment, weights may be chosen randomly or by pre-training using a deep belief network. In at least one embodiment, training may be performed in a supervised, partially supervised, or unsupervised manner.

In at least one embodiment, untrained neural network 2406 is trained using supervised learning, wherein training dataset 2402 includes inputs paired with desired outputs, or where training dataset 2402 includes inputs with known outputs and the output of neural network 2406 is manually graded. In at least one embodiment, untrained neural network 2406 is trained in a supervised manner by processing inputs from training dataset 2402 and comparing the resulting outputs against a set of expected or desired outputs. In at least one embodiment, errors are then propagated back through untrained neural network 2406. In at least one embodiment, training framework 2404 adjusts the weights that control untrained neural network 2406. In at least one embodiment, training framework 2404 includes tools to monitor how well untrained neural network 2406 is converging towards a model, such as trained neural network 2408, suitable for generating correct answers, such as result 2414, based on input data such as new dataset 2412. In at least one embodiment, training framework 2404 trains untrained neural network 2406 repeatedly while adjusting weights to refine the output of untrained neural network 2406 using a loss function and adjustment algorithm, such as stochastic gradient descent. In at least one embodiment, training framework 2404 trains untrained neural network 2406 until it achieves a desired accuracy. In at least one embodiment, trained neural network 2408 can then be deployed to implement any number of machine learning operations.

In at least one embodiment, untrained neural network 2406 is trained using unsupervised learning, wherein untrained neural network 2406 attempts to train itself using unlabeled data. In at least one embodiment, the unsupervised learning training dataset 2402 will include input data without any associated output data or “ground truth” data. In at least one embodiment, untrained neural network 2406 can learn groupings within training dataset 2402 and can determine how individual inputs are related to untrained dataset 2402. In at least one embodiment, unsupervised training can be used to generate a self-organizing map in trained neural network 2408 capable of performing operations useful in reducing the dimensionality of new dataset 2412. In at least one embodiment, unsupervised training can also be used to perform anomaly detection, which allows identification of data points in new dataset 2412 that deviate from normal patterns of new dataset 2412.

In at least one embodiment, semi-supervised learning may be used, which is a technique in which training dataset 2402 includes a mix of labeled and unlabeled data. In at least one embodiment, training framework 2404 may be used to perform incremental learning, such as through transferred learning techniques. In at least one embodiment, incremental learning enables trained neural network 2408 to adapt to new dataset 2412 without forgetting knowledge instilled within trained neural network 2408 during initial training.

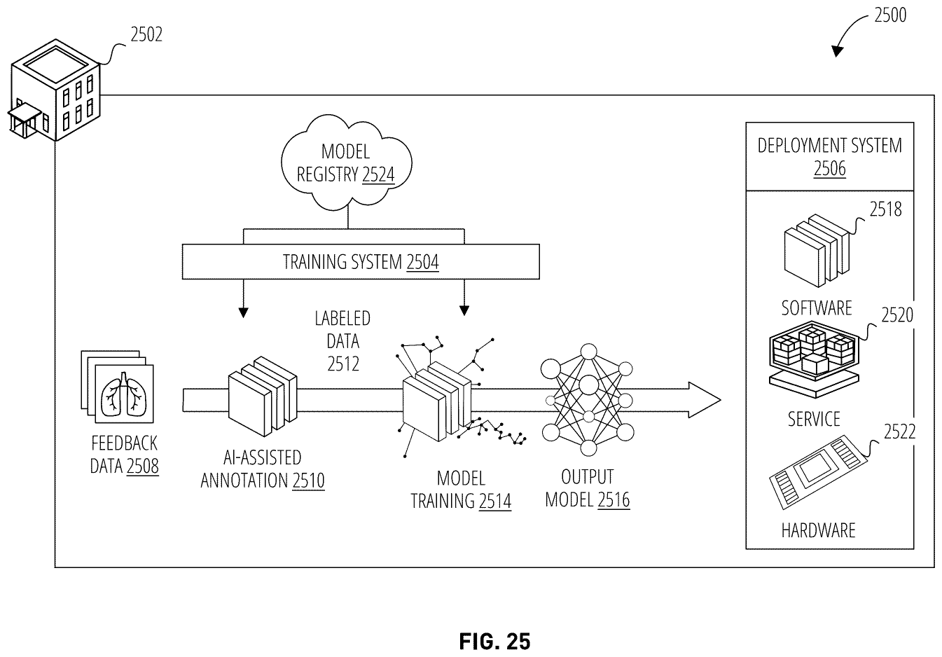

With reference to FIG. 25, FIG. 25 is an example data flow diagram for a process 2500 of generating and deploying a processing and inferencing pipeline, according to at least one embodiment. In at least one embodiment, process 2500 may be deployed to perform game name recognition analysis and inferencing on user feedback data at one or more facilities 2502, such as a data center.

In at least one embodiment, process 2500 may be executed within a training system 2504 and/or a deployment system 2506. In at least one embodiment, training system 2504 may be used to perform training, deployment, and embodiment of machine learning models (e.g., neural networks, object detection algorithms, computer vision algorithms, etc.) for use in deployment system 2506. In at least one embodiment, deployment system 2506 may be configured to offload processing and compute resources among a distributed computing environment to reduce infrastructure requirements at facility 2502. In at least one embodiment, deployment system 2506 may provide a streamlined platform for selecting, customizing, and implementing virtual instruments for use with computing devices at facility 2502. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 2506 during execution of applications.

In at least one embodiment, some applications used in advanced processing and inferencing pipelines may utilize machine learning models or other AI technologies to perform one or more processing steps. In at least one embodiment, machine learning models may be trained at facility 2502 using feedback data 2508 (such as imaging data) stored at facility 2502, feedback data 2508 from another facility or facilities, or a combination thereof. In at least one embodiment, training system 2504 may provide applications, services, and/or other resources for generating functional, deployable machine learning models for deployment system 2506.

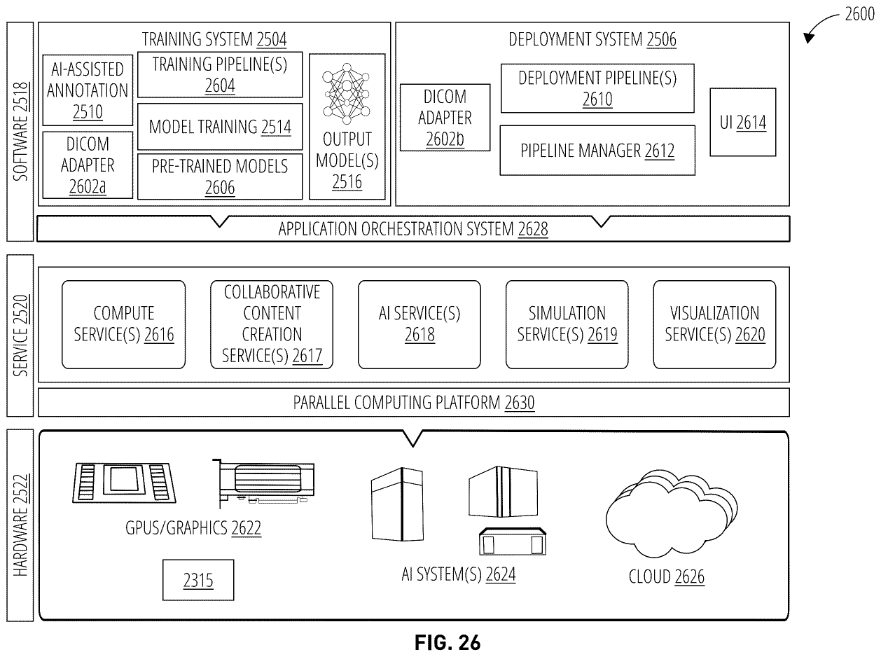

In at least one embodiment, a model registry 2524 may be backed by object storage that may support versioning and object metadata. In at least one embodiment, object storage may be accessible, for example, through a cloud storage (e.g., cloud 2626 of FIG. 26) compatible application programming interface (API) from within a cloud platform. In at least one embodiment, machine learning models within model registry 2524 may be uploaded, listed, modified, or deleted by developers or partners interacting with an API. In at least one embodiment, an API may provide access to methods that allow users with appropriate credentials to associate models with applications, enabling models to be executed as part of containerized instantiations of applications.

In at least one embodiment, a training pipeline(s) 2604 (FIG. 26) may include a scenario where facility 2502 is training its own machine learning model or has an existing machine learning model that needs to be optimized or updated. In at least one embodiment, feedback data 2508 may be received from various channels, such as forums, web forms, or similar sources. In at least one embodiment, once feedback data 2508 is received, AI-assisted annotation 2510 may be used to generate annotations corresponding to feedback data 2508, which serve as ground truth data for a machine learning model. In at least one embodiment, AI-assisted annotation 2510 may include one or more machine learning models (e.g., convolutional neural networks (CNNs)) that may be trained to generate annotations for certain types of feedback data 2508 (e.g., from specific devices) and/or certain types of anomalies in feedback data 2508. In at least one embodiment, AI-assisted annotations 2510 may then be used directly or may be adjusted or fine-tuned using an annotation tool, to generate ground truth data. In at least one embodiment, in some examples, labeled data 2512 may be used as ground truth data for training a machine learning model. In at least one embodiment, AI-assisted annotations 2510, labeled data 2512, or a combination thereof may be used as ground truth data for training a machine learning model, for example, via model training 2514 in FIG. 25 and/or FIG. 26. In at least one embodiment, a trained machine learning model may be referred to as an output model 2516 and may be used by deployment system 2506, as described herein.

In at least one embodiment, training pipeline(s) 2604 (FIG. 26) may include a scenario in which facility 2502 needs a machine learning model to perform one or more processing tasks for one or more applications in deployment system 2506, but facility 2502 may not currently have such a machine learning model (or may not have a model that is optimized, efficient, or effective for such purposes). In at least one embodiment, an existing machine learning model may be selected from model registry 2524. In at least one embodiment, model registry 2524 may include machine learning models trained to perform a variety of different inference tasks on imaging data. In at least one embodiment, machine learning models in model registry 2524 may have been trained on imaging data from facilities other than facility 2502 (e.g., remotely located facilities). In at least one embodiment, machine learning models may have been trained on imaging data from one location, two locations, or any number of locations. In at least one embodiment, when being trained on imaging data—which may be a form of feedback data 2508—from a specific location, training may take place at that location, or at least in a manner that protects the confidentiality of imaging data or restricts imaging data from being transferred off-premises (e.g., to comply with HIPAA regulations, privacy regulations, etc.). In at least one embodiment, once a model is trained- or partially trained—at one location, it may be added to model registry 2524. In at least one embodiment, a machine learning model may then be retrained or updated at any number of other facilities, and the retrained or updated model may be made available in model registry 2524. In at least one embodiment, a machine learning model may then be selected from model registry 2524—referred to as output model(s) 2516—and used in deployment system 2506 to perform one or more processing tasks for one or more applications of a deployment system.

In at least one embodiment, training pipeline(s) 2604 (FIG. 26) may be used in a scenario where facility 2502 requires a machine learning model for performing one or more processing tasks for one or more applications in deployment system 2506, but facility 2502 may not currently have such a machine learning model (or may not have a model that is optimized, efficient, or effective for such purposes). In at least one embodiment, a machine learning model selected from model registry 2524 might not be fine-tuned or optimized for feedback data 2508 generated at facility 2502 due to differences in populations, genetic variations, robustness of the training data used to train the model, diversity in anomalies within the training data, and/or other issues with the training data. In at least one embodiment, AI-assisted annotation 2510 may be used to aid in generating annotations corresponding to feedback data 2508, which can be used as ground truth data for retraining or updating a machine learning model. In at least one embodiment, labeled data 2512 may also be used as ground truth data for training a machine learning model. In at least one embodiment, retraining or updating a machine learning model may be referred to as model training 2514. In at least one embodiment, model training 2514 may include data—such as AI-assisted annotations 2510, labeled data 2512, or a combination thereof—that may be used as ground truth data for retraining or updating a machine learning model.

In at least one embodiment, deployment system 2506 may include software 2518, service 2520, hardware 2522, and/or other components, features, and functionality. In at least one embodiment, deployment system 2506 may include a software “stack,” such that software 2518 may be built on top of service 2520 and may use service 2520 to perform some or all processing tasks. Service 2520 and software 2518 may be built on top of hardware 2522 and use hardware 2522 to execute processing, storage, and/or other compute tasks of deployment system 2506.

In at least one embodiment, software 2518 may include any number of different containers, with each container executing an instance of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device, there may be any number of containers capable of performing a data processing task with respect to feedback data 2508 (or other data types, as described herein). In at least one embodiment, an advanced processing and inferencing pipeline may be defined based on the selection of different containers that are desired or required for processing feedback data 2508, in addition to containers that receive and configure imaging data for use by each container and/or for use by facility 2502 after processing through a pipeline (e.g., to convert outputs back to a usable data type for storage and display at facility 2502). In at least one embodiment, a combination of containers within software 2518 (e.g., those that make up a pipeline) may be referred to as a virtual instrument (as described in more detail herein), and a virtual instrument may leverage service 2520 and hardware 2522 to execute some or all processing tasks of applications instantiated in containers.

In at least one embodiment, data may undergo pre-processing as part of the data processing pipeline to prepare it for processing by one or more applications. In at least one embodiment, post-processing may be performed on the output of one or more inferencing tasks or other processing tasks of a pipeline to prepare output data for the next application and/or to prepare output data for transmission and/or use by a user (e.g., as a response to an inference request). In at least one embodiment, inferencing tasks may be performed by one or more machine learning models, such as trained or deployed neural networks, which may include output model(s) 2516 of training system 2504.

In at least one embodiment, tasks of a data processing pipeline may be encapsulated in one or more containers, each representing a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 2524 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with the system). In at least one embodiment, an application that is developed may be tested locally (e.g., at a first facility, on data from a first facility) with an SDK that may support at least some of services 2520 as a system (e.g., system 2600 of FIG. 26). In at least one embodiment, once validated by system 2600 (e.g., for accuracy, etc.), an application may be made available in a container registry for selection and/or use by a user (e.g., a hospital, clinic, lab, healthcare provider, etc.) to perform one or more processing tasks with respect to data at a facility (e.g., a second facility) of a user.

In at least one embodiment, developers may share applications or containers over a network for access and use by users of a system (e.g., system 2600 of FIG. 26). In at least one embodiment, completed and validated applications or containers may be stored in a container registry and associated machine learning models may be stored in model registry 2524. In at least one embodiment, a requesting entity that provides an inference or image processing request may browse a container registry and/or model registry 2524 for an application, container, dataset, machine learning model, etc., select a desired combination of elements for inclusion in a data processing pipeline, and submit a processing request. In at least one embodiment, a request may include input data necessary to perform the request and/or a selection of application(s) and/or machine learning models to be executed during processing. In at least one embodiment, a request may then be passed to one or more components of deployment system 2506 (e.g., a cloud) to process the data pipeline. In at least one embodiment, processing by deployment system 2506 may include referencing selected elements (e.g., applications, containers, models, etc.) from the container registry and/or model registry 2524. In at least one embodiment, once results are generated by the pipeline, they may be returned to a user for reference (e.g., for viewing in a viewing application suite executing on a local, on-premises workstation or terminal).

In at least one embodiment, to aid in processing or execution of applications or containers in pipelines, service 2520 may be leveraged. In at least one embodiment, service 2520 may include compute services, collaborative content creation services, simulation services, artificial intelligence (AI) services, visualization services, and/or other service types. In at least one embodiment, service 2520 may provide functionality that is common to one or more applications in software 2518, allowing functionality to be abstracted to a service that can be called upon or leveraged by applications. In at least one embodiment, functionality provided by service 2520 may run dynamically and more efficiently, while also scaling well by allowing applications to process data in parallel, e.g., using a parallel computing platform 2630 (FIG. 26). Rather than requiring each application that shares the same functionality offered by service 2520 to have a respective instance, service 2520 may be shared among various applications. In at least one embodiment, services may include an inference server or engine that can be used for executing detection or segmentation tasks, as non-limiting examples. In at least one embodiment, a model training service may also be included to provide machine learning model training and/or retraining capabilities.

In at least one embodiment, where a service 2520 includes an AI service (e.g., an inference service), one or more machine learning models associated with an application for anomaly detection (e.g., tumors, growth abnormalities, scarring, etc.) may be executed by calling upon (e.g., via an API call) an inference service (e.g., an inference server) to execute machine learning model(s), or process them, as part of application execution. In at least one embodiment, where another application includes one or more machine learning models for segmentation tasks, an application may call upon an inference service to execute machine learning models for performing one or more processing operations associated with segmentation tasks. In at least one embodiment, software 2518 implementing an advanced processing and inferencing pipelines may be streamlined because each application may call upon the same inference service to perform one or more inferencing tasks.

In at least one embodiment, hardware 2522 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 2522 may be used to provide efficient, purpose-built support for software 2518 and service 2520 in deployment system 2506. In at least one embodiment, use of GPU processing may be implemented for processing locally (e. g., at facility 2502), within an AI/deep learning system, in a cloud system, and/or in other processing components of deployment system 2506 to improve the efficiency, accuracy, and efficacy of game name recognition.

In at least one embodiment, software 2518 and/or service 2520 may be optimized for GPU processing for deep learning, machine learning, high-performance computing, simulation, and visual computing, as non-limiting examples. In at least one embodiment, some or all of the computing environment of deployment system 2506 and/or training system 2504 may be executed in a datacenter or on one or more supercomputers or high-performance computing systems, with GPU-optimized software (e.g., a hardware and software combination such as NVIDIA's DGX™ system). In at least one embodiment, hardware 2522 may include any number of GPUs that can be utilized to perform parallel data processing, as described herein. In at least one embodiment, the cloud platform may also include GPU processing for GPU-optimized execution of deep learning tasks, machine learning tasks, or other computing tasks. In at least one embodiment, the cloud platform (e.g., NVIDIA's NGC™) may be executed using AI/deep learning supercomputers and/or GPU-optimized software (e.g., as provided on NVIDIA's DGX™ systems) as a hardware abstraction and scaling platform. In at least one embodiment, the cloud platform may integrate an application container clustering system or orchestration system (e.g., KUBERNETES) into multiple GPUs to enable seamless scaling and load balancing.

FIG. 26 is a system diagram for an example system 2600 for generating and deploying a deployment pipeline, according to at least one embodiment. In at least one embodiment, system 2600 may be used to implement process 2500 of FIG. 25 and/or other processes including advanced processing and inferencing pipelines. In at least one embodiment, system 2600 may include training system 2504 and deployment system 2506. In at least one embodiment, training system 2504 and deployment system 2506 may be implemented using software 2518, services 2520, and/or hardware 2522, as described herein.

In at least one embodiment, system 2600 (e.g., training system 2504 and/or deployment system 2506) may implemented in a cloud computing environment (e.g., using cloud 2626). In at least one embodiment, system 2600 may be implemented locally with respect to a facility, or as a combination of both cloud and local computing resources. In at least one embodiment, access to APIs in cloud 2626 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 2600, may be restricted to a set of public internet service providers (ISPs) that have been vetted or authorized for interaction.

In at least one embodiment, various components of system 2600 may communicate between and among one another using any of a variety of different network types, including but not limited to local area networks (LANs) and/or wide area networks (WANs) via wired and/or wireless communication protocols. In at least one embodiment, communication between facilities and components of system 2600 (e.g., for transmitting inference requests, for receiving results of inference requests, etc.) may be communicated over a data bus or data buses, wireless data protocols (e.g., Wi-Fi), wired data protocols (e.g., Ethernet), etc.

In at least one embodiment, training system 2504 may execute training pipelines 2604, similar to those described herein with respect to FIG. 25. In at least one embodiment, where one or more machine learning models are to be used in deployment pipeline(s) 2610 by deployment system 2506, training pipeline(s) 2604 may be used to train or retrain one or more (e.g., pre-trained) models, and/or implement one or more of pre-trained models 2606 (e.g., without a need for retraining or updating). In at least one embodiment, as a result of training pipeline(s) 2604, output model(s) 2516 may be generated. In at least one embodiment, training pipeline(s) 2604 may include any number of processing steps, AI-assisted annotation 2510, labeling or annotating of feedback data 2508 to generate labeled data 2512, model selection from a model registry, model training 2514, training, retraining, or updating models, and/or other processing steps. In at least one embodiment, DICOM adapter 2102a can be used to access DICOM data. In at least one embodiment, for different machine learning models used by deployment system 2506, different training pipeline(s) 2604 may be used. In at least one embodiment, training pipeline(s) 2604, similar to a first example described with respect to FIG. 25, may be used for a first machine learning model, training pipeline(s) 2604, similar to a second example described with respect to FIG. 25, may be used for a second machine learning model, and training pipeline(s) 2604, similar to a third example described with respect to FIG. 25, may be used for a third machine learning model. In at least one embodiment, any combination of tasks within training system 2504 may be used depending on what is required for each respective machine learning model. In at least one embodiment, one or more machine learning models may already be trained and ready for deployment so machine learning models may not undergo any processing by training system 2504 and may be implemented by deployment system 2506.

In at least one embodiment, output model(s) 2516 and/or pre-trained models 2606 may include any types of machine learning models depending on embodiment. In at least one embodiment, and without limitation, machine learning models used by system 2600 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 2604 may include AI-assisted annotation. In at least one embodiment, labeled data 2512 (e.g., traditional annotation) may be generated by any number of techniques. In at least one embodiment, labels or other annotations may be generated within a drawing program (e.g., an annotation program), a computer-aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 2508 (or other data type used by machine learning models), there may be corresponding ground truth data generated by training system 2504. In at least one embodiment, AI-assisted annotation may be performed as part of deployment pipeline(s) 2610; either in addition to, or in lieu of, AI-assisted annotation included in training pipeline(s) 2604. In at least one embodiment, system 2600 may include a multi-layer platform that may include a software layer (e.g., software 2518) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from external environment(s), e.g., facility 2502. In at least one embodiment, applications may then call or execute one or more services 2520 for performing compute, AI, or visualization tasks associated with respective applications, and software 2518 and/or services 2520 may leverage hardware 2522 to perform processing tasks in an effective and efficient manner.

In at least one embodiment, deployment system 2506 may execute deployment pipelines 2610. In at least one embodiment, deployment pipeline(s) 2610 may include any number of applications that may be sequentially, non-sequentially, or otherwise applied to feedback data (and/or other data types), including AI-assisted annotation, as described above. In at least one embodiment, as described herein, a deployment pipeline(s) 2610 for an individual device may be referred to as a virtual instrument for a device. In at least one embodiment, for a single device, there may be more than one deployment pipeline(s) 2610 depending on information desired from data generated by a device.

In at least one embodiment, applications available for deployment pipeline(s) 2610 may include any application that may be used for performing processing tasks on feedback data or other data from devices. In at least one embodiment, because various applications may share common image operations, in some embodiments, a data augmentation library (e.g., as one of services 2520) may be used to accelerate these operations. In at least one embodiment, to avoid bottlenecks of conventional processing approaches that rely on CPU processing, parallel computing platform 2630 may be used for GPU acceleration of these processing tasks.

In at least one embodiment, deployment system 2506 may include a user interface (UI) 2614 (e.g., a graphical user interface, a web interface, etc.) that may be used to select applications for inclusion in deployment pipeline(s) 2610, arrange applications, modify or change applications or parameters or constructs thereof, use and interact with deployment pipeline(s) 2610 during set-up and/or deployment, and/or to otherwise interact with deployment system 2506. In at least one embodiment, although not illustrated with respect to training system 2504, UI 2614 (or a different user interface) may be used for selecting models for use in deployment system 2506, for selecting models for training, or retraining, in training system 2504, and/or for otherwise interacting with training system 2504.

In at least one embodiment, pipeline manager 2612 may be used, in addition to an application orchestration system 2628, to manage interaction between applications or containers of deployment pipeline(s) 2610 and services 2520 and/or hardware 2522. In at least one embodiment, pipeline manager 2612 may be configured to facilitate interactions from application to application, from application to service 2520, and/or from application or service to hardware 2522. In at least one embodiment, although illustrated as included in software 2518, this is not intended to be limiting, and in some examples pipeline manager 2612 may be included in services 2520. In at least one embodiment, application orchestration system 2628 (e.g., Kubernetes, DOCKER, etc.) may include a container orchestration system that may group applications into containers as logical units for coordination, management, scaling, and deployment. In at least one embodiment, by associating applications from deployment pipeline(s) 2610 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 2612 and application orchestration system 2628. In at least one embodiment, so long as an expected input and/or output of each container or application is known by a system (e.g., based on constructs of applications or containers), application orchestration system 2628 and/or pipeline manager 2612 may facilitate communication among and between, and sharing of resources among and between, each of the applications or containers. In at least one embodiment, because one or more applications or containers in deployment pipeline(s) 2610 may share the same services and resources, application orchestration system 2628 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 2628) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 2520 leveraged and shared by applications or containers in deployment system 2506 may include compute service(s) 2616, collaborative content creation service(s) 2617, AI service(s) 2618, simulation service(s) 2619, visualization service(s) 2620, and/or other service types. In at least one embodiment, applications may call (e.g., execute) one or more services 2520 to perform processing operations for an application. In at least one embodiment, compute service(s) 2616 may be leveraged by applications to perform super-computing or other high-performance computing (HPC) tasks. In at least one embodiment, compute service(s) 2616 may be leveraged to perform parallel processing (e.g., using a parallel computing platform 2630) for processing data through one or more of applications and/or one or more tasks of a single application, substantially simultaneously. In at least one embodiment, parallel computing platform 2630 (e.g., NVIDIA's CUDA®) may enable general purpose computing on GPUs (GPGPU) (e.g., GPUs/graphics 2622). In at least one embodiment, a software layer of parallel computing platform 2630 may provide access to virtual instruction sets and parallel computational elements of GPUs, for execution of compute kernels. In at least one embodiment, parallel computing platform 2630 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 2630 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 2618 may be leveraged to perform inferencing services for executing machine learning model(s) associated with applications (e.g., tasked with performing one or more processing tasks of an application). In at least one embodiment, AI service(s) 2618 may leverage AI system(s) 2624 to execute machine learning model(s) (e.g., neural networks, such as CNNs) for segmentation, reconstruction, object detection, feature detection, classification, and/or other inferencing tasks. In at least one embodiment, applications of deployment pipeline(s) 2610 may use one or more of output model(s) 2516 from training system 2504 and/or other models of applications to perform inference on imaging data (e.g., DICOM data, RIS data, CIS data, REST compliant data, RPC data, raw data, etc.). For example, DICOM adapter 2102b may be used to access DICOM data. In at least one embodiment, two or more examples of inferencing using application orchestration system 2628 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 2628 may distribute resources (e.g., services 2520 and/or hardware 2522) based on priority paths for different inferencing tasks of AI service(s) 2618.

In at least one embodiment, shared storage may be mounted to AI service(s) 2618 within system 2600. In at least one embodiment, shared storage may operate as a cache (or other storage device type) and may be used to process inference requests from applications. In at least one embodiment, when an inference request is submitted, a request may be received by a set of API instances of deployment system 2506, and one or more instances may be selected (e.g., for best fit, for load balancing, etc.) to process a request. In at least one embodiment, to process a request, a request may be entered into a database, a machine learning model may be located from model registry 2524 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 2612) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that the same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray) or may require inference on hundreds of images (e.g., chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from the requesting institution or entity and may include partner network traversal time, as well as execution on an inference service.

In at least one embodiment, transfer of requests between services 2520 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with the most instances of an application connected to it, while lowest priority work may go to a queue with a single instance connected to it that processes tasks in the order received. In at least one embodiment, an application may run on a GPU-accelerated instance generated in cloud 2626, and an inference service may perform inferencing on a GPU.

In at least one embodiment, visualization service(s) 2620 may be leveraged to generate visualizations for viewing outputs of applications and/or deployment pipeline(s) 2610. In at least one embodiment, GPUs/graphics 2622 may be leveraged by visualization service(s) 2620 to generate visualizations. In at least one embodiment, rendering effects, such as ray-tracing or other light transport simulation techniques, may be implemented by visualization service(s) 2620 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 2620 may include an internal visualizer, cinematics, and/or other rendering or image processing capabilities or functionality (e.g., ray tracing, rasterization, internal optics, etc.).

In at least one embodiment, hardware 2522 may include GPUs/graphics 2622, AI system(s) 2624, cloud 2626, and/or any other hardware used for executing training system 2504 and/or deployment system 2506. In at least one embodiment, GPUs/graphics 2622 (e.g., NVIDIA's TESLA® and/or QUADRO® GPUs) may include any number of GPUs that may be used for executing processing tasks of compute service(s) 2616, collaborative content creation service(s) 2617, AI service(s) 2618, simulation service(s) 2619, visualization service(s) 2620, other services, and/or any features or functionality of software 2518. For example, with respect to AI service(s) 2618, GPUs/graphics 2622 may be used to perform pre-processing on imaging data (or other data types used by machine learning models), post-processing on outputs of machine learning models, and/or to perform inferencing (e.g., to execute machine learning models). In at least one embodiment, cloud 2626, AI system(s) 2624, and/or other components of system 2600 may use GPUs/graphics 2622. In at least one embodiment, cloud 2626 may include a GPU-optimized platform for deep learning tasks. In at least one embodiment, AI system(s) 2624 may use GPUs, and cloud 2626—or at least a portion tasked with deep learning or inferencing—may be executed using one or more AI system(s) 2624. As such, although hardware 2522 is illustrated as discrete components, this is not intended to be limiting, and any components of hardware 2522 may be combined with, or leveraged by, any other components of hardware 2522.

In at least one embodiment, AI system(s) 2624 may include a purpose-built computing system (e.g., a super-computer or an HPC) configured for inferencing, deep learning, machine learning, and/or other artificial intelligence tasks. In at least one embodiment, AI system(s) 2624 (e.g., NVIDIA's DGX™) may include GPU-optimized software (e.g., a software stack) that may be executed using a plurality of GPUs/graphics 2622, in addition to CPUs, RAM, storage, and/or other components, features, or functionality. In at least one embodiment, one or more AI system(s) 2624 may be implemented in cloud 2626 (e.g., in a data center) for performing some or all AI-based processing tasks of system 2600.

In at least one embodiment, cloud 2626 may include a GPU-accelerated infrastructure (e.g., NVIDIA's NGC™) that may provide a GPU-optimized platform for executing processing tasks of system 2600. In at least one embodiment, cloud 2626 may include an AI system(s) 2624 for performing one or more AI-based tasks of system 2600 (e.g., as a hardware abstraction and scaling platform). In at least one embodiment, cloud 2626 may integrate with application orchestration system 2628 leveraging multiple GPUs to enable seamless scaling and load balancing between and among applications and services 2520. In at least one embodiment, cloud 2626 may be tasked with executing at least some of services 2520 of system 2600, including compute service(s) 2616, AI service(s) 2618, and/or visualization service(s) 2620, as described herein. In at least one embodiment, cloud 2626 may perform small and large batch inference (e.g., executing NVIDIA's TensorRT™), provide an accelerated parallel computing platform 2630 (e.g., NVIDIA's CUDA®), execute application orchestration system 2628 (e.g., KUBERNETES), provide a graphics rendering API and platform (e.g., for ray-tracing, 2D graphics, 3D graphics, and/or other rendering techniques to produce higher quality cinematics), and/or may provide other functionality for system 2600. In at least one embodiment, parallel computing platform 2630 may include an API.

In at least one embodiment, to preserve patient confidentiality (e.g., where patient data or records are to be used off-premises), cloud 2626 may include a registry, such as a deep learning container registry. In at least one embodiment, a registry may store containers for instantiation of applications that may perform pre-processing, post-processing, or other processing tasks on patient data. In at least one embodiment, cloud 2626 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Neural Network Training and Deployment

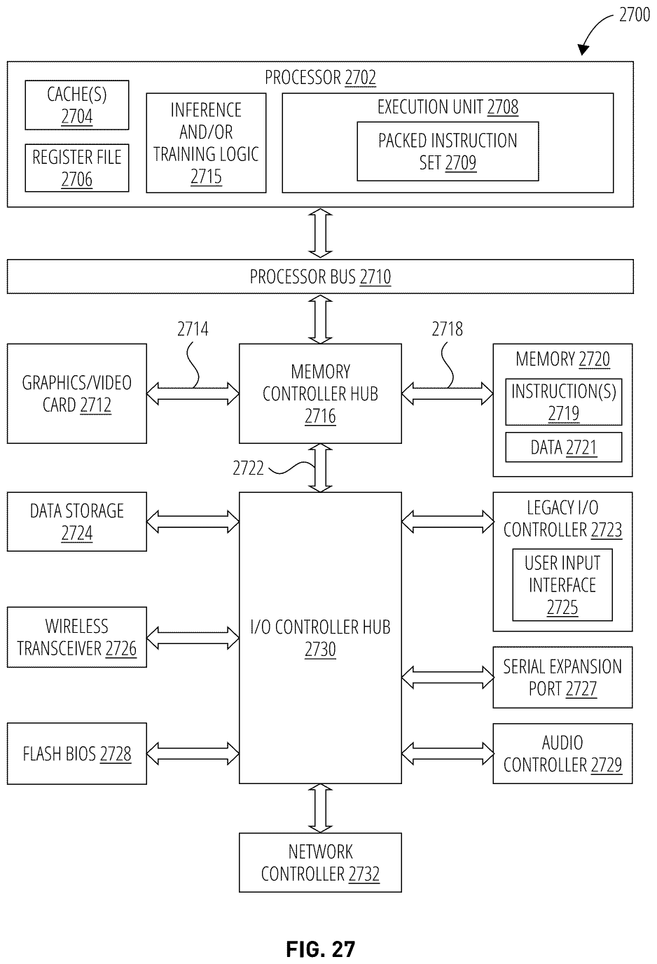

FIG. 27 is a block diagram illustrating an exemplary computer system 2700, which may be a system with interconnected devices and components, a system-on-a-chip (SOC) or some combination thereof formed with a processor that may include execution units to execute an instruction, according to at least one embodiment. In at least one embodiment, computer system 2700 may include, without limitation, a component, such as a processor 2702 to employ execution units including logic to perform algorithms for process data, in accordance with present disclosure, such as in embodiment described herein. In at least one embodiment, computer system 2700 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 2700 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 2700 may include, without limitation, processor 2702 that may include, without limitation, one or more execution units 2708 to perform machine learning model training and/or inferencing according to techniques described herein. In at least one embodiment, computer system 2700 is a single processor desktop or server system, but in another embodiment, computer system 2700 may be a multiprocessor system. In at least one embodiment, processor 2702 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 2702 may be coupled to a processor bus 2710 that may transmit data signals between processor 2702 and other components in computer system 2700.

In at least one embodiment, processor 2702 may include, without limitation, a Level 1 (“L1”) internal cache memory (“cache”) 2704. In at least one embodiment, processor 2702 may have a single internal cache or multiple levels of internal cache. In at least one embodiment, cache memory may reside externally to processor 2702. Other embodiments may also include a combination of both internal and external caches depending on a particular implementation and needs.

In at least one embodiment, processor 2702 may include, without limitation, a Level 2 (“L2”) internal cache memory (“cache”) 2704. The L2 cache can serve as a secondary, larger, and somewhat slower cache compared to the L1 cache that is still faster than accessing the main memory (e.g., via the memory controller hub 2716). Thus, the L2 cache can enhance performance by reducing the time the processor spends accessing the main memory. In at least one embodiment, processor 2702 may have a single internal L2 cache or multiple levels of internal cache. In embodiments where the processor 2702 is a multi-core processor, the L2 cache can be shared among multiple cores of processor 2702, providing a larger, intermediate level of cache memory for more than one processing core. In at least one embodiment, L2 cache memory may reside externally to processor 2702.

In at least one embodiment, processor 2702 may include, without limitation, a Level 3 (“L3”) internal cache memory (“cache”) 2704. The L3 cache can serve as a tertiary, larger, and slower cache compared to both the L1 and L2 caches. The L3 cache can enhance performance by reducing the time the processor spends accessing the main memory. The L3 cache can be shared among multiple cores of processor 2702, providing a larger pool of fast-access memory for data for the processor cores. In at least one embodiment, processor 2702 may have a single internal L3 cache or multiple levels of internal cache. In at least one embodiment, L3 cache memory may reside externally to processor 2702. Other embodiments may also include any combination of internal or external L1, L2, and/or L3 caches depending on a particular implementation and needs. In at least one embodiment, register file 2706 may store different types of data in various registers including, without limitation, integer registers, floating point registers, status registers, and instruction pointer register.

In at least one embodiment, execution unit 2708, including, without limitation, logic to perform integer and floating-point operations, also resides in processor 2702. In at least one embodiment, processor 2702 may also include a microcode (“ucode”) read only memory (“ROM”) that stores microcode for certain macro instructions. In at least one embodiment, execution unit 2708 may include logic to handle a packed instruction set 2709. In at least one embodiment, by including packed instruction set 2709 in an instruction set of a general-purpose processor 2702, along with associated circuitry to execute instructions, operations used by many multimedia applications may be performed using packed data in a general-purpose processor 2702. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 2708 may also be used in microcontrollers, embedded processors, graphics devices, DSPs, and other types of logic circuits. In at least one embodiment, computer system 2700 may include, without limitation, a memory 2720. In at least one embodiment, memory 2720 may be implemented as a Dynamic Random Access Memory (“DRAM”) device, a Static Random Access Memory (“SRAM”) device, flash memory device, or other memory device. In at least one embodiment, memory 2720 may store instruction(s) 2719 and/or data 2721 represented by data signals that may be executed by processor 2702.

In at least one embodiment, system logic chip may be coupled to processor bus 2710 and memory 2720. In at least one embodiment, system logic chip may include, without limitation, a memory controller hub 2716 (“MCH”), and processor 2702 may communicate with MCH 2716 via processor bus 2710. In at least one embodiment, MCH 2716 may provide a high bandwidth memory path 2718 to memory 2720 for instruction and data storage and for storage of graphics commands, data, and textures. In at least one embodiment, MCH 2716 may direct data signals between processor 2702, memory 2720, and other components in computer system 2700 and bridge data signals between processor bus 2710, memory 2720, and a system I/O 2722. In at least one embodiment, a system logic chip may provide a graphics port for coupling to a graphics controller. In at least one embodiment, MCH 2716 may be coupled to memory 2720 through a high bandwidth memory path 2718 and graphics/video card 2712 may be coupled to MCH 2716 through an Accelerated Graphics Port (“AGP”) interconnect 2714.

In at least one embodiment, computer system 2700 may use system I/O 2722 that is a proprietary hub interface bus to couple MCH 2716 to I/O controller hub (“ICH”) 2730. In at least one embodiment, ICH 2730 may provide direct connections to some I/O devices via a local I/O bus. In at least one embodiment, the local I/O bus may include, without limitation, a high-speed I/O bus for connecting peripherals to memory 2720, chipset, and processor 2702. Examples may include, without limitation, an audio controller 2729, a firmware hub (“flash BIOS”) 2728, a wireless transceiver 2726, a data storage 2724, a legacy I/O controller 2723 containing user input and keyboard interfaces 2725, a serial expansion port 2727, such as Universal Serial Bus (“USB”), and a network controller 2732, which may include in some embodiments, a data processing unit. Data storage 2724 may comprise a hard disk drive, a floppy disk drive, a CD-ROM device, a flash memory device, or other mass storage device.

In at least one embodiment, FIG. 27 illustrates a system, which includes interconnected hardware devices or “chips”, whereas in other embodiments, FIG. 27 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 2700 are interconnected using compute express link (CXL) interconnects.

Inference and/or training logic 2715 are used to perform inferencing and/or training operations associated with one or more embodiments. The inference and/or training logic 2715 may include same or similar features of training logic/hardware structure(s) 2315. Details training logic/hardware structure(s) 2315 are provided in conjunction with FIG. 23A and/or FIG. 23B. In at least one embodiment, inference and/or training logic 2715 may be used in system FIG. 27 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

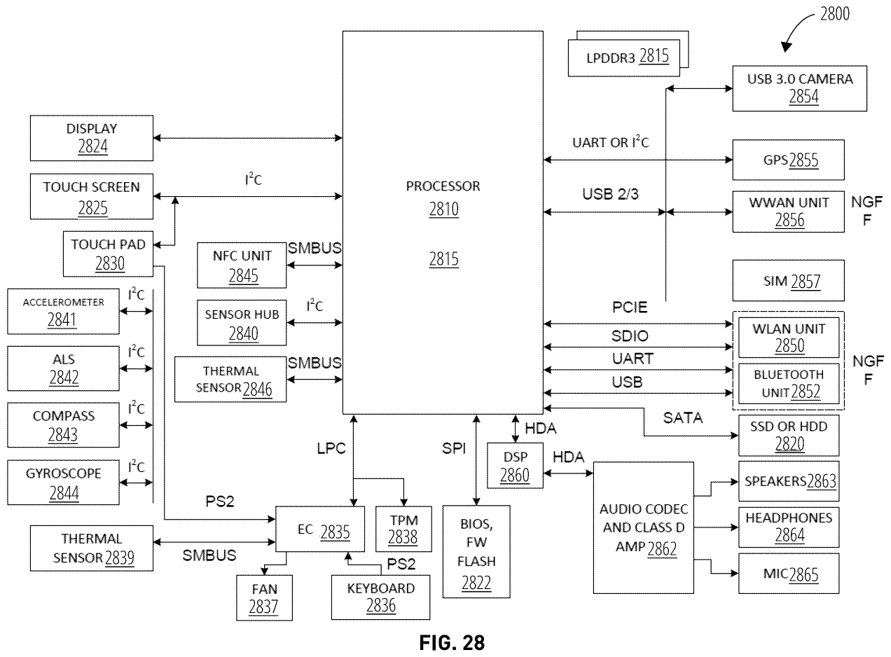

FIG. 28 is a block diagram illustrating an electronic device 2800 for utilizing a processor 2810, according to at least one embodiment. In at least one embodiment, electronic device 2800 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, electronic device 2800 may include, without limitation, processor 2810 communicatively coupled to any suitable number or kind of components, peripherals, modules, or devices. In at least one embodiment, processor 2810 coupled using a bus or interface, such as a I2C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 28 illustrates a system, which includes interconnected hardware devices or “chips”, whereas in other embodiments, FIG. 28 may illustrate an exemplary System on a Chip (“SoC”). In at least one embodiment, devices illustrated in FIG. 28 may be interconnected with proprietary interconnects, standardized interconnects (e.g., PCIe) or some combination thereof. In at least one embodiment, one or more components of FIG. 28 are interconnected using compute express link (CXL) interconnects.

In at least one embodiment, FIG. 28 may include a display 2824, a touch screen 2825, a touch pad 2830, a Near Field Communications unit (“NFC”) 2845, a sensor hub 2840, a thermal sensor 2846, an Express Chipset (“EC”) 2835, a Trusted Platform Module (“TPM”) 2838, BIOS/firmware/flash memory (“BIOS, FW Flash”) 2822, a DSP 2860, a drive 2820 such as a Solid State Disk (“SSD”) or a Hard Disk Drive (“HDD”), a wireless local area network unit (“WLAN”) 2850, a Bluetooth unit 2852, a Wireless Wide Area Network unit (“WWAN”) 2856, a Global Positioning System (GPS) 2855, a camera (“USB 3.0 camera”) 2854 such as a USB 3.0 camera, and/or a Low Power Double Data Rate (“LPDDR”) memory unit (“LPDDR3”) 2815 implemented in, for example, LPDDR3 standard. These components may each be implemented in any suitable manner.

In at least one embodiment, other components may be communicatively coupled to processor 2810 through components discussed above. In at least one embodiment, an accelerometer 2841, Ambient Light Sensor (“ALS”) 2842, compass 2843, and a gyroscope 2844 may be communicatively coupled to sensor hub 2840. In at least one embodiment, thermal sensor 2839, a fan 2837, a keyboard 2836, and a touch pad 2830 may be communicatively coupled to EC 2835. In at least one embodiment, speaker 2863, headphones 2864, and microphone (“mic”) 2865 may be communicatively coupled to an audio unit (“audio codec and class d amp”) 2862, which may in turn be communicatively coupled to DSP 2860. In at least one embodiment, audio unit 2862 may include, for example and without limitation, an audio coder/decoder (“codec”) and a class D amplifier. In at least one embodiment, a Subscriber Identity/Identification Module (SIM) card (“SIM”) 2857 may be communicatively coupled to WWAN unit 2856. In at least one embodiment, components such as WLAN unit 2850 and Bluetooth unit 2852, as well as WWAN unit 2856 may be implemented in a Next Generation Form Factor (“NGFF”).

Inference and/or training logic/hardware structures are used to perform inferencing and/or training operations associated with one or more embodiments. Details regarding training logic/hardware structure(s) are provided in conjunction with FIG. 23A and/or FIG. 23B. In at least one embodiment, inference and/or training logic structures may be used in system FIG. 28 for inferencing or predicting operations based, at least in part, on weight parameters calculated using neural network training operations, neural network functions and/or architectures, or neural network use cases described herein.

Such components may be used to generate synthetic data that imitates failure cases in a network training process, which may help improve the performance of the network while limiting the amount of synthetic data to avoid overfitting.

Other variations are within the spirit of the present disclosure. Thus, while the disclosed techniques are susceptible to various modifications and alternative constructions, certain illustrated embodiments are shown in the drawings and have been described above in detail. It should be understood, however, that there is no intention to limit the disclosure to the specific forms disclosed; on the contrary, the intention is to cover all modifications, alternative constructions, and equivalents falling within the spirit and scope of the disclosure, as defined in the appended claims.

The use of terms such as “a,” “an,” “the,” and similar referents in the context of describing disclosed embodiments (especially in the context of the following claims) is to be construed to cover both singular and plural, unless otherwise indicated herein or clearly contradicted by context, and not as a definition of a term. Terms such as “comprising,” “having,” “including,” and “containing” are to be construed as open-ended terms (meaning “including, but not limited to”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set; the subset and corresponding set may be equal.

Conjunctive language, such as phrases of the form “at least one of A, B, and C,” or “at least one of A, B and C,” unless specifically stated otherwise or clearly contradicted by context, is generally understood to mean that an item, term, etc., may be either A or B or C, or any nonempty subset of the set of A and B and C. For instance, in an illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two but can be more when so indicated, either explicitly or by context. Further, unless stated otherwise or clearly indicated by context, the phrase “based on” means “based at least in part on” and not “based solely on.”

Operations of processes described herein may be performed in any suitable order unless otherwise indicated or clearly contradicted by context. In at least one embodiment, a process described herein (or variations and/or combinations thereof) is performed under the control of one or more computer systems configured with executable instructions and is implemented as code (e.g., executable instructions, one or more computer programs, or one or more applications) executing collectively on one or more processors, by hardware, or by combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on one or more non-transitory computer-readable storage media having stored thereon executable instructions (or other memory to store executable instructions) that, when executed by one or more processors of a computer system, cause the computer system to perform operations described herein. In at least one embodiment, a set of non-transitory computer-readable storage media comprises multiple non-transitory computer-readable storage media, and one or more individual non-transitory storage media of the multiple non-transitory computer-readable storage media may lack all of the code, while the multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of the present disclosure may be a single device, and in another embodiment, may be a distributed computer system comprising multiple devices that operate differently, such that the distributed computer system performs operations described herein and a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In the description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but still co-operate or interact with each other.

Unless specifically stated otherwise, it may be appreciated that throughout the specification, terms such as “processing,” “computing,” “calculating,” “determining,” or the like refer to actions and/or processes of a computer or computing system, or similar electronic computing device, that manipulate and/or transform data represented as physical, such as electronic, quantities within the computing system's registers and/or memories into other data similarly represented as physical quantities within the computing system's memories, registers, or other such information storage, transmission, or display devices.

In a similar manner, the term “processor” may refer to any device or portion of a device that processes electronic data from registers and/or memory and transforms that electronic data into other electronic data that may be stored in registers and/or memory. As a non-limiting example, a “processor” may be a network device. A “computing platform” may comprise one or more processors. As used herein, “software” processes may include, for example, software and/or hardware entities that perform work over time, such as tasks, threads, and intelligent agents. Also, each process may refer to multiple processes that continuously or intermittently carry out instructions in sequence or in parallel. In at least one embodiment, the terms “system” and “method” are used herein interchangeably, as a system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog or digital data can be accomplished in a variety of ways, such as by receiving data as a parameter of a function call or a call to an application programming interface. In at least one embodiment, these processes can be accomplished by transferring data via a serial or parallel interface. In at least one embodiment, these processes can be accomplished by transferring data via a computer network from a providing entity to an acquiring entity. In at least one embodiment, references may also be made to providing, outputting, transmitting, sending, or presenting analog or digital data. In various examples, these processes can be accomplished by transferring data as an input or output parameter of a function call, a parameter of an application programming interface, or an inter-process communication mechanism.

Although the descriptions herein set forth example embodiments of the described techniques, other architectures may be used to implement the described functionality and are intended to be within the scope of this disclosure. Furthermore, although specific distributions of responsibilities may be defined above for purposes of description, various functions and responsibilities might be distributed and divided in different ways, depending on the circumstances.

Furthermore, although the subject matter has been described in language specific to structural features and/or methodological acts, it is to be understood that the subject matter claimed in the appended claims is not necessarily limited to the specific features or acts described. Rather, the specific features and acts are disclosed as exemplary forms of implementing the claims.

What is claimed is:

1. A communication system comprising:
a receiver circuit;
a Forward Error Correction (FEC) circuit operatively coupled to the receiver circuit; and
a processing device operatively coupled to the receiver circuit and the FEC circuit, wherein the processing device is to:
evaluate a quality metric associated with a trained deep neural network (DNN) relative to a quality criterion, the DNN to estimate a post-FEC bit error rate of a FEC circuit;
update at least one of a feature set or a neural network configuration when the quality metric does not satisfy the quality criterion;
retrain the DNN with an updated feature set or updated neural network configuration and re-evaluating the quality metric;
select a final feature set or a final neural network configuration for DNN inference when the quality metric satisfies the quality criterion; and
store trained DNN model parameters corresponding to the final feature set or final neural network configuration.

2. The communication system of claim 1, wherein the processing device is further to:
identify an initial feature set and an initial neural network configuration for training the DNN to estimate the post-FEC bit error rate; and
train the DNN using the initial feature set and the initial neural network configuration.

3. The communication system of claim 2, wherein, to evaluate the quality metric, the processing device is further to:
determine one or more DNN training metrics associated with the training of the DNN using the initial feature set and the initial neural network configuration;
determine a post-FEC BER quality metric associated with the training of the DNN using the initial feature set and the initial neural network configuration; and
combine the one or more DNN training metrics and the post-FEC BER quality metric to obtain the quality metric.

4. The communication system of claim 3, wherein the post-FEC BER quality metric is a post-FEC BER error value representing a difference between a predicted post-FEC BER of the initial feature set and the initial neural network configuration and a reference post-FEC BER.

5. The communication system of claim 3, wherein the one or more DNN training metrics comprise at least one of a training loss convergence profile or a validation loss convergence profile.

6. The communication system of claim 1, wherein the processing device is to update the updated feature set or the updated neural network configuration using a full parallel grid search, a sequential grid search, or a stochastic hill climbing (SHC) based grid traversal.

7. The communication system of claim 1, wherein DNN model parameters of the DNN are trained based on input training data, validation data, reference output data, and validation output data, and wherein the processing device is to perform at least one of a validation inference or a diagnostic inference to determine a post-FEC BER quality metric associated with the training of the DNN using the feature set and the neural network configuration, wherein the quality metric is based on at least the post-FEC BER quality metric.

8. The communication system of claim 1, wherein the processing device is further to:
receive measurement data corresponding to the final feature set;
determine, using the measurement data and the trained DNN model parameters, the post-FEC bit error rate of the FEC circuit; and
adjust, based on the post-FEC bit error rate, at least one of a FEC parameter of the FEC circuit or a link parameter of a transmitter or the receiver circuit.

9. The communication system of claim 8, wherein:
the FEC circuit comprises:
an interleaver; and
a decoder;
the FEC parameter is an interleave factor of the interleaver; and
the processing device, to adjust at least one of the FEC parameter or the link parameter, is to change the interleave factor from a first value to a second value.

10. The communication system of claim 8, wherein the receiver circuit comprises a serializer/deserializer (SerDes) circuit, wherein:
the link parameter is a SerDes parameter of the SerDes circuit; and
the processing device, to adjust at least one of the FEC parameter or the link parameter, is to change the SerDes parameter from a first value to a second value.

11. The communication system of claim 8, wherein the receiver circuit comprises a serializer/deserializer (SerDes) circuit, wherein:
the FEC circuit comprises an interleaver;
the FEC parameter is an interleave factor of the interleaver;
the link parameter is a SerDes parameter of the SerDes circuit; and
the processing device, to adjust at least one of the FEC parameter or the link parameter, is to:
change the interleave factor from a first value to a second value; and
change the SerDes parameter from a third value to a fourth value.

12. A method comprising:
evaluating a quality metric of a trained deep neural network (DNN) relative to a quality criterion, the trained DNN to estimate a post-FEC bit error rate of a Forward Error Correction (FEC) circuit;
updating at least one of a feature set or network configuration when the quality metric does not satisfy the quality criterion;
retraining the DNN with an updated feature set or updated network configuration and re-evaluating the quality metric;
selecting a final feature set or configuration for DNN inference when the quality metric satisfies the criterion; and
storing trained DNN model parameters corresponding to the final feature set or configuration.

13. The method of claim 12, further comprising:
identifying an initial feature set and an initial neural network configuration for training a deep neural network (DNN) to estimate a post-FEC bit error rate of a Forward Error Correction (FEC) circuit; and
training the DNN using the initial feature set and the initial neural network configuration.

14. The method of claim 13, wherein evaluating the quality metric comprises:
determining one or more DNN training metrics associated with the training of the DNN using the initial feature set and the initial neural network configuration;
determining a post-FEC BER quality metric associated with the training of the DNN using the initial feature set and the initial neural network configuration; and
combining the one or more DNN training metrics and the post-FEC BER quality metric to obtain the quality metric.

15. The method of claim 14, wherein the post-FEC BER quality metric is a post-FEC BER error value representing a difference between a predicted post-FEC BER of the initial feature set and the initial neural network configuration and a reference post-FEC BER.

16. The method of claim 14, wherein the one or more DNN training metrics comprise at least one of a training loss convergence profile or a validation loss convergence profile.

17. The method of claim 12, wherein updating the feature set or network configuration comprises using a full parallel grid search, a sequential grid search, or a stochastic hill climbing (SHC) based grid traversal.

18. The method of claim 12, wherein DNN model parameters of the DNN are trained based on input training data, validation data, reference output data, and validation output data, and wherein the method further comprises performing at least one of a validation inference or a diagnostic inference to determine a post-FEC BER quality metric associated with the training of the DNN using the feature set or network configuration, wherein the quality metric is based on at least the post-FEC BER quality metric.

19. The method of claim 12, further comprising:
receiving measurement data corresponding to the final feature set;
determining, using the measurement data and the trained DNN model parameters, the post-FEC bit error rate of the FEC circuit; and
adjusting, based on the post-FEC bit error rate, at least one of a FEC parameter of the FEC circuit or a link parameter of a transmitter or a receiver circuit comprising the FEC circuit.

20. The method of claim 19, wherein adjusting at least one of the FEC parameter or the link parameter comprises changing an interleave factor of an interleaver of the FEC circuit from a first value to a second value.

21. The method of claim 19, wherein the receiver circuit is a Serializer/Deserializer (SerDes) circuit, wherein adjusting at least one of the FEC parameter or the link parameter comprises changing a SerDes parameter of the SerDes circuit from a first value to a second value.

22. The method of claim 19, wherein the receiver circuit is a Serializer/Deserializer (SerDes) circuit, wherein adjusting at least one of the FEC parameter or the link parameter comprises:
changing an interleave factor of an interleaver of the FEC circuit from a first value to a second value; and
changing a SerDes parameter of the SerDes circuit from a third value to a fourth value.

23. A system for high-speed network communication, the system comprising:
a processing unit; and
a network interface coupled to the processing unit, wherein the network interface comprises a transceiver comprising:
a receiver circuit; and
a Forward Error Correction (FEC) circuit operatively coupled to the receiver circuit, wherein the processing unit it to:
evaluate a quality metric associated with a trained deep neural network (DNN) relative to a quality criterion, the DNN to estimate a post-FEC bit error rate of the FEC circuit;
update at least one of a feature set or a neural network configuration when the quality metric does not satisfy the quality criterion;
retrain the DNN with an updated feature set or updated neural network configuration and re-evaluating the quality metric;
select a final feature set or a final neural network configuration for DNN inference when the quality metric satisfies the quality criterion; and
store trained DNN model parameters corresponding to the final feature set or final neural network configuration.

24. The system of claim 23, wherein the processing unit comprises at least one of a central processing unit (CPU), a graphics processing unit (GPU), a data processing unit (DPU), a network adapter, a network switch, or an NVLink switch.
